(19) United States
(12) Patent Application Publication
(10) Pub. No.: US 2026/0094126 A1
(43) Pub. Date: Apr. 2, 2026

(54) EVENT NOTIFICATION AND MESSAGING SYSTEM

(71) Applicant: Kohi LLC, Wethersfield, CT (US)

(72) Inventors: Catherine MURPHY, Wethersfield, CT (US); Carollynne WEIDLER, Wethersfield, CT (US); Claire MURPHY, Wethersfield, CT (US)

(21) Appl. No.: 19/112,645

(22) PCT Filed: Nov. 2, 2023
(86) PCT No.: PCT/US2023/036645

§ 371 Date: Mar. 18, 2025

Related U.S. Application Data
(60) Provisional application No. 63/421,786, filed on Nov. 2, 2022.

(51) Int. Cl. G06Q 10/1093; G06Q 10/02

(52) U.S. Cl. CPC G06Q 10/1093; G06Q 10/02

(57) ABSTRACT

Systems and methods are presented for receiving and responding to an event status message for an event. The system includes a server having a processor and memory, and user devices, each having a processor and memory. The user devices communicate with the server over a network. When the event status message includes a change in status of the event, the server processes the message to apply user-defined preferences for a response by generating notification messages including control signals, and distributing the notification messages to the user devices. Upon receipt, the user devices processes the notification messages by automatically revising an action previously set within the user device, the action including activating an audio or a visual notification message or alarm. The user adjusts, revises, and/or adapts their schedules in response to the revised action on the user device.

### CROSS-REFERENCE TO RELATED APPLICATIONS

This application is a non-provisional application of, claims benefit of, and priority under 35 U.S.C. § 119(e) to, co-pending and commonly owned U.S. Provisional Patent Application Ser. No. 63/421,786, filed on Nov. 2, 2022, titled “Event Notification and Messaging System,” which is hereby incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### FIELD OF THE INVENTION

The present disclosure relates to systems and methods for communicating an event notification and, in particular, to systems and methods for communicating a notification including an updated status of an event and activating an automated response to such notification.

### BACKGROUND OF THE INVENTION

This description of related art is provided to generally present a context of the present disclosure. Unless otherwise indicated, the information described in this section is not prior art to the claimed invention of this patent document and is not admitted to be prior art by inclusion therein.

Generally speaking, it is desirable for event organizers, local government officials, administrators of schools or universities, managers for television, film, and/or stage productions, administrators or staff of travel and/or transportation service providers, and the like, to notify one or more attendees, participants, and others of a change in status such as, for example, a delay, closure, or cancellation of an event, or early or late dismissal from the event. The timelier the notification of such a change in status, the timelier a response can be taken to the change. In some circumstances, the attendee or others may revise or otherwise adjust their schedules in response to the notification. For example, if the event includes a starting time that is early in a morning and the event's start time is delayed or the event is cancelled, the attendee or others may wish to remain asleep or at least sleep longer than otherwise would be appropriate to attend the event at the original start time.

It is known to broadcast a notification that an event such as, for example, a school day, is delayed or cancelled due to, for example, inclement weather or the like. Such broadcasted notifications may include, for example, announcements on public television, public radio, and more recently, postings on social media sites accessible by attendees and others as well as electronic mail messages, telephone calls, and/or text messages automatically sent to certain stationary and/or portable communication and/or computing devices such as, for example, workstations, laptops, tablet computers, cellular radiotelephones, smartphones, and the like, operated by the one or more attendees and others. While receipt of the broadcasted notifications may allow action by the attendees, participants, or others, there is a need for a solution that provides for an automated response that may allow the attendees or others to better adjust, revise, and/or adapt their schedules upon receipt of the notification.

Accordingly, the inventors have discovered that there is a need for systems and methods that receive broadcast notifications including a change in status of an event such as, for example, a delay, a closure, a cancellation, or change in formation of the event, or early or delayed dismissal from the event, and that automatically and selectively respond to allow attendees or others planning to attend or participate in the event to adjust, revise, and/or adapt their schedules upon receipt of the notification.

### SUMMARY

The present disclosure is directed to a system and a method for receiving and responding to a change of status message for an event over a communication network. In one aspect of the disclosure, the system includes a server including a server processor and a server memory operatively coupled to the server processor. The server memory stores server instructions executable by the server processor. The system further includes one or more user devices, operable by one or more users of the system. Each of the one or more user devices includes a user device processor and a user device memory operatively coupled to the user device processor. The one or more user devices communicate with the server over a communication network. Each of the user device memory store user device instructions executable by the user device processor. When an event status message including a change in a status of an event is received by the server, the server processor executes the server instructions such that the server is configured to extract from the received event status message one or more event facilities conducting at least one event impacted by the event status message. The server processor further executes to determine whether the received event status message is generated by one or more sources authorized to change the status of events conducted at a corresponding one of the one or more event facilities. When the received event status message is generated from an authorized source, the server processor further identifies the one or more users associated with at least one event facility impacted by the received event status message, generates one or more notification messages including the change in the status of the event, and sends the generated one or more notification messages to the one or more user devices of the identified one or more users. When a notification message is received by a user device of the identified one or more users, the user device processor executes the user device instructions such that the user device is configured to extract from the received notification message the change in the status of the event. The user device processor further executes to determine a type of the change in the status of the event from a plurality of types of changes in the status of events and to compare the determined type of the change in the status to one or more automated responses enabled on the user device for the plurality of types of changes in the status of events. When an automated response is enable for the determined type of the change in the status, the user device processor further executes to activate the automated response by the user device to the received notification message.

In one embodiment, the one or more automated responses activated on the user device include at least one of cancelling an alarm signal set for activation on the user device at a first predetermined time, updating the first predetermined time set for activating the alarm signal by a first delay period set by an event facility associated with the user of the user device, updating the first predetermined time set for activating the alarm signal by a second delay period set by the user of the user device, and cancelling the alarm signal previously set for activation on the user device at the first predetermined time and setting the alarm signal for activation on the user device at a second predetermined time. In one embodiment, when no automated response is enabled on the user device, exhibiting on the user device, in response to the received notification message, an alert message that no automated response is enabled. In one embodiment, the alarm signal activated on the user device includes at least one of an audio notification message and a visual notification message. In one embodiment, the visual notification message includes a snooze option to instruct the user device to re-activate the alarm signal after expiration of a delay period of, for example, about nine seconds.

In another embodiment, the system further includes one or more Internet of Things (IoT) devices operatively coupled to at least one of the server and one of the one or more user devices. Each of the IoT devices includes an IoT device processor and an IoT device memory operatively coupled to the IoT device processor. The IoT device memory stores IoT device instructions executable by the IoT processor. In one embodiment, the notification message further includes control signals provided to the one or more IoT devices by one of the server and one of the user devices. The control signals instruct the one or more IoT devices to activate one or more automated responses on the IoT device for the plurality of types of changes in the status of events. In one embodiment, the one or more automated responses activated on the IoT devices include at least one of cancelling an alarm signal set for activation on the one or more IoT devices at a first predetermined time, updating the first predetermined time set for activating the alarm signal by a first delay period set by an event facility associated with the user of the user device coupled to the one or more IoT devices, updating the first predetermined time set for activating the alarm signal by a second delay period set by the user of the user device coupled to the one or more IoT devices, and cancelling the alarm signal previously set for activation on the one or more IoT devices at the first predetermined time and setting the alarm signal for activation on the one or more IoT devices at a second predetermined time.

In one embodiment, the server processor at least one of receives the event status messages from and retrieves the event status messages from a third party source. In one embodiment, the third party source includes at least one of event organizers, local government officials, administrators of schools or universities, managers for television, film, or stage productions, administrators or staff of travel or transportation service providers. In one embodiment, the users of the system include one or more attendees and others planning to attend or participate in the event, persons picking up the attendees and others after an end of the event, administrators of event facilities, and system administrators. In one embodiment, the users further include two or more subsets of the attendees and others planning to attend or participate in the event, the persons picking up the attendees and others, and the administrators of event facilities registered with the system as one or more user groups associated with one or more of the event facilities. In one embodiment, the event includes at least one of a school day, a meeting, a conference, an audition, a rehearsal, a show or performance, and a schedule for travel. In another embodiment, the event facilities of the system include at least one of a school, a school district, an educational institute, a user group, and a venue for an event. In one embodiment, the change of status within the notification message includes at least one of a delay, a closure, a cancellation, an early dismissal, a late dismissal, and an alternative format for conducting the event.

In another aspect of the disclosure, a method for responding to a change of status message for an event received over a communication network is provided. The method includes receiving, at a first processing device, an event status message including a change in a status of an event. In response to the received event status message, the method includes the first processing device further operating to extract, from the received event status message, one or more event facilities conducting at least one event impacted by the event status message. The first processing device further operates to determine whether the received event status message is generated by one or more sources authorized to change the status of events conducted at a corresponding one of the one or more event facilities. When the received event status message is generated from an authorized source, the first processing device operates to identify the one or more users associated with at least one event facility impacted by the received event status message, generate one or more notification messages including the change in the status of the event, and send the generated one or more notification messages to the one or more second processing devices of the identified one or more users. The method further includes receiving, by the one or more second processing devices, one of the one or more notification messages. In response to the received notification message, the second processing device further operates to extract from the received notification message the change in the status of the event and to determine a type of the change in the status of the event from a plurality of types of changes in the status of events. The second processing device further operates to compare the determined type of the change in the status to one or more automated responses enabled on the user device for the plurality of types of changes in the status of events. When an automated response is enable for the determined type of the change in the status, the second processing devices further operates to activate the automated response to the received notification message.

In one embodiment, the one or more automated responses activated on the second processing device include at least one of cancelling an alarm signal set for activation on the second processing device at a first predetermined time, updating the first predetermined time set for activating the alarm signal by a first delay period set by an event facility associated with the user of the second processing device, updating the first predetermined time set for activating the alarm signal by a second delay period set by the user of the second processing device, and cancelling the alarm signal previously set for activation on the second processing device at the first predetermined time and setting the alarm signal for activation on the second processing device at a second predetermined time. In one embodiment, when no automated response is enabled on the second processing device, the method includes exhibiting on the second processing device, in response to the received notification message, an alert message that no automated response is enabled.

In another embodiment, the method further includes providing one or more Internet of Things (IoT) devices operatively coupled to at least one of the first processing device and one of the second processing devices. In one embodiment, the notification message further includes control signals provided to the one or more IoT devices by the at least one of the first processing device and one of the second processing devices. The control signals instruct the one or more IoT devices to activate one or more automated responses on the one or more IoT devices for the plurality of types of changes in the status of events. In one embodiment, the one or more automated responses activated on the one or more IoT devices include at least one of cancelling an alarm signal set for activation on the one or more IoT devices at a first predetermined time, updating the first predetermined time set for activating the alarm signal by a first delay period set by an event facility associated with the user of the user device coupled to the one or more IoT devices, updating the first predetermined time set for activating the alarm signal by a second delay period set by the user of the user device coupled to the one or more IoT devices, and cancelling the alarm signal previously set for activation on the one or more IoT devices at the first predetermined time and setting the alarm signal for activation on the one or more IoT devices at a second predetermined time.

### BRIEF DESCRIPTION OF THE DRAWINGS

The features and advantages of the present disclosure are better understood when the Detailed Description of the Preferred Embodiments given below is considered in conjunction with the figures provided herein and illustrating exemplary embodiments, wherein:

FIG. 1 is a simplified schematic diagram depicting an event notification and messaging system, according to one embodiment;

FIGS. 2A and 2B depict a flow diagram of a login process for the event notification and messaging system of FIG. 1, according to one embodiment;

FIG. 3 depicts an exemplary Login graphical user interface (GUI) implemented within the event notification and messaging system of FIG. 1 on a mobile computing or telecommunication device, according to one embodiment;

FIGS. 4A, 4B, and 4C depict a flow diagram of a sign-up process for the event notification and messaging system of FIG. 1, according to one embodiment;

FIG. 5 depicts an exemplary Sign Up GUI implemented within the event notification and messaging system of FIG. 1 on a mobile computing and/or telecommunication device, according to one embodiment;

FIG. 6 depicts an exemplary Select State GUI implemented within the event notification and messaging system of FIG. 1, according to one embodiment;

FIG. 7 depicts an exemplary Select School GUI implemented within the event notification and messaging system of FIG. 1, according to one embodiment;

FIG. 8 depicts an exemplary Contact School GUI implemented within the event notification and messaging system of FIG. 1, according to one embodiment;

FIG. 9 depicts an exemplary Sign Up GUI implemented within the event notification and messaging system of FIG. 1, according to one embodiment;

FIG. 10 depicts an exemplary Configure Alarm Introduction GUI implemented within the event notification and messaging system of FIG. 1, according to one embodiment;

FIGS. 11, 12, and 13 depict exemplary Configure Alarms GUIs implemented within the event notification and messaging system of FIG. 1, according to one embodiment;

FIG. 14 depicts an exemplary Edit Alarm GUI implemented within the event notification and messaging system of FIG. 1, according to one embodiment;

FIG. 15 depicts an exemplary User Dashboard GUI implemented within the event notification and messaging system of FIG. 1, according to one embodiment;

FIG. 16 depicts an exemplary Configure GUI implemented within the event notification and messaging system of FIG. 1, according to one embodiment;

FIG. 17 depicts an exemplary Login GUI implemented within the event notification and messaging system of FIG. 1 on a server computing device and exhibited to a system administrator, according to one embodiment;

FIG. 18 depicts an exemplary Dashboard GUI implemented within the event notification and messaging system of FIG. 1, according to one embodiment;

FIG. 19 depicts an exemplary navigation menu exhibited on the Dashboard GUI of FIG. 18 and implemented within the event notification and messaging system of FIG. 1, according to one embodiment;

FIGS. 20, 21, and 22 depict exemplary Delays, Closing & Dismissals GUIs implemented within the event notification and messaging system of FIG. 1, according to one embodiment;

FIG. 23 depicts an exemplary Add Delays/Closings GUI implemented within the event notification and messaging system of FIG. 1, according to one embodiment;

FIG. 24 depicts an exemplary Select Schools/School Districts Dialog Box exhibited on the Add Delays & Closings GUI of FIG. 23 and implemented within the event notification and messaging system of FIG. 1, according to one embodiment;

FIG. 25 depicts an exemplary Edit Delays/Closings GUI implemented within the event notification and messaging system of FIG. 1, according to one embodiment;

FIG. 26 depicts an exemplary Schools/School Districts GUI implemented within the event notification and messaging system of FIG. 1, according to one embodiment;

FIG. 27 depicts an exemplary Add New GUI implemented within the event notification and messaging system of FIG. 1, according to one embodiment;

FIG. 28 depicts an exemplary Edit School GUI implemented within the event notification and messaging system of FIG. 1 for a non-verified event facility, according to one embodiment;

FIG. 29 depicts an exemplary Edit School GUI implemented within the event notification and messaging system of FIG. 1 for a verified event facility, according to one embodiment;

FIG. 30 depicts an Admins GUI implemented within the event notification and messaging system of FIG. 1, according to one embodiment;

FIG. 31 depicts an Add New GUI implemented within the event notification and messaging system of FIG. 1, according to one embodiment;

FIG. 32 depicts an Edit Admin GUI implemented within the event notification and messaging system of FIG. 1, according to one embodiment;

FIG. 33 depicts an exemplary Profile GUI implemented within the event notification and messaging system of FIG. 1, according to one embodiment;

FIG. 34 depicts an exemplary Change Password Dialog Box exhibited on the Profile GUI of FIG. 33 and implemented within the event notification and messaging system of FIG. 1, according to one embodiment;

FIG. 35 depicts an exemplary Create Account GUI implemented within the event notification and messaging system of FIG. 1 on a user computing device and exhibited to an event facility administrator, according to one embodiment;

FIG. 36 depicts an exemplary Create Account—School Details GUI implemented within the event notification and messaging system of FIG. 1, according to one embodiment;

FIG. 37 depicts an exemplary Dashboard—School Name GUI implemented within the event notification and messaging system of FIG. 1, according to one embodiment;

FIG. 38 depicts an exemplary navigation menu exhibited on the Dashboard—School Name GUI of FIG. 37 and implemented within the event notification and messaging system of FIG. 1, according to one embodiment;

FIG. 39 depicts an exemplary Select Schools/School Districts Dialog Box exhibited on the Dashboard—School Name GUI of FIG. 38 and implemented within the event notification and messaging system of FIG. 1, according to one embodiment;

FIG. 40 depicts an exemplary Edit Delays/Closings GUI implemented within the event notification and messaging system of FIG. 1, according to one embodiment;

FIG. 41 depicts a Schools GUI implemented within the event notification and messaging system of FIG. 1, according to one embodiment;

FIG. 42 depicts an Add New GUI implemented within the event notification and messaging system of FIG. 1, according to one embodiment;

FIG. 43 depicts an Edit School GUI implemented within the event notification and messaging system of FIG. 1, according to one embodiment;

FIG. 44 depicts an exemplary Profile—School Admin GUI implemented within the event notification and messaging system of FIG. 1, according to one embodiment;

FIG. 45 depicts an exemplary Change Password Dialog Box exhibited on the Profile—School Admin GUI of FIG. 44 and implemented within the event notification and messaging system of FIG. 1, according to one embodiment;

FIG. 46 depicts a flow diagram of a method for processing an event change of status message within the notification and messaging system of FIG. 1, according to one embodiment; and

FIGS. 47A, 47B, 47C, and 47D depict a flow diagram of a method for processing a notification message to activate an automated response to a received event change of status message within the event notification and messaging system of FIG. 1, according to one embodiment.

In these figures, like structures are assigned like reference numerals but may not be referenced in the description of all figures.

### DETAILED DESCRIPTION OF PREFERRED EMBODIMENTS

### Introduction

The present disclosure describes novel and non-obvious systems and methods that receive event status messages each including a change in status of an event such as, for example, a school day, a meeting, a conference, an audition, rehearsal, show or performance, a schedule for travel, or the like (referred to hereinafter collectively as the event) held or conducted at a venue or location (hereinafter referred to as an event facility, described more fully below). In one embodiment, the event status message includes a change such as, for example, a delay, a closure or a cancellation of the event, an early dismissal from the event, a late dismissal from the event (e.g., a holdover of the event due to, for example, an emergency situation such as, for example, a lockdown or “shelter in place” order for the event facility preventing timely dismissal), or an alternative format for conducting the event. The systems and methods, as described herein, generate one or more notification messages in response to receipt of the event status messages that enable one or more attendees and/or others planning to attend or participate in the event, or pick up a participant after an end of the event to, automatically and selectively, adjust, revise, and/or adapt their schedules upon receipt of the notification messages. While described within the context of a school delay, closure, early or late dismissal notification system, it should be appreciated that the scope of the present invention is not limited to only this implementation. For example, it should be appreciated that the systems and methods described herein may be applied more generally to any event notification system wherein event organizers, local government officials, administrators of schools, universities, or other educational institutions, managers for television, film, and/or stage productions, administrators or staff of travel and/or transportation service providers, and the like, may wish to notify one or more attendees and others of a change in status such as, for example, a delay, closure, or cancellation of, or earlier or late/delayed dismissal from the event, or alternative format for the event, an emergency situation within a predetermined proximity to the event and/or its participants, or a scheduled arrival or departure time for a transportation vehicle, and allow a response thereto, for example, to allow an automatic and selective response so the one or more attendees, participants, or others planning to attend, participate in, or pick up a participant from the event may adjust, revise, and/or adapt their schedules upon receipt of the notification.

In one embodiment, the systems and methods described herein may generate one or more notification messages in response to receipt of an event status message to provide notification to two or more subsets of attendees and others at the event. For example, a first group or subset of attendees and others may include, e.g., staff or teachers, working at the event that are instructed to report to the event at a first time and a second group or subset of attendees and others may include persons participating in the event, e.g., as students that are instructed to report to the event at a second time, which is later in a day than the first time. In one embodiment, described herein, an event facility may be defined (e.g., registered within the system 100) to include the two or more subsets of attendees and others at the event. For example, in an exemplary use of the systems and methods described herein in a film or stage production environment, an event facility may be defined for all persons involved or associated with the production together, or two or more groups of the persons may be defined within the production such that, for example, principle or lead role performers are defined as a first group of users within the production event facility or as a first performer event facility, ensemble performers are defined as a second group of users within the production event facility or as a second performer event facility, and performers cast as extras are defined as a third group of users within the production event facility or as a third performer event facility. Accordingly, it should be appreciated that the term “event facility” should be broadly interpreted as both a physical location as well as a group of two or more attendees, others, or administrators associated with an event (e.g., user groups).

With respect to an alternative format for the event, in one embodiment the present invention addresses a change where, for example, an in-person learning/class session in which students physically go to a classroom at a school or other educational or event facility to attend the learning/class session may be changed to a remote learning/class session in which students are at-home or otherwise away from the event facility, and attend the learning/class session provided via virtual instruction. In this manner, the present disclosure is seen to support decision making where administrators of one or more schools or educational or event facilities decide that rather than losing a day of instruction for inclement weather or the like, the schools or other educational or event facilities revise their format for the learning/class sessions to be conducted via “remote learning” sessions. In one embodiment, a remote learning day(s) can start at the same time as an in-person learning day(s), or the remote day(s) may be delayed to allow students, teachers, and others to address any technology issues to ensure complete, or at least substantially complete attendance of as many participants as possible.

### System Overview

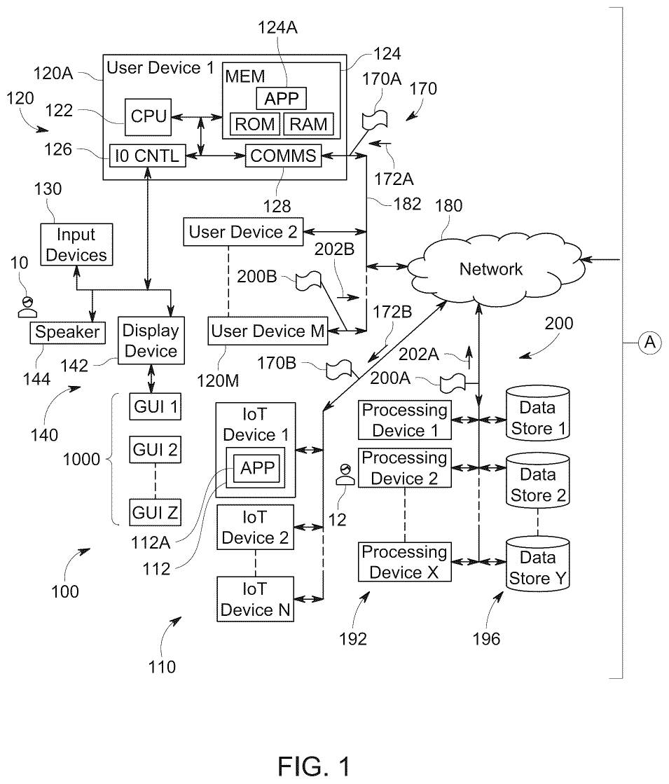

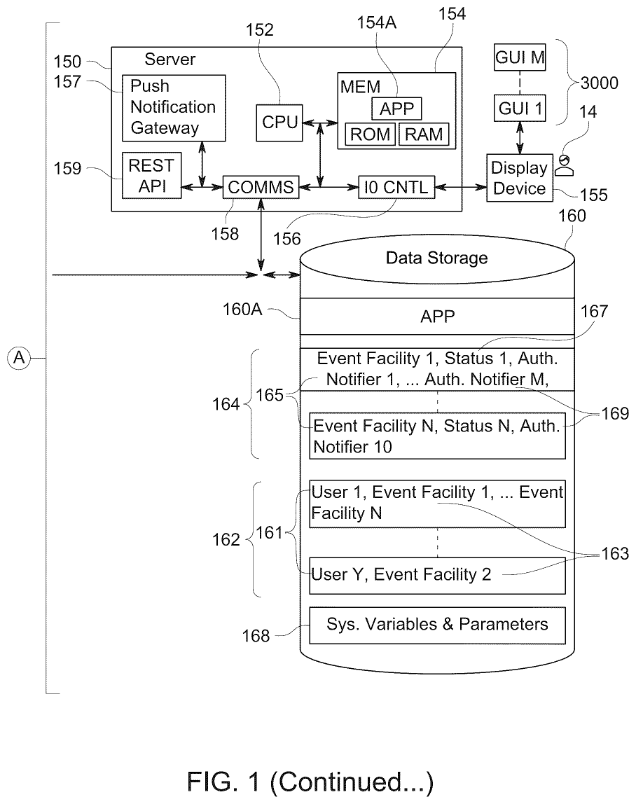

In various embodiments of an event notification and messaging system 100, illustrated in FIG. 1 and referred to as a School DelayZz™ system and application according to one embodiment. SCHOOL DELAYZZ is a trademark of Kohi, LLC of Wethersfield, Connecticut USA. Within the School DelayZz™ event notification and messaging system 100 one or more attendees and others, referred to hereinafter as users and shown generally at 10, operate a plurality of stationary and/or portable communication and/or computing devices (exemplary devices described below) referred to hereinafter as client/user devices shown generally at 120. The plurality of client/user devices 120, including client/user devices 120A to 120M, are each capable of receiving, processing, and displaying input and output such as the aforementioned event status messages, notification messages, system preferences, and the like, and of transmitting the notification messages and other messages or control signals over wired or wireless communication connections 182 via a network 180 such as, for example, a local area network (LAN), an intranet, extranet, the Internet, or other distributed communication network, to other devices (described below) operatively coupled to the communication network 180. The notification messages, system preference messages, and other messages or control signals distributed within the system 100 are illustrated in FIG. 1 generally at 170. In one embodiment, each of the client/user devices 120 includes or is operatively coupled via the network 180 to one or more processors (CPU) 122, memory (e.g., internal memory (MEM) 124 including hard drives, ROM, RAM, and the like), and/or data storage (e.g., hard drives, optical storage devices, and the like) as is known in the art. In one embodiment, each of the client/user devices 120 includes or is operatively coupled to one or more input devices 130 and one or more output devices, shown generally at 140, via an input/output controller (IO CNTL) 126.

In one embodiment, the input devices 130 include, for example, a keyboard, mouse, stylus, or like pointing device, buttons, wheels, touch pad, or touch screen portions of a display device, or input ports, and/or combinations thereof, for receiving and providing data and information to the client/user device 120. In one embodiment, the output devices 140 include, for example, one or more display devices 142 integral with or operatively coupled to the client/user device 120 to exhibit visual output, a speaker 144 to provide audio output, and/or a printer (not shown) to provide printed output. In one embodiment, the visual and printed output includes documents, images, and other visual representations of the data and information within the system 100. In one embodiment, the output devices exhibit one or more graphical user interfaces (GUIs, e.g., GUI 1 to GUI Z), shown generally at 1000, that may be visually perceived by a user/operator 10 operating one of the client/user devices 120. In one embodiment, the audio output and optionally, the visual output, may include an alarm and/or other signal or message set in advance to alert a user of the pre-set time to perform an action, e.g., wake up to attend an event, to leave to pick up someone at the event, and the like. In one embodiment, the alarm signal activated on the user device includes at least one of an audio notification message (e.g., an audio alarm tone) and a visual notification message (e.g., a text message). In one embodiment, the visual notification message enables a “snooze” option to instruct the user device to re-activate the alarm signal after expiration of a delay period of, for example, about nine seconds.

It should also be appreciated that for clarity purposes, components (e.g., CPU. MEM, IO CNTL, input and output devices and the like) are depicted in FIG. 1 only with reference to User Device 1 120A but equally may correspond to one or more of the other client/user devices 120 (User Device 2 to User Device M). In one embodiment, the client/user devices 120 include, for example, a personal computer or workstation, or portable computer processing devices such as, for example, a personal digital assistant (PDA), iPAD™ device, tablet, laptop, mobile radio telephone, smartphone (e.g., Apple™ iPhone™ device, Google™ Android™ device, etc.), or the like. It should be appreciated that the designations Apple, iPhone, and iPad are trademarks of Apple Inc. of Cupertino, California. It should also be appreciated that the designations Google and Android are trademarks of Google LLC of Mountain View, California.

In one embodiment, the event notification and messaging system 100 and each of the client/user devices 120 may be operatively coupled to and in communication with, via the network 180, a server 150. In one embodiment, the server 150 includes one or more processors (CPU) 152, memory (e.g., internal memory (MEM) 154 including hard drives, ROM, RAM, and the like), an input/output controller (IO CNTL) 156 for receiving and outputting data and information via input devices (not shown) and output devices including a display device 155 coupled thereto, and/or one or more data storage devices 160 (e.g., hard drives, optical storage devices, and the like) as is known in the art. In one embodiment, the display device 155 exhibits one or more graphical user interfaces (GUIs, e.g., GUI 1 to GUI M), shown generally at 3000, that may be visually perceived by one or more system administrators 14 operating the server 150. In one embodiment, illustrated in FIG. 1, each of the client/user devices 120 and the server 150 include communication circuitry (COMMS) 128 and 158, respectively, such as a transceiver or network interface card (NIC), for operatively coupling the client/user devices 120 and the server 150 by the wired or wireless communication connections 182 to the network 180, and in some embodiments to a plurality of processing devices 192 including, for example, processing devices 1 to X and/or a plurality of data storage devices 196, for example, data stores 1 to Y, also operatively coupled to and communicating with the network 180. In one embodiment, the server 150 includes a “push” or “server push” notification gateway 157 employed to disseminate the notification messages 170 throughout the system 100 as described herein. It should be appreciated that, while not shown, the network 180 may include, for example, cell towers, routers, repeaters, ports, switches, and/or other network components that comprise the Internet and/or a cellular telephone network and/or Public Switched Telephone Network (PSTN), as is known in the art. It should also be appreciated that the network 180 may include or utilize, for example, components and/or resources in a “cloud” or virtual environment. It should also be appreciated that communication and transfer of data between devices coupled to the network 180 may occur through protocols operating at various Open Systems Interconnection (OSI) model layers including, for example, Transmission Control Protocol/Internet Protocol (TCP/IP) on the Transport and Internet layers and/or the Hypertext Transfer Protocol (HTTP) and interfaces such as, for example, Application Programming Interfaces (APIs) including REST APIs 159 (APIs that conform to the design principles of the representational state transfer (REST) architecture), as are known in the art.

In one embodiment of the notification and messaging system 100, the server 150 is connected to the communication network 180 and communicates with (e.g., distributes the messages 170) to the user devices 120 connected with the network 180 and a plurality of relatively low-power, low-bandwidth, and/or low-processing power devices 110 (e.g., so called “smart” or Internet of Things (IoT) devices) that are operatively coupled to the communication network 180 and may communicate with the server 150 directly, or through one or more of the user devices 120, to receive the notification messages 170 to, for example, adjust or reset an audio and/or visual alarm or alert message enabled on the IoT device 110. In one embodiment, the alarm signal activated on the IoT device 110 includes at least one of an audio notification message and a visual notification message. In one embodiment, the visual notification message includes a “snooze” option to instruct the IoT device 110 to re-activate the alarm signal after expiration of a delay period of, for example, about nine seconds. In one embodiment, the server 150 may disseminate the notification messages 170 via the push notification gateway 157 to the user devices 120 (e.g., as notification messages 170A passed in a direction indicated by arrow 172A) and to the IoT devices 110 (e.g., as notification messages 170B passed in a direction indicated by arrow 172B), as shown in FIG. 1. In one embodiment, the IoT devices 110 are operatively coupled to (e.g., linked or synchronized to) and receive the notification messages 170 (including control signals) from at least one of the server 150 and one of the user devices 120. It should also be appreciated that for clarity purposes, while local memory (MEM) 112 is illustrated, other components (e.g., a processor or CPU, an IO CNTL, input and output devices, and the like) of the smart or IoT devices 110 are not depicted in FIG. 1. However, it should be appreciated that like client/user devices 120, these components may be present within the IoT devices 110. Exemplary IoT devices 110, illustrated in FIG. 1 as IoT Devices 1 to N, include, for example, devices within transportation vehicles (e.g., cars, trucks, boats, etc.), home systems and appliances (e.g., refrigerators, coffee makers, thermostats, etc.), and personal devices and/or consumer products (e.g., alarm clocks, wristwatches, electronics, etc.). It should be appreciated that this list of exemplary smart or IoT devices 110 is provided for illustration purposes only and is not intended to limit the scope of the present disclosure as other devices may receive and act upon the messages 170 received within the system 100.

In one embodiment, event status messages, shown generally at 200, are provided to and/or retrieved by the event notification and messaging system 100 from, for example, the aforementioned event organizers, local government officials, administrators of schools, school districts, or universities, managers for television, film, and/or stage productions, administrators or staff of travel and/or transportation service providers, and the like, utilizing the system 100 as one of the users 10 operating one of the user devices 120 or providing information to the system 100 as an unaffiliated third-party 12 operating one of the processing devices 192. The users 10 and unaffiliated third-parties 12 providing the notification message 200 to the system 100 are referred to hereinafter collectively as notifiers. The event status messages 200 from the notifiers include a change in status of an event such as, for example, a delay, closure, or cancellation of the event, early or late dismissal of the event, or a revised format for the event. In one embodiment, the event status messages 200 are provided to the event notification and messaging system 100, shown as messages 200A sent in a direction indicated by arrow 202A, from the notifiers via an electronic mail message, electronic broadcast message, alert, or like dissemination of news or information, API call, or data feed (e.g., XML feed, CSV feed, or like data feed) from one of the processing devices 192 to the server 150, or by the notifier as one of the users 10 of the event notification and messaging system 100 operating one of the client/user devices 120 to directly input the event status messages, shown as messages 200B sent in a direction indicated by arrow 202B, to the server 150. In one embodiment, the notifier operates one of the client/user devices 120 to input the event status messages 200B via, for example, one of the GUIs 1000 (described below) and to send the input event status messages 200B to the server 150.

In one aspect of the event notification and messaging system 100, the IoT devices 110, the client/user devices 120, and the server 150 execute a plurality of programmable instructions of a multifunctional School DelayZz software application or app (e.g., “APP”) of the School DelayZz system 100, or portions or modules thereof, 112A, 124A, 154A, or 160A, stored in local memory 112, 124, 154, or network memory 160, respectively, to implement the system 100 and features and/or functions thereof that receive the event status messages 200 including a change in status or format of the event, generate the notification messages 170 in response thereto, and that enable automatically and selectively, one or more attendees or others to adjust, revise, and/or adapt their schedules upon receipt of the notification messages. In one embodiment, users of the system 100 (e.g., the operators 10 operating the user devices 120 or the unaffiliated third-party notifiers 12) may be granted differing authorizations or permissions and/or levels thereof, to execute various ones of the features and/or functions of the system 100. For example, the authorizations or permissions may specify whether a user or notifier may access and/or manipulate, e.g., perform operations upon, information stored and/or processed within the system 100, as described herein.

### Client/User Application Overview—Mobile Device

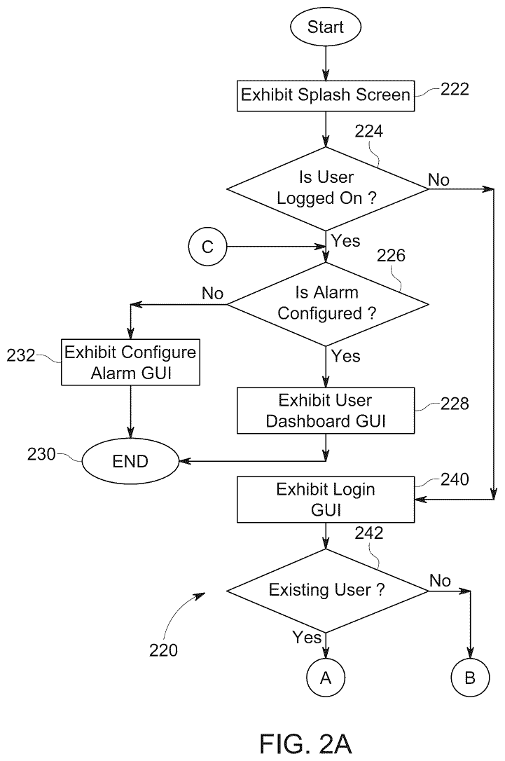

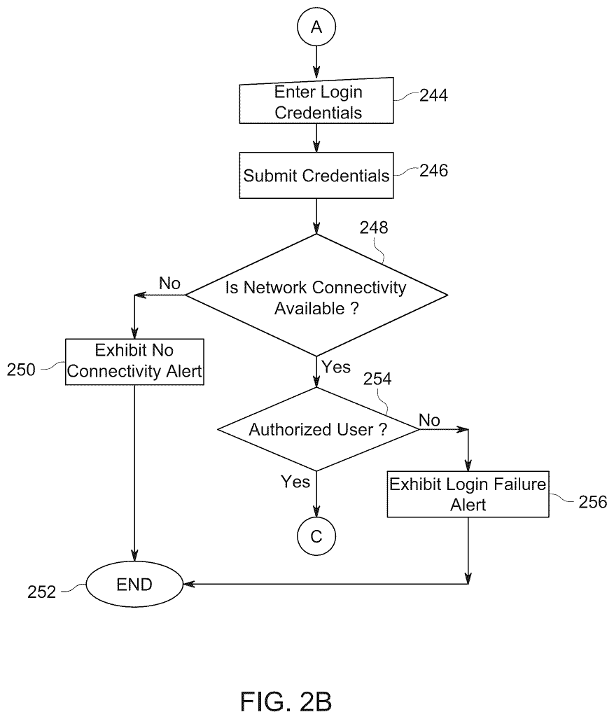

In one embodiment, the users of the system 100 (e.g., the operators 10 of one of the user devices 120) interact with the server 150 during one or more processes/methods of the School DelayZz APP (e.g., APPs 112A, 124A, 154A, 160A) executed within the system 100 via one or more of the GUIs 1000 and 3000 exhibited to the users 10 and to the system administrators 14. For example, FIGS. 2A and 2B depict a Login method 220 of the School DelayZz APP 124A executing on one of the client/user devices 120. It should be appreciated that while presented as a client/user login method on, for example, a mobile telecommunication or computing device, a similar login method is employed for system administrators 14 accessing the system 100 by login in through the server 150 and event facility (e.g., school) administrators 10 accessing the system 100 via an internet website, as described below.

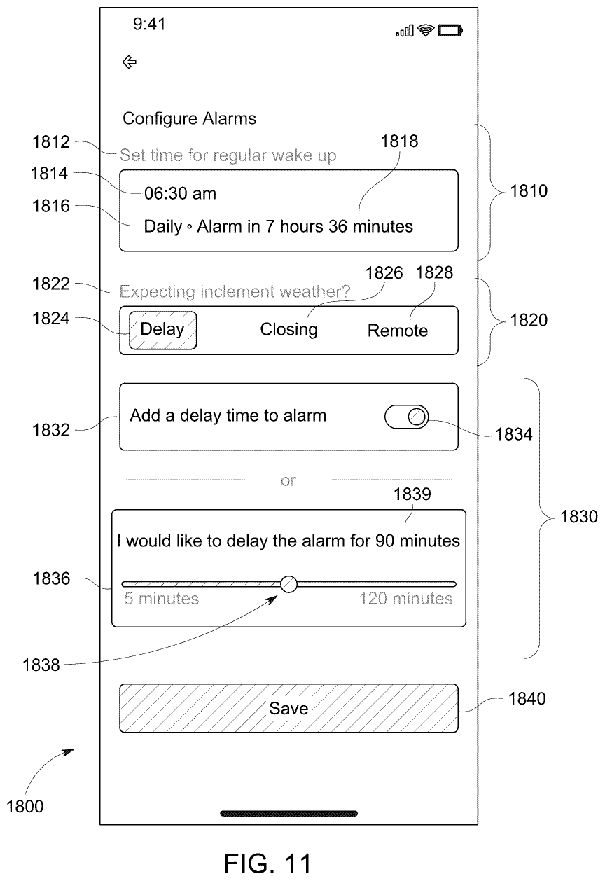

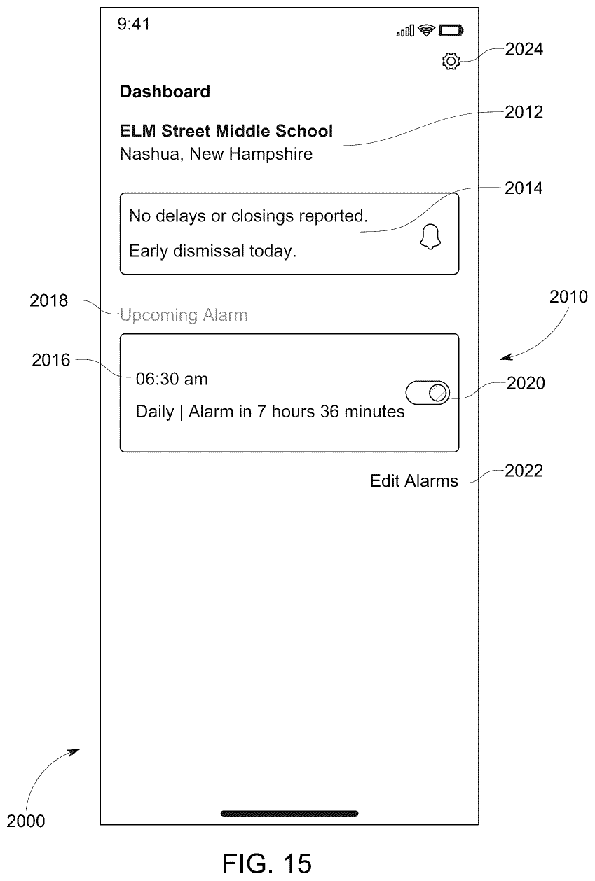

Referring again to FIGS. 2A and 2B, at Step 222, the operator 10 of the client/user device 120 is exhibited a Splash Screen including the School DelayZz™ system logo (not shown) as the School DelayZz APP 124A loads. At Step 224, the APP 124A determines whether the operator 10/user is logged on to the APP. If the user is logged on to the APP 124A, a “Yes” path is followed from Step 224 to Step 226. At Step 226, the APP 124A determines whether an alarm is configured for responding to one or more of the notification messages 170 received at the user device 120 from the server 150. If at least one alarm is already configured, then the APP 124A continues executing the Login method 220 and follows a “Yes” path from Step 226 to Step 228 where a User Dashboard GUI 2000, illustrated in FIG. 15, is exhibited to the user 10 and execution of the Login method 220 proceeds to Step 230 where its execution ends. Referring again to Step 226, if the user is logged on and no alarms are configured, then the APP 124A continues executing the Login method 220 and follows a “No” path from Step 226 to Step 232 where a Configure Alarms GUI 1800, illustrated in FIG. 11, is exhibited to the user 10. Once exhibited, execution of the Login method 220 proceeds from Step 232 to Step 230 where execution ends.

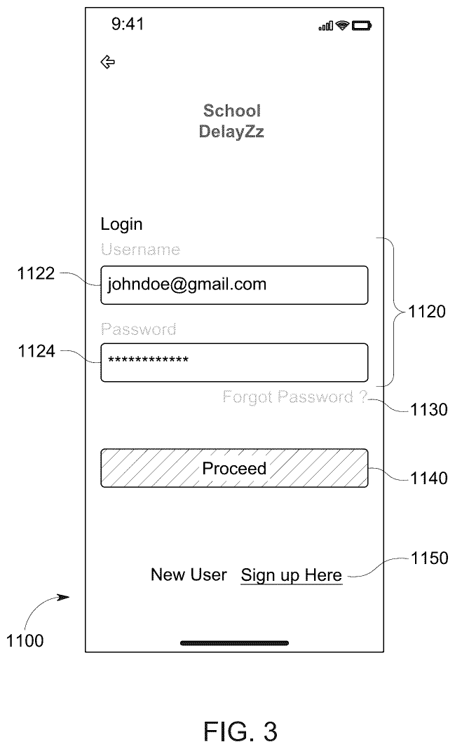

Referring again to Step 224 of the Login method 220, if the user is not logged on to the APP 124A, a “No” path is followed from Step 224 to Step 240. At Step 240, a Login GUI 1100, illustrated in FIG. 3, is exhibited to the user 10. In the Login GUI 1100 the user 10 informs (via actions taken) the APP 124A whether he/she is an existing user of the system 100 or whether the user 10 is a new user. At Step 242, the APP 124A determines whether the user 10 is an existing or a new user. If the user 10 is an existing user of the system 100, then a “Yes” path is followed from Step 242 to Step 244 by following a connector labeled “A” from FIG. 2A to FIG. 2B. At Step 244, the user enters his/her login credentials. For example, as illustrated in FIG. 3, an existing user 10 enters their login credentials in a region shown generally at 1120. In one embodiment, the login credentials 1120 include a unique username entered into a username field 1122 labeled “Username” and a password entered into a password field 1124 labeled “Password.” If the existing user has forgotten their password, a “Forgot Password” navigation control 1130 may be selected to initiate a password reset process, as is known in the art, using, for example, a registered electronic mail address previously provided to the system 100. Once the user 10 has entered their login credentials 1120, the user 10 selects a “Proceed” control button 1140 to submit the login credentials to the APP 124A. At Step 246 of FIG. 2B, the AP164P 124A receives the user's submitted credentials and initiates an inquiry to verify whether the user is an authorized user of the system 100. For example, in one embodiment, a list of authorized users 10 of the system 100 is maintained in the data storage device 160, as shown generally at 162. The user list 162 is populated during a registration process (outlined below) wherein usernames 161 and associated one or more event facilities 163 (e.g., schools, school districts, event venues, and the like) are defined and stored within the data storage device 160. As the verification process is undertaken, the APP 124A continues executing the Login method 220 and at Step 248 determines whether the user device 120 operated by the user 10 has sufficient network connectivity available, for example, is able to receive the notification messages 170 over the communication connections 182 of the network 180 from the server 150. If network connectivity is not available to the user device 120, then execution of the APP 124A proceeds from Step 248 to Step 250 along a “No” path. At Step 250, a warning or alert message (not shown) is exhibited to the user 10 informing the user that no or insufficient connectivity is available. Once the warning or alert message is exhibited, execution of the Login method 220 proceeds from Step 250 to Step 252 where execution ends. Referring again to Step 248 (FIG. 2B) of the Login method 220, if sufficient network connectivity is available to the user device 120, then execution of proceeds from Step 248 to Step 254 along a “Yes” path. At Step 254, the APP 124A evaluates the results of the verification process to determine whether the user 10 is an authorized user of the system 100. If the user 10 is not authorized user (e.g., has not been previously registered as a user or has an inactive status), then execution of the Login method 220 proceeds from Step 254 to Step 256 where the APP 124A exhibits a “Login Failure” or similar alert message (not shown) to the user and execution proceeds from Step 256 to Step 252 where execution of the Login method 220 ends. If the user 10 is an authorized user (e.g., previously registered user having an active status), then execution of the Login method 220 proceeds from Step 254 back to Step 226 by following a connector labeled “C” from FIG. 2B to FIG. 2A, where the alarm configuration status is determined.

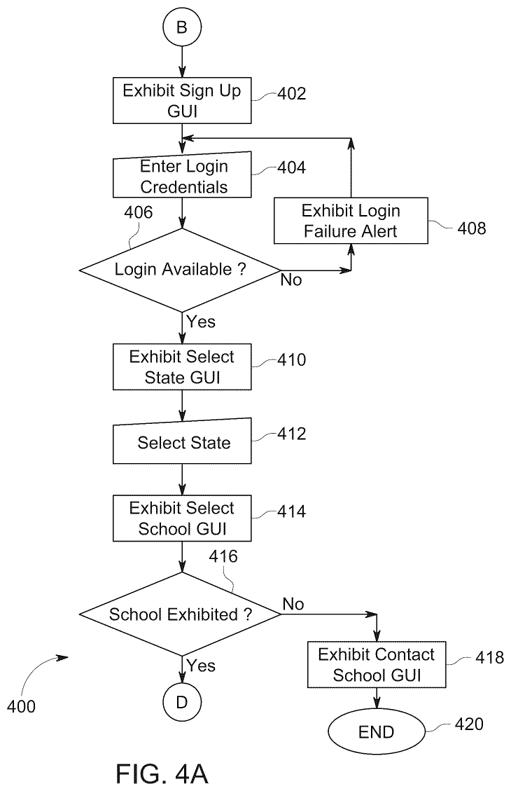

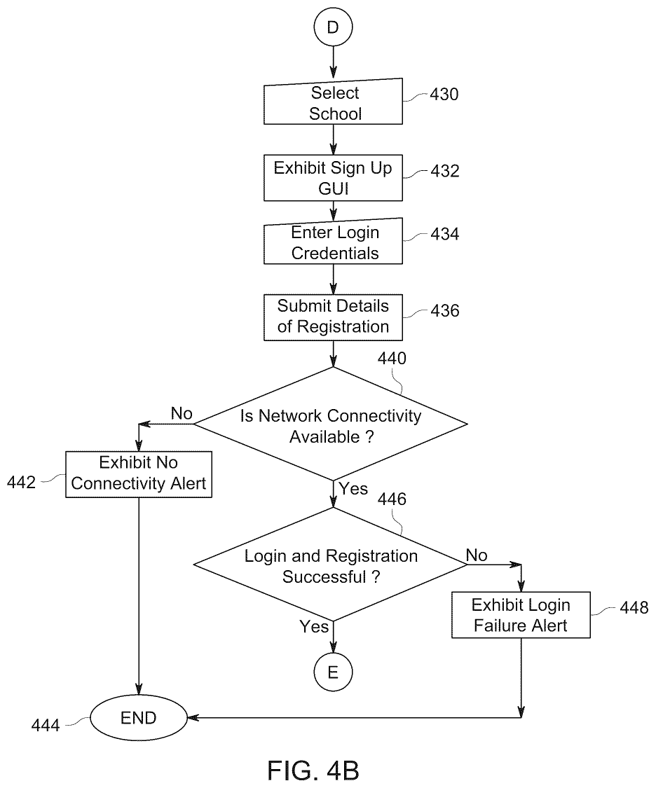

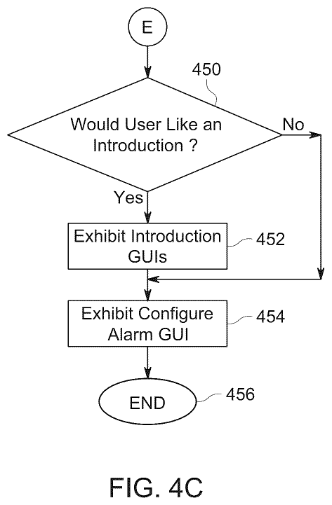

Referring again to Step 242 of the Login method 220 of FIG. 2A, if the user is not an existing user (e.g., not previously registered or registered but with an inactive status) of the system 100, then execution proceeds from the Login method 220 of FIGS. 2A and 2B to a New User Sign Up method 400 of FIGS. 4A, 4B, and 4C by following a connector labeled “B” from FIG. 2A to FIG. 4A. For example, execution proceeds from Step 242 of FIG. 2A to Step 402 of FIG. 4A by following the connector labeled “B” from FIG. 2A to FIG. 4A. Similarly, and referring to the Login GUI 1100 of FIG. 3, if the user selects a “New User Sign Up Here” navigation control 1150 on the Login GUI 1100, the APP 124A invokes the New User Sign Up method 400 of FIGS. 4A, 4B, and 4C.

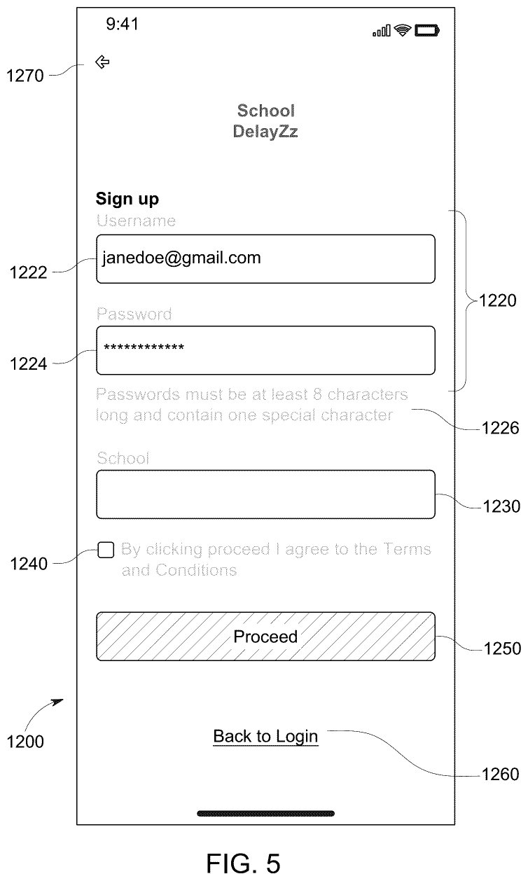

At Step 402, a Sign Up GUI 1200, illustrated in FIG. 5, is exhibited to the user 10 so that the user may register with the system 100. In the Sign Up GUI 1200, the new user defines his/her login credentials. For example, as illustrated in FIG. 5, the new user 10 enters their choice of login credentials in a region shown generally at 1220. In one embodiment, the login credentials 1220, like those of the login credentials 1120 for existing users (FIG. 3), include a unique username entered into a username field 1222 labeled “Username” and a password entered into a Password field 1224 labeled “Password.” In one embodiment, the user's username is an electronic email (e.g., email) address of the user. The email address may be used by the system 100 to contact the user, for example, to reset the user's password or to perform other administrative tasks. In one embodiment, the Sign Up GUI 1200 includes textual instructions 1226 aimed to inform the new user of system 100 requirements of a valid password (e.g., a minimum length and required character(s)). In one embodiment, the new user may also input an event facility, for example, school name, if known to be participating in the system 100, in a School field 1230 labeled “School” of the Sign Up GUI 1200. In one embodiment, the Sign Up GUI 1200 also includes an Agree checkbox control element 1240 labeled “By clicking proceed I agree to the Terms and Conditions,” where the new user is asked to confirm that he/she agrees to certain Terms and Conditions for utilizing the event notification and messaging system 100, and the features and functions thereof. Once the user 10 has entered their login credentials 1220, the user 10 selects a “Proceed” control button 1250 to submit the login credentials. Alternatively, the user may terminate the New User Sign Up method 400 and quit the Sign Up GUI 1200 by selecting a “Back to Login” navigation text element 1260 or an arrow navigation control element 1270, which if invoked, reloads the Login GUI 1100 of FIG. 3 and restarts the Login method 220 at Step 224.

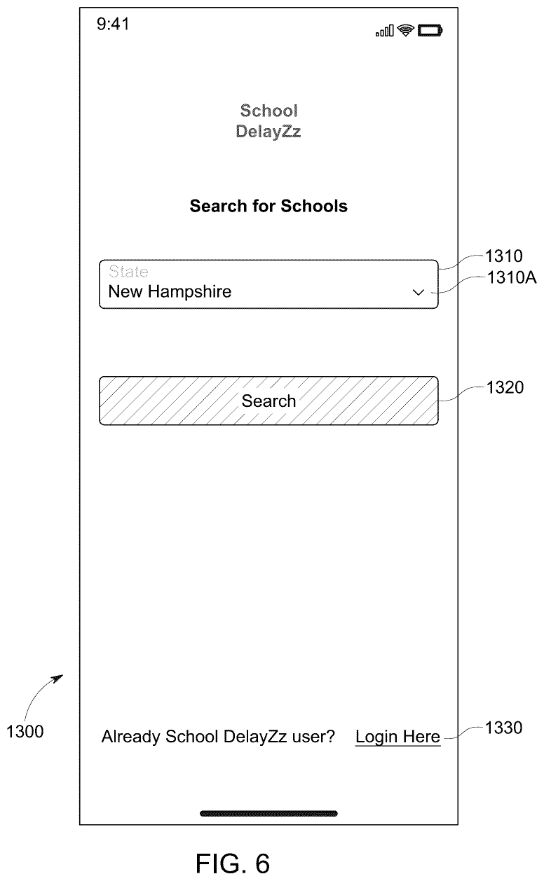

Referring again to FIG. 4A, at Step 404 of the New User Sign Up method 400, the entered login credentials input into fields 1222 and 1224 are received by the APP 124A. At Step 406, an inquiry is initiated to determine whether the input login credentials, for example, the username, is available for adoption and use in the system 100. As noted above, in one embodiment, usernames within the system 100 are unique therefore two users cannot share a same username. If at Step 406 the login credentials are not available for use, execution proceeds along a “No” path from Step 406 to Step 408. At Step 408, the APP 124A exhibits a “Login Failure” or similar alert message (not shown) to the user and execution proceeds back to Step 404 where the user is prompted to again enter new login credentials. Referring again to Step 406, if the new user's login credentials are available, then execution of the APP 124A continues and proceeds from Step 406 to Step 410 along a “Yes” path. At Step 410, the APP 124A exhibits a Select State GUI 1300 as depicted in FIG. 6. As shown in FIG. 6, the Select State GUI 1300 includes a State field 1310 labeled “State” where a user may manually input a state name (e.g., a State within the United States of America) and invoke a search function whereby the School DelayZz APP 124A searches for schools, school districts, venues, or event facilities within the selected state that are registered and/or are participating within the system 100. In one embodiment, the State field 1310 includes a drop-down list element 1310A that provides predefined, acceptable options for the State fields, for example, the States within the United States of America in, for example, an alphabetically ordered list. Once a State is selected from the drop-down list and/or otherwise entered into the State field 1310, the user 10 selects a “Search” control button 1320 to submit the selected State (e.g., value within the State field 1310) to the APP 124A. Alternatively, the user 10 may terminate the New User Sign Up method 400 and quit the Select State GUI 1300 by selecting an “Already School DelayZz User? Login Here” navigation text element 1330, which if invoked, reloads the Login GUI 1100 of FIG. 3 and restarts the Login method 220 at Step 224.

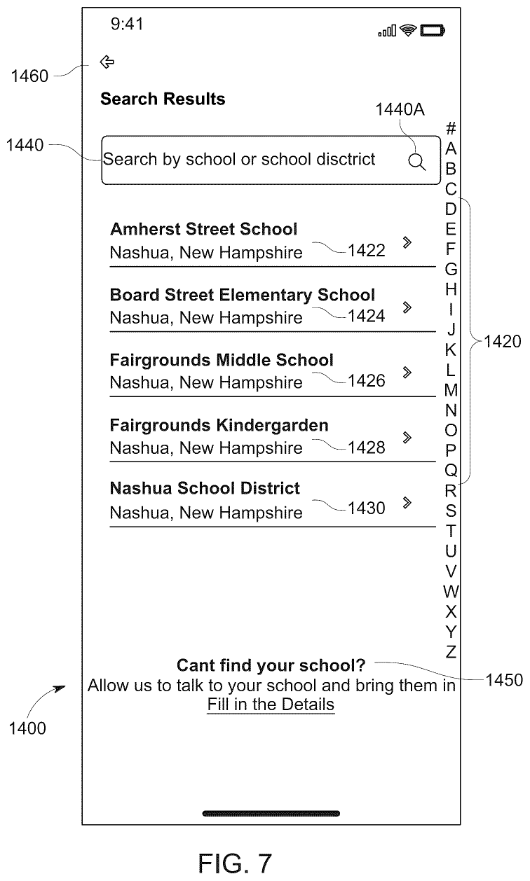

Referring again to the New User Sign Up method 400 of FIG. 4A, at Step 412, the user 10 selected State (input to the State field 1310) is received by the APP 124A and, once received, the APP 124A retrieves from the data storage device 160 the event facilities (e.g., schools, school districts, event venues, user groups, and the like) within the selected State. It should be appreciated that while described as one or more event facilities, as described above it is within the scope of the present disclosure for the one or more event facilities to include groups of users within one of the event facilities or a group of users being defined individually as one of the event facilities. For example, groups may include user groups associated with one facility such as, a teachers group, an administrators group, a staff group, and a students group, and defined as a subset of a specified school as the event facility, or the groups may be defined individually as their own event facilities having the characteristics of the specified school. In one embodiment, registered or participating ones of the event facilities are stored within the data storage device 160 in an event facilities list, shown generally at 164, which includes fields corresponding to the event facility including, e.g., the event facility's name 165, location, and other identifying information, a status 167 of the facility, and a list of one or more authorized persons 169 that are approved or otherwise authorized to provide a change of status of one or more events held at the event facility and/or other characteristics of the facility within the system 100. As shown in FIG. 1, these approved or authorized persons are referred to as Authorized Notifiers 169 for the event facility 165. It should be appreciated that while the status field 167 of the event facilities list 164 is shown as one field, in one embodiment, the status field 167 may include both a status of the event facility's registration within the system 100, for example, whether it is active and participating, whether the facility's registration is pending (e.g., initial registration awaits review and approval), or whether the event facility is inactive for some reason or condition, as well as a status of events held at the facility, for example, whether one or more events at the event facility are delayed or cancelled, or whether the event is being conducted with a change in format (e.g., conducted remotely). At Step 414 of the New User Sign Up method 400, the retrieved event facilities from the list of event facilities 164 located within the selected State are exhibited to the user 10 on a Select School GUI 1400 of FIG. 7. As shown in FIG. 7, the Select School GUI 1400 includes a list of Event Facilities, shown generally at 1420, including individual facilities (e.g., schools) 1422, 1424, 1426, and 1428, and/or grouping of facilities (e.g., school districts) 1430 registered or participating within the School DelayZz system 100. In one embodiment, the list of Event Facilities 1420 includes additional identifying information such as, for example, a City and State name. In one embodiment, a Search field 1440 labeled “Search by school or school district” is provided to locate a particular event facility within the list of Event Facilities 1420, which may be long in length for certain States. The user 10 may enter a name of an event facility within the Search field 1440 and select a magnifying-glass icon 1440A to initiate a search for the input event facility (e.g., value of the Search field 1440) within the exhibited list 1420.

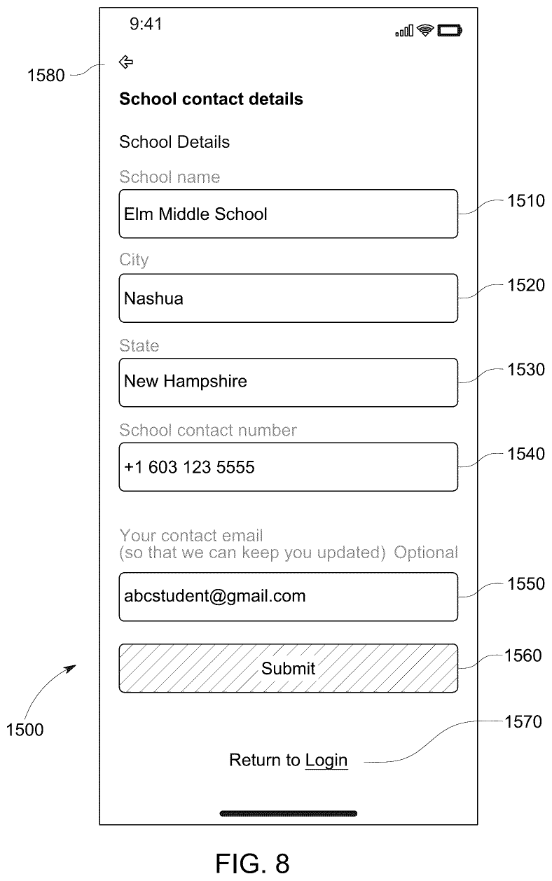

Once the list of Event Facilities 1420 is exhibited, at Step 416 of the New User Sign Up method 400, it is determined (e.g., based on user action) whether the user's desired event facility (e.g., school, school district, user group, etc.) is exhibited within the list of Event Facilities 1420. If the user's desired event facility is not within the 1420, the user 10 may initiate a process to sign-up, register, or otherwise invite their desired event facility to enroll or participate in the School DelayZz system 100. For example, if the user's desired event facility is not exhibited within the list of Event Facilities 1420, the user may select the “Can't find your school? Allow us to talk to your school and bring them in. Fill in the Details” navigation text element 1450 on FIG. 7, which if invoked, the APP 124A continues to execute the New User Sign Up method 400 by following a “No” path from Step 416 to Step 418. At Step 418, the APP 124A continues to execute the New User Sign Up method 400 and exhibits a Contact School GUI 1500 of FIG. 8. As shown in FIG. 8, the Contact School GUI 1500 includes fields for identifying an Event Facility that is not currently available within the system 100 (e.g., not registered or participating) and which the user 10 would like an administrator of the system 100 to contact and invite to join the system 100. For example, the Contact School GUI 1500 of FIG. 8 includes an Event or School Name field 1510 labeled “School name,” location information such as, for example, a City field 1520 labeled “City” and a State field 1530 labeled “State,” a Contact Number field 1540 labeled “School contact number,” and optionally, a Your Contact Email field 1540 labeled “Your contact email (so that we can keep you updated),” where the user may input his/your contact email address to be kept apprised of enrollment within the system 100 of this new event facility. Once completed, the user 10 selects the “Submit” control button 1560 to provide the contact information to the system 100 (e.g., a system administrator). The APP 124A then continues to execute the New User Sign Up method 400 passing from Step 418 to Step 420 where execution ends. Alternatively, the user 10 may quit the Contact School GUI 1500 of FIG. 8 by selecting a “Return to Login” textual navigation control 1570 to return to the Login GUI 1100 of FIG. 3 or the user 10 may select an arrow navigation control element 1580, which if invoked, reloads the Select School GUI 1400 of FIG. 7 and restarts the New User Sign Up method 400 at Step 416. Referring again to the Select School GUI 1400 of FIG. 7, the user 10 may quit the Select School GUI 1400 of FIG. 7 by selecting an arrow navigation control element 1460, which if invoked, reloads the Select School GUI 1300 of FIG. 6 and restarts the New User Sign Up method 400 at Step 410.

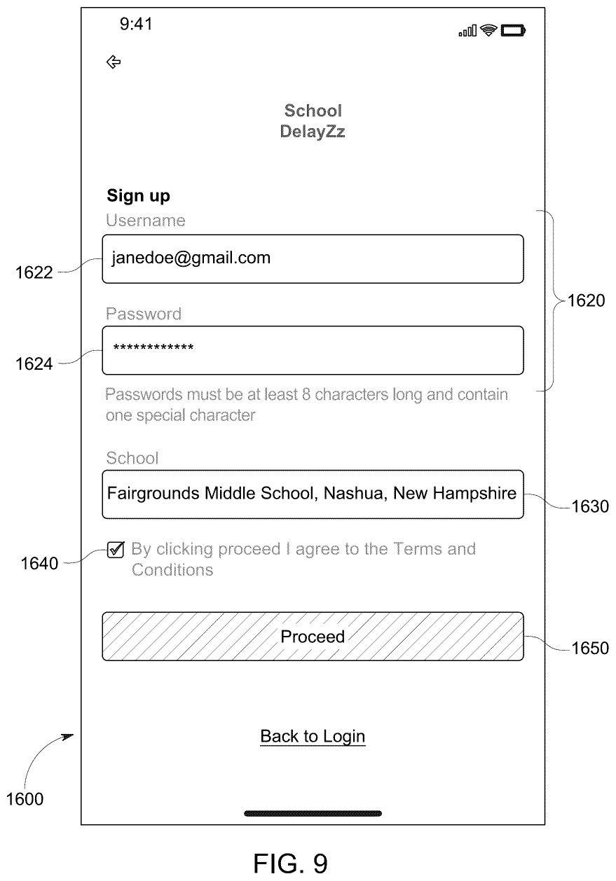

Referring again to the New User Sign Up method 400 of FIG. 4A, at Step 416, if the user's desired event facility is exhibited within the list 1420 (FIG. 7), execution of the method 400 proceeds from Step 416 of FIG. 4A to Step 430 of FIG. 4B by following a connector labeled “D” from FIG. 4A to FIG. 4B. At Step 430, the user 10 selects one of the events (e.g., a school, school district, user group, or the like) exhibited in the list of Event Facilities 1420 of FIG. 7. Execution of the New User Sign Up method 400 by the APP 124A then proceeds from Step 430 to Step 432 where a Sign Up GUI 1600 of FIG. 9 is exhibited. It should be appreciated that the Sign Up GUI 1600 of FIG. 9 is substantially similar to the Sign Up GUI 1200 of FIG. 5. However, in FIG. 9, the Sign Up GUI 1600 is now populated with the selected event from the list of Event Facilities 1420 in FIG. 7. For example, the user 10 selects the exhibited event labeled “Fairgrounds Middle School, Nashua, New Hampshire” at 1426 of FIG. 7 and that value is populated in the “School” field 1630 of FIG. 9. Execution of the New User Sign Up method 400 continues and proceeds from Step 432 to Step 434 where the user enters their login credentials (e.g., a username and password) into a Login Credentials region 1620 including a Username field 1622 labeled “Username” and Password field 1624 labeled “Password.” As shown in FIG. 9, the user 10 may also indicate their acceptance of certain Terms and Conditions of the event notification and messaging system 100 via a Checkbox control element 1640. Once the user 10 has completed their actions, the user 10 selects the “Proceed” control button 1650 to provide their Login Credentials to the system 100 (e.g., a system administrator). Execution of the New User Sign Up method 400 by the APP 124A continues and proceeds from Step 434 to Step 436 where the APP 124A submits the details of the user's registration to the system 100. For example, within the registration process the user's is added as an authorized user 161 of the system 100. In one embodiment, the user's information is added to the list of authorized users 162 of the system 100 maintained in the data storage device 160. As shown in FIG. 1, in one embodiment, the list of authorized users 162 includes the username 161 and associated one or more event facilities 163 (e.g., schools, school districts, event venues, user group, and the like), for example, as specified in the school field 1630 of the Sign Up GUI 1600 of FIG. 9. As should be appreciated, in one aspect of the present disclosure, the association between users 161 and one or more event facilities 163 means that a change in status of an event held at the one or more facilities is communicated by the system 100 to each of the users 161 associated with the event facility 163 to allow for a selectively and automatic response to the change in status as described herein. In one embodiment, the registration process may include storing additional informational or status fields related to the user. For example, in one embodiment, a user may be identified as having an “active” (regular, authorized user) or an “inactive” status (non-participating user). In one embodiment, a system administrator monitors and updates the status of users 10 within the system 100. In one embodiment, the user status information is stored within the list of authorized users 162. Alternatively, the user status information is stored in another active versus inactive user list in the data storage device 160, for example, together with other variables and/or parameters of the system 100 that are used by the system, shown stored generally at 168.

As information within the registration process is being recorded (e.g., stored), the APP 124A continues executing the New User Sign Up method 400 and at Step 440 (FIG. 4B) determines whether the user device 120 operated by the user 10 has sufficient network connectivity available, for example, is able to receive the notification messages 170 over the communication connections 182 of the network 180 from the server 150. If network connectivity is not available to the user device 120, then execution of the New User Sign Up method 400 by the APP 124A proceeds from Step 440 to Step 442 along a “No” path. At Step 442, a warning or alert message (not shown) is exhibited to the user 10 informing the user that no or insufficient connectivity is available. Once the warning or alert message is exhibited, execution of the New User Sign Up method 400 proceeds from Step 442 to Step 444 where execution of the New User Sign Up method 400 ends. Referring again to Step 440 of the New User Sign Up method 400, if sufficient network connectivity is available to the user device 120, then execution of proceeds from Step 440 to Step 446 along a “Yes” path. At Step 446, the APP 124A evaluates the results of the login and registration process to determine whether the user 10 has successfully been added as an authorized user of the system 100. If the login and registration process is not successful, then execution of the New User Sign Up method 400 proceeds from Step 446 to Step 448 along a “No” path, where the APP 124A exhibits a “Login Failure” or similar alert message (not shown) to the user and execution proceeds from Step 448 to Step 444 where execution of the New User Sign Up method 400 ends. If the login and registration process is successful, then the user 10 is added as authorized user and execution of the New User Login method 400 proceeds from Step 446 to Step 450 along a “Yes” path and by following a connector labeled “E” from FIG. 4B to FIG. 4C.

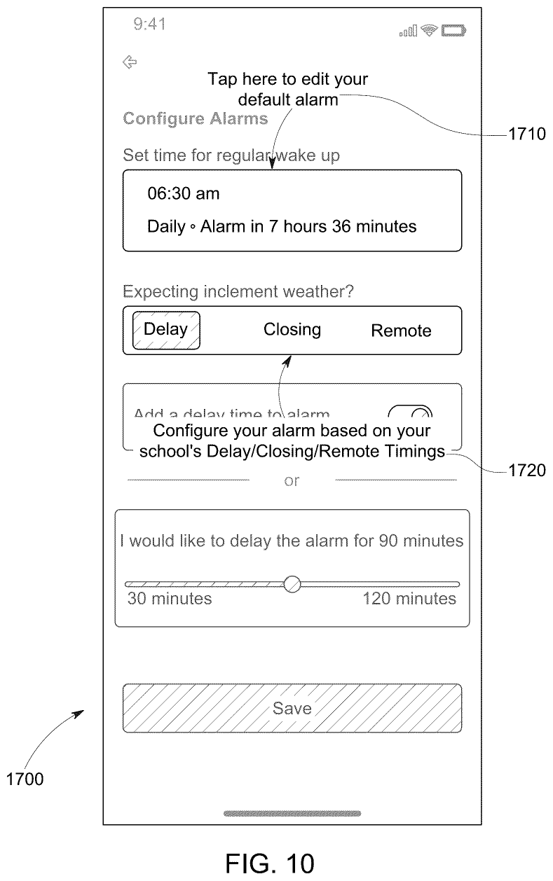

As the added user 10 is a new user to the system 100, at Step 450, the APP 124A presents the user 10 with an option to view one of more exemplary GUIs 1000 that provide an introduction to the system 100 and its features and functions. For example, if the user 10 indicates that he/she does want to view an introduction, execution proceeds from Step 450 to Step 452 along a “Yes” path. At Step 452, the APP 124A exhibits a Configure Alarm Introduction GUI 1700, illustrated in FIG. 10, to the user 10. In one embodiment, the Configure Alarm Introduction GUI 1700 is one of a number of GUIs 1000 that include GUIs that invoke a number of features and functions of the system 100 (as described below) but in this introduction mode, the Configure Alarm Introduction GUI 1700 is overlayed with instructional text, shown generally at 1710 and 1720, to sequentially demonstrate how to use functionality such as, for example, editing default alarm settings 1710 and/or configuring an alarm 1720 based on a change of status of an event at an event facility such as a Delay, Closing, or change of format to Remote participation. If at Step 450, the user 10 indicates that he/she does not want to view the introduction, execution proceeds from Step 450 to Step 454 along a “No” path. At Step 454, the APP 124A exhibits a Configure Alarms GUI 1800 of FIG. 11, where, as discussed below, the user 10 may input one or more alarm settings in response to receipt of one or more notification messages 170 received from the server 170. While the user 10 may then continue to utilize the system 100 to configure one or more of the alarms, execution of the New User Login method 400 by the APP 124A ends at Step 456.

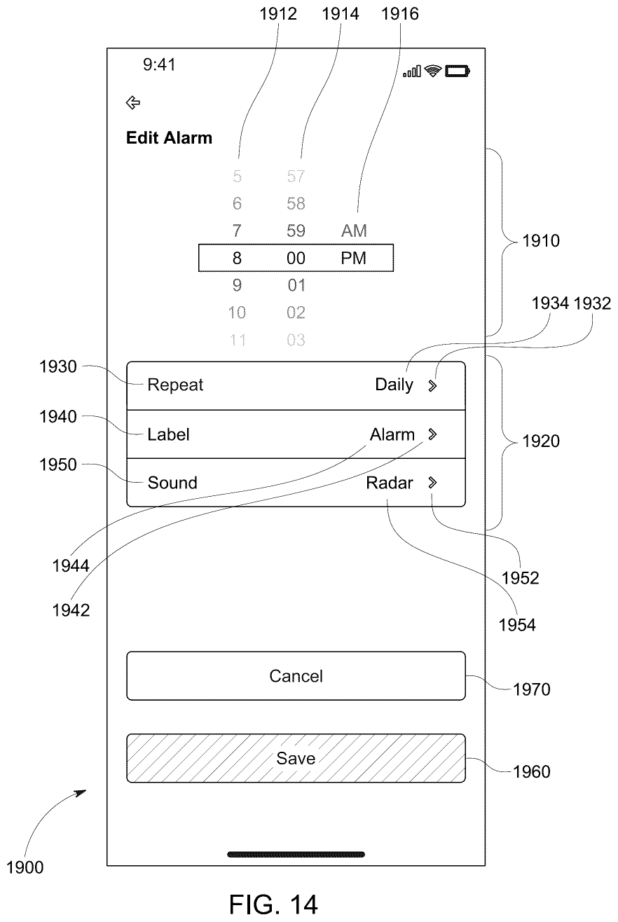

As shown in FIG. 11, the Configure Alarms GUI 1800 includes one or more regions, for example, a first region, a second region, and a third region, shown generally at 1810, 1820, and 1830, respectively, that guide a user 10 to define their response to receipt of one or more notification messages 170 received from the system 100. In one embodiment, the first region 1810 is identified by, for example, a textual label “Set time for regular wake up” 1812. In the first region the user 10 specifies (e.g., inputs) an alarm setting defining a regular or usual time of day for them to wake up to attend an event (e.g., a school day, a meeting, a conference, a schedule for travel, or the like) taking into account no change in the status of a planned start time for the event. In one embodiment, the alarm setting is defined in field 1814 as a value of, for example, “06:30 am”. In one embodiment, the user 10 may manually enter the alarm value (e.g., type in the value for the field using an input device such as a keyboard or touch screen display) or, as describe below, may select the field (e.g., double click the field with an input device such as a mouse) to invoke an Edit Alarm GUI 1900 of FIG. 14. In one embodiment, as shown in FIG. 11, the first region 1810 includes a recurrence setting 1816 shown as a value of “Daily,” indicating that the alarm setting is repeated in a twenty-four (24) hour cycle, and a time period for a next alarm to be triggered 1818 shown as a value of “Alarm in 7 hours 36 minutes.” As described below, the recurrence setting 1816 is definable by the user 10 in, for example, the Edit Alarm GUI 1900 of FIG. 14. In one embodiment, the values within the next alarm to be triggered field 1818 are calculated by the system 100 based upon predefined settings by the user 10 and a current time of day.

In one embodiment, the second region 1820 is identified by, for example, a textual label “Expecting inclement weather?” 1822. In the second region 1820 the user 10 specifies their response in relation to the type of change in status for the event, e.g., whether a received notification messages 170 informs the user 10 that the event is one of delayed, closed or cancelled, or its format has changed to a remote session. In one embodiment, the second region 1820 identifies each of these types of changes by, for example, control tabs 1824, 1826, and 1828, labeled “Delay”, “Closing”, and “Remote”, respectively. When the user 10 selects one of the control tabs 1824, 1826, 1828, they are defining the response to the selected type of change in status for the event. For example, as the Delay control tab 1824 is selected in FIG. 11, the user 10 is defining the response to receipt of one of the notification messages 170 indicating that the event has been delayed. As shown in the third region 1830, in response to the selection of the Delay control tab 1824, the user 10 is provided, for example, with two options, shown at 1832 and 1836. In a first option 1832, the user 10 may activate a toggle control element 1834 to add a delay time to their alarm setting (e.g., the value within the field 1814) equal to the time delay for the event as indicated within the notification message 170. For example, if a start of the event (e.g., school day) is delayed sixty (60) minutes and the user 10 activated the toggle control element 1834 in advance to receiving the notification message 170, then in response to receiving the notification message 170 the School DelayZz APP 124A automatically adds a sixty (60) minute delay to the user 10 alarm setting. In this example, the APP 124A adds sixty (60) minutes to the value of “6:30 am” in field 1814 resulting in a new value of “7:30 am” in field 1814 such that a timekeeping device, e.g., one of the IoT devices 110, associated with the School DelayZz system 100 triggers its alarm at this new 7:30 am time as opposed to the previous 6:30 am time setting. In a second option 1836, the user 10 may activate a slider control element 1838 to add a variable delay time from between, for example, a numeric value of five (5) minutes to one hundred twenty (120) minutes, to their alarm setting (e.g., the value within the field 1814). In one embodiment, the Configure Alarms GUI 1800 exhibits a delay period 1839 (e.g., “90 minutes”) set by the user 10 activating the slider control element 1838. Accordingly, in this example, the APP 124A adds ninety (90) minutes to the value of “6:30 am” in field 1814 resulting in a new value of “8:00 am” in field 1814 such that the timekeeping device triggers its alarm at 8:00 am rather than at 6:30 am. In one embodiment, the two options 1832 and 1836 are mutually exclusive such that enabling one option disables the other option. Once the user 10 is satisfied with their actions to configure their response to a Delay status within the notification message 170, the user 10 selects a “Save” control button 1840 to close the Configure Alarms GUI 1800. In one embodiment, in response to the closing of the Configure Alarms GUI 1800, then APP 124A navigates to the User Dashboard GUI 2000, illustrated in FIG. 15.

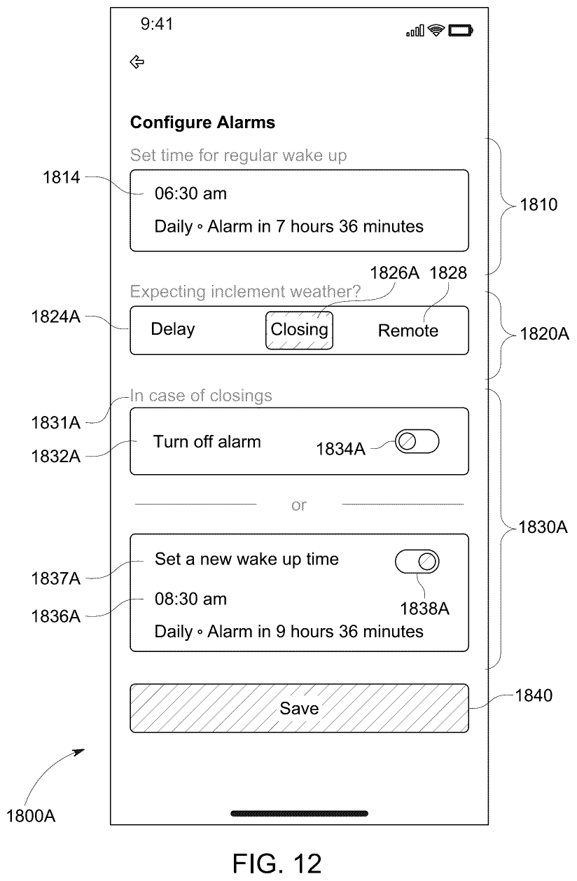

As shown in FIG. 12, a Configure Alarms GUI 1800A is exhibited when the user 10 defines his/her response to receipt of one of the notification messages 170 indicating that the event has been cancelled or closed. It should be appreciated that the Configure Alarms GUI 1800A is similar to the Configure Alarms GUI 1800 (FIG. 11) in that the contents of the first region 1810 are the same, contents of a second region 1820A is substantially the same as the second region 1820 of the Configure Alarms GUI 1800 except that a Delay control tab 1824A is not selected while a Closing control tab 1826A is selected indicating, as noted above, that the user 10 is defining his/her response to an event being closed. A third region 1830A of the Configure Alarms GUI 1800A is different from the third region 1830 of the Configure Alarms GUI 1800. For example, as shown in FIG. 12, the third region 1830A is identified by, for example, a textual label “In case of closing” 1831A and in response to the selection of the Closing control tab 1826A, the user 10 is provided, for example, with two options, shown at 1832A and 1836A, different from the options 1832 and 1836 of the Configure Alarms GUI 1800. In the first option 1832A, the user 10 may activate a toggle control element 1834A to turn off the alarm set in the first region 1810. For example, if the event (e.g., school day) is cancelled and the user 10 has activated the toggle control element 1834A in advance to receiving the notification message 170, then in response to receiving the notification message 170 the School DelayZz APP 124A automatically deactivates or cancels the alarm of the timekeeping device, e.g., one of the IoT devices 110, associated with the School DelayZz system 100. In the second option 1836A identified by a textual label “Set a new wake up time” 1837A, the user 10 may activate toggle control element 1838A to set or specify (e.g., manually input) a new alarm setting defining an alternate time of day for them to wake up as the event (e.g., a school day, a meeting, a conference, a schedule for travel, or the like) has been cancelled and therefore they do not have to attend the event. In one embodiment, the alarm setting is defined in field 1836A as a value of, for example, “08:30 am”. In one embodiment, the user 10 may manually enter the alarm value (e.g., type in the value for the field using an input device such as a keyboard or touch screen display) or, as describe below, may select the field 1836A (e.g., double click the field with an input device such as a mouse, pointer, or his/her finger) to invoke the Edit Alarm GUI 1900 of FIG. 14, described below. Accordingly, when the toggle element 1838A is enabled, the APP 124A adds one hundred twenty (120) minutes to the “regular wake up” value of “6:30 am” in field 1814 resulting in a new value of “8:30 am” in field 1836A such that the timekeeping device triggers its alarm at 8:30 am rather than at 6:30 am. In one embodiment, the two options 1832A and 1836A are mutually exclusive such that enabling one option disables the other option. Once the user 10 is satisfied with their actions to configure their response to a Closing status within the notification message 170, the user 10 selects the “Save” control button 1840 to close the Configure Alarms GUI 1800A. In one embodiment, in response to the closing of the Configure Alarms GUI 1800A, then APP 124A navigates to the User Dashboard GUI 2000, illustrated in FIG. 15.

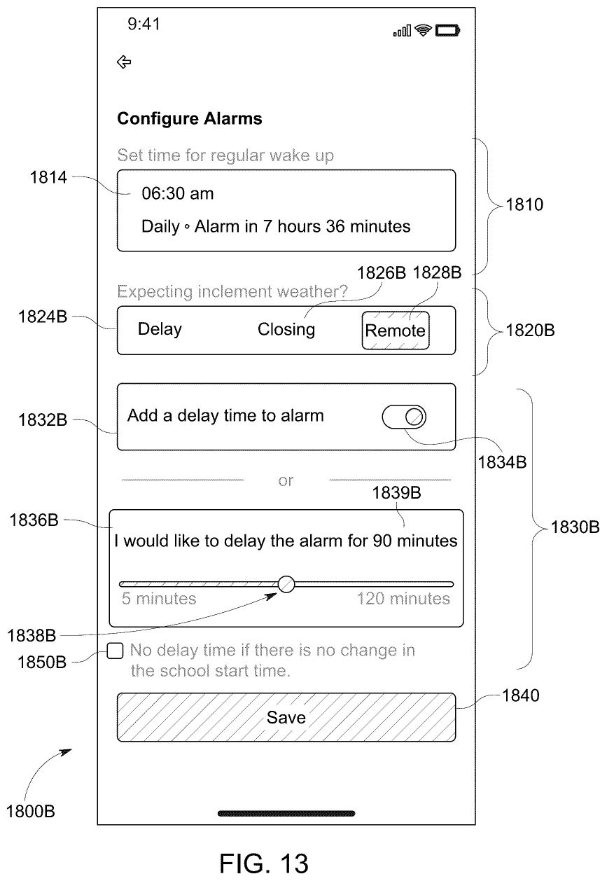

As shown in FIG. 13, a Configure Alarms GUI 1800B is exhibited when the user 10 defines his/her response to receipt of one of the notification messages 170 indicating that the format of the event has been changed to a remote format. It should be appreciated that the Configure Alarms GUI 1800B is similar to the Configure Alarms GUI 1800 (FIG. 11) and the Configure Alarms GUI 1800A (FIG. 12) in that the contents of the first region 1810 are the same, contents of a second region 1820B is substantially the same as the second region 1820 of the Configure Alarms GUI 1800 and the second region 1820A of the Configure Alarms GUI 1800A except that a Delay control tabs 1824B and a Closing control tab 1826B are not selected while a Remote control tab 1828B is selected indicating, as noted above, that the user 10 is defining his/her response to a format of an event being changed to a remote format. A third region 1830B of the Configure Alarms GUI 1800B is different from the region 1830 of the Configure Alarms GUI 1800 and the region 1830A of the Configure Alarms GUI 1800A. For example, as shown in FIG. 13, the third region 1830B, in response to the selection of the Remote control tab 1828B, the user 10 is provided, for example, with two options, shown at 1832B and 1836B, different from the options 1832 and 1836 of the Configure Alarms GUI 1800 (FIG. 11) and options 1832A and 1836A of the Configure Alarms GUI 1800A (FIG. 12).

In a first option 1832B, the user 10 may activate a toggle control element 1834B to add a delay time to their alarm setting (e.g., the value within the field 1814) equal to the time delay for the event as indicated within the notification message 170. For example, if a start of the event (e.g., school day) is delayed third (30) minutes and the user 10 activated the toggle control element 1834B in advance to receiving the notification message 170, then in response to receiving the notification message 170 the School DelayZz APP 124A automatically adds a thirty (30) minute delay to the user 10 alarm setting. In this example, the APP 124A adds thirty (30) minutes to the value of “6:30 am” in field 1814 resulting in a new value of “7:00 am” in field 1814 such that a timekeeping device, e.g., one of the IoT devices 110, associated with the School DelayZz system 100 triggers its alarm at this new 7:00 am time as opposed to the previous 6:30 am time. In a second option 1836B, the user 10 may activate a slider control element 1838B to add a variable delay time from between, for example, a numeric value of five (5) minutes to one hundred twenty (120) minutes, to their alarm setting (e.g., the value within the field 1814). In one embodiment, the Configure Alarms GUI 1800B exhibits a delay period 1839B (e.g., “90 minutes”) set by the user 10 activating the slider control element 1838B. Accordingly, in this example, the APP 124A adds ninety (90) minutes to the value of “6:30 am” in field 1814 resulting in a new value of “8:00 am” in field 1814 such that the timekeeping device triggers its alarm at 8:00 am rather than at 6:30 am. In one embodiment, the user 10 may specify or define, for example, an override to his/her instructions (e.g., selections described above within the two options 1832B and 1836B) to delay the alarm by selecting a checkbox control element 1850B including a textual descriptive label “No Delay time if there is no change in the school start time”. In one embodiment, the two options 1832B and 1836B are mutually exclusive such that enabling one option disables the other option. Once the user 10 is satisfied with their actions to configure their response to a Remote status within the notification message 170, the user 10 selects a “Save” control button 1840 to close the Configure Alarms GUI 1800B. In one embodiment, in response to the closing of the Configure Alarms GUI 1800B, then APP 124A navigates to the User Dashboard GUI 2000, illustrated in FIG. 15.

As described above with reference to the Configure Alarms GUI 1800 of FIG. 11, in one embodiment, the user 10 may edit the value within the alarm field 1814 by, for example, double clicking the field 1814 with an input device such as a mouse, to invoke the Edit Alarm GUI 1900 of FIG. 14. As shown in FIG. 14, in one embodiment the Edit Alarm GUI 1900 includes two regions 1910 and 1920 for editing settings or characteristics of the alarm. In the first region 1910, the user 10 edits the value for the time, e.g., as a clock value including a 12-hour clock interval 1912 representing the twenty-four (24) hours of a day with the numbers one (1) to twelve (12) and an “AM” or a “PM” label 1916, identifying a 12-hour period from midnight to just prior to noon (AM) and a 12-hour period from noon to just before midnight (PM), as is known in the art. As shown in FIG. 14, accompanying the hourly clock periods (e.g., values “1” to “12”) within the 12-hour clock interval 1912 is a 60-minute clock interval 1914 (e.g., “00” to “59”) identifying each 60-minute period within an hour, as is also known in the art. In one embodiment, as shown in FIG. 14, each of the 12-hour clock interval 1912, the 60-minute clock interval 1914, and the AM/PM labels 1916 are exhibited in a scrolling wheel format. It should be appreciated that while the 12-hour clock interval 1912 is depicted in FIG. 14, in another embodiment, the Edit Alarm GUI 1900 may include a 24-hour clock interval identifying individually, each of the hours within a day. In such an embodiment, the AM/PM labels 1916 may be eliminated.

In the second region 1920 of the Edit Alarm GUI 1900, the user 10 may define the recurrence of the alarm utilizing a field 1930 labeled “Repeat”, a title or other identifier for the alarm setting utilizing a field 1940 labeled “Label”, and a sound broadcast as the alarm is triggered utilizing a field 1950 labeled “Sound”. In one embodiment, the Repeat field 1930 includes a drop-down list element 1932, which when selected by the user 10 exhibits, for example, multiple options for recurrence of the alarm including “Every Sunday,” “Every Monday,” “Every Tuesday,” etc., as options for each day of the week, a “Daily” option, or a “Week Day” option (e.g., for days Monday through Friday), and a blank or null value indicating that no recurrence should be implemented. Once a selection is made, the selected value is exhibited in a field 1934 associated with the Repeat field 1930. In one embodiment, the Label field 1940 includes a control element 1942, which when selected by the user 10 exhibits, for example, a text box where the user may enter a custom identification for the alarm. In one embodiment, a default value for the Label field 1940 is “Alarm.” Once a selection is made, the selected value is exhibited in a field 1944 associated with the Label field 1940. In one embodiment, the Sound field 1950 includes a drop-down list element 1952, which when selected by the user 10 exhibits, for example, a list of the sounds available on the user 10's user device 120. In one embodiment, a default value for the Sound field 1950 is a “Radar” sound. Once a selection is made, the selected value is exhibited in a field 1954 associated with the Sound field 1950. Once the user 10 is satisfied with their actions to edit the alarm setting in response to the notification message 170, the user 10 selects a “Save” control button 1960 to store their modifications, e.g., within memory 124 of the user device 120, and to close the Edit Alarm GUI 1900. Alternatively, the user 10 may select a “Cancel” control button 1970 to discard their modifications and to close the Edit Alarm GUI 1900.

When the user 10 closes the Edit Alarm GUI 1900, the School DelayZz APP 124A either navigates back to the previous GUI from which the Edit Alarm GUI 1900 was invoked, e.g., the Configure Alarms GUI 1800 of FIG. 11, or to a User Dashboard GUI 2000 of FIG. 15. In one embodiment, as the User Dashboard GUI 2000 is invoked, the School DelayZz APP 124A requests the user's information from local memory 124 or from the data storage device 160. For example, the APP 124A queries the server 150 to retrieve information from the list of authorized users 162 including the one or more event facilities 163 (e.g., schools, school districts, or other facilities) that the user 10 (e.g., based on username 161) is associated with. In response, the server 150 provides the one or more event facilities 163 associated with the username 161 and the status 167 of events being held at the facilities 163. As shown in FIG. 15, the User Dashboard GUI 2000 includes a region, shown generally at 2010, that exhibits the one or more event facilities 163 associated with the user 10. For example, the APP 124A exhibits an event facility “ELM Street Middle School” at 2012 of the User Dashboard GUI 2000. In one embodiment, the location of the event facility, e.g., City and State, are also exhibited the User Dashboard GUI 2000. In one embodiment, below each of the event facilities, the APP 124A provides the status 167 in a message field 2014 to the user 10. For example, when events at the event facility are operating as planned, the APP 124A exhibits a “No delays or closing reported. Early dismissal today.” message within the message field 2014 as shown in FIG. 15. When events at the facility are delayed, the APP 124A exhibits a message reporting the delay and corresponding time period of delay by, e.g., exhibiting a “Reported Delay—30 Minutes” message within the message field 2014. When events at the facility are cancelled or closed, the APP 124A exhibits a message reporting the closure by, e.g., exhibiting a “Closing Reported” message within the message field 2014. When events at the facility have changed format from in-person to remote, the APP 124A exhibits a message reporting the change in format as well as whether no delay or a delay and corresponding time period of delay has been implemented by, e.g., exhibiting a “No delays or closing reported. School is operating remotely” message within the message field 2014. It should be appreciated that the above-described messages are merely exemplary and the present disclosure is not limited by these messages or formats of presentation to the user 10. For example, as described herein, the system 100 may be employed by event facility administrators 10 and/or system administrators 14 to broadcast an important message (e.g., an emergency condition at or near the event facility 163) to users 10 of the system 100. In one embodiment, below each of the event facilities, the APP 124A also provides a next scheduled alarm setting of the user 10 associated with the listed event facility 163. For example, in an alarm message field 2016, under a textual field 2018 labeled “Upcoming Alarm”, the APP 124A provides the next scheduled alarm setting to the user 10. As shown in FIG. 15, the alarm message field 2016 exhibits a daily alarm setting of “06:30 am” as the next scheduled alarm. In one embodiment, the User Dashboard GUI 2000 includes a toggle control element 2020 where, if selected by the user 10, the next scheduled alarm may be selectively enabled or disabled. Additionally, the user 10 may edit the next scheduled alarm setting by, for example, selecting the alarm message field 2016 (e.g., double click the field with an input device such as a mouse, pointing stylus, or his/her finger on a touch sensitive screen) or selecting an “Edit Alarms” textual navigation element 2022 to invoke an Edit Alarm GUI 1900 of FIG. 14.

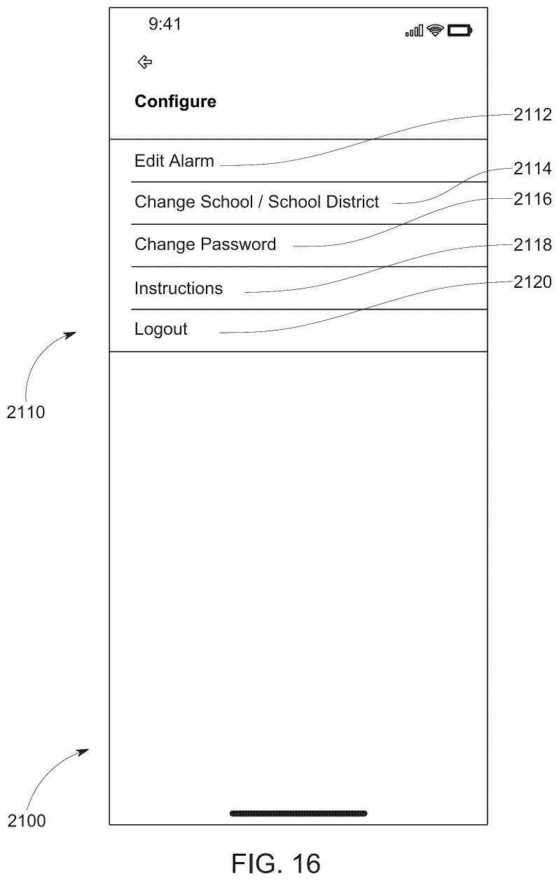

In one embodiment, the User Dashboard GUI 2000 (FIG. 15) also includes a Cog icon 2024. When the user 10 selects the Cog icon 2024, the School DelayZz APP 124A closes the User Dashboard GUI 2000 and navigates to a Configure GUI 2100 of FIG. 16. As shown in FIG. 16, the Configure GUI 2100 includes two or more textual navigation elements exhibited in a region shown generally at 2110. In one embodiment, the navigation elements include an “Edit Alarm” element 2112, a “Change School/School District” element 2114, a “Change Password” element 2116, an “Instructions” element 2118, and a “Logout” element 2120. In one embodiment, when the user 10 selects the Edit Alarm element 2112 (e.g., double clicks the element with an input device such as a mouse) the APP 124A closes the Configure GUI 2100 and invokes the Edit Alarm GUI 1900 of FIG. 14. In one embodiment, when the user 10 selects the Change School/School District element 2114, the APP 124A closes the Configure GUI 2100 and invokes the Select State GUI 1300 of FIG. 6. In one embodiment, when the user 10 selects the Change Password element 2116, the APP 124A opens a Dialog Box (not shown) on the Configure GUI 2100 in which the user 10 may enter his/her current password as well as a new password, as is known in the art. Once the user 10 enters a new password in an approved format (e.g., see password requirements included in the Sign Up GUI 1200 of FIG. 5), the APP 124A updates the profile for the user 10 to include the new password and closes the Dialog Box. In one embodiment, when the user 10 selects the Instructions element 2118, the APP 124A closes the Configure GUI 2100 and invokes the Configure Alarm Introduction GUI 1700 of FIG. 10. As noted above, the APP 124A provides a number of GUIs 1000 that include GUIs that invoke the features and functions of the system 100 (as described herein) but in an introduction mode, where the GUIs are overlayed with instructional text demonstrating how to use functionality of the system 100 such as, for example, editing default alarm settings 1710 and/or configuring an alarm 1720 based on a change of status of an event at an event facility such as a Delay, Closing, or change of format to Remote participation. In one embodiment, when the user 10 selects the Logout element 2120, the APP 124A closes the Configure GUI 2100 and invokes the Login GUI 1100 of FIG. 3.

It should be appreciated that the above-described GUIs, for example, the Login GUI 1100 of FIG. 3 to the Configure GUI 2100 of FIG. 16, represent GUIs presented by the APP 124A to the user 10 operating one of the client/user devices 120 including mobile communication and/or computing devices such as, for example, a personal digital assistant (PDA), iPAD™ device, mobile radio telephone, or smartphone (e.g., Apple™ iPhone™ device, Google™ Android™ device, etc.). In another aspect of the present disclosure, the user 10 may operate a personal computer or workstation, or tablet computer processing device that accesses the School DelayZz event notification and messaging system 100 via a website uniform resource locator (URL) available on the network 180. While GUIs 1000 presented via the website may be formatted differently from the GUIs discussed above (e.g., the Login GUI 1100 of FIG. 3 to the Configure GUI 2100 of FIG. 16), the features and functionality accessed therein are substantially similar. Accordingly, for brevity, not all GUIs provided to the users 10 accessing the system 100 via the website URL are described.

### Administrator—Application Overview

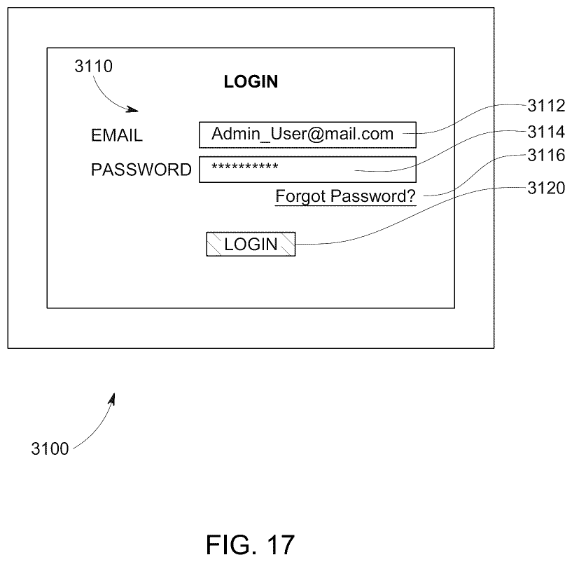

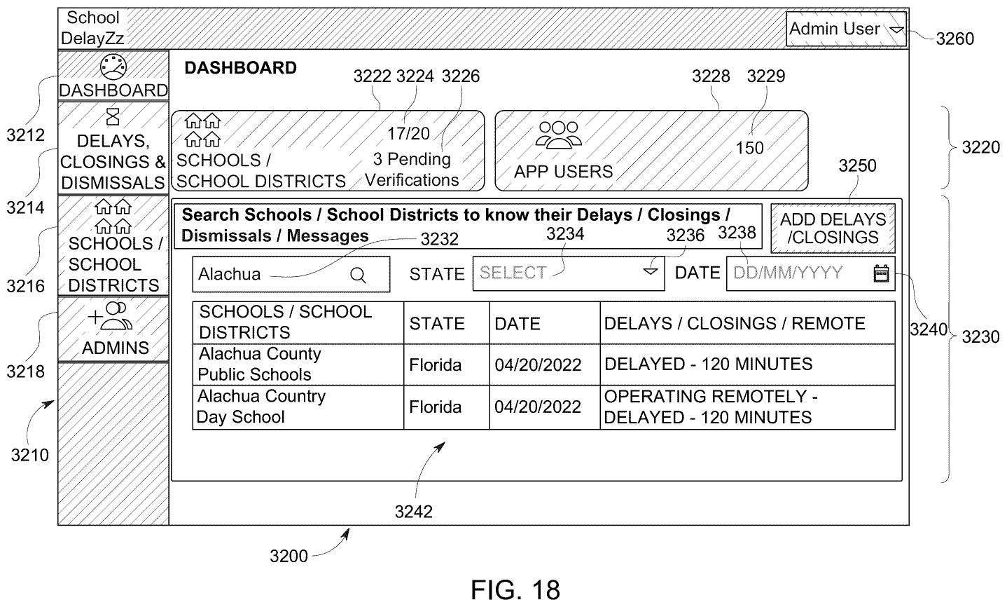

It should also be appreciated that, as described herein, the users 10 (e.g., operators of the client/user devices 120) of the system 100 may include one or more attendees or participants of the event being conducted at one of the event facilities but also others including, for example, persons picking up or dropping off the attendees of the event, as well as administrators of one or more of the event facility 165. Additionally, in one embodiment, one or more of the administrators 14 (e.g., operators of the server 150) of the School DelayZz event notification and messaging system 100 may access the GUIs 3000 to execute features and functionality of the system 100, as described herein. As shown in FIG. 17, one of the administrators 14 navigates to the URL for the School DelayZz event notification and messaging system 100 and is presented by the School DelayZz APP 154A with a Login GUI 3100 where the administrator 14 enters his/her login credentials. For example, as illustrated in FIG. 17 the administrator 14 enters their login credentials in a region shown generally at 3110. In one embodiment, the login credentials 3110 include a unique username entered into a Username field 3112 labeled “Email” and a password entered into a Password field 3114 labeled “Password.” If the administrator 14 has forgotten his/her password, a “Forgot Password” textual navigation control element 3116 may be selected to initiate a password reset process, as is known in the art, using, for example, a registered electronic mail address previously provided to the system 100. Once the administrator 14 has entered their login credentials 3110, the administrator 14 selects a “Login” control button 3120 to submit the login credentials to the APP 154A. The APP 154A then validates the administrator's login credentials to ensure that the administrator is authorized to access the School DelayZz system 100. Once validated, the APP 154A exhibits a Dashboard GUI 3200 of FIG. 18 to the School DelayZz administrator 14.

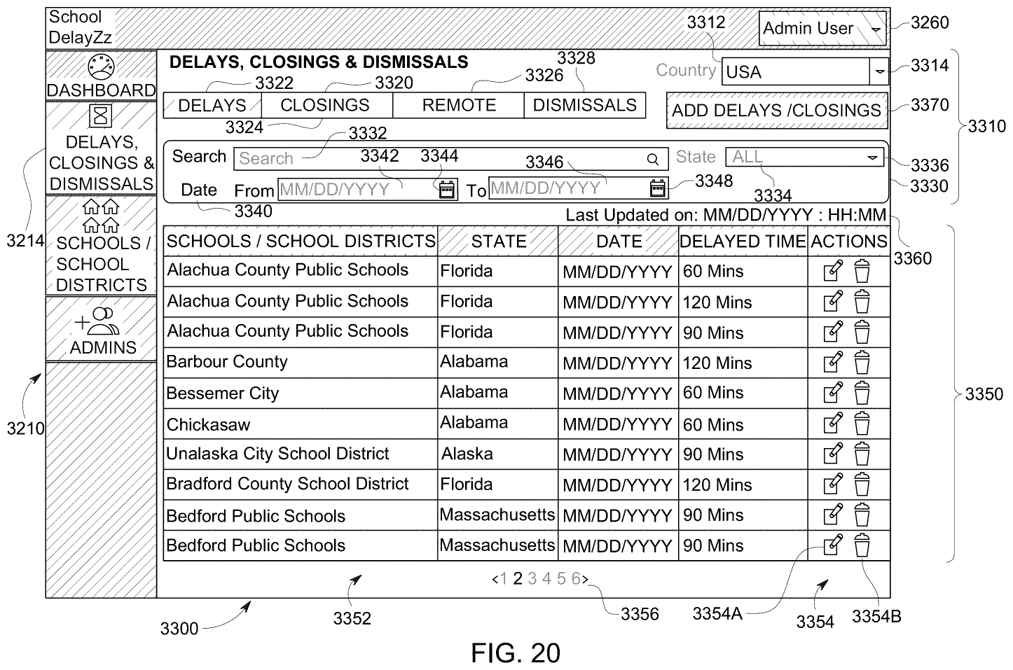

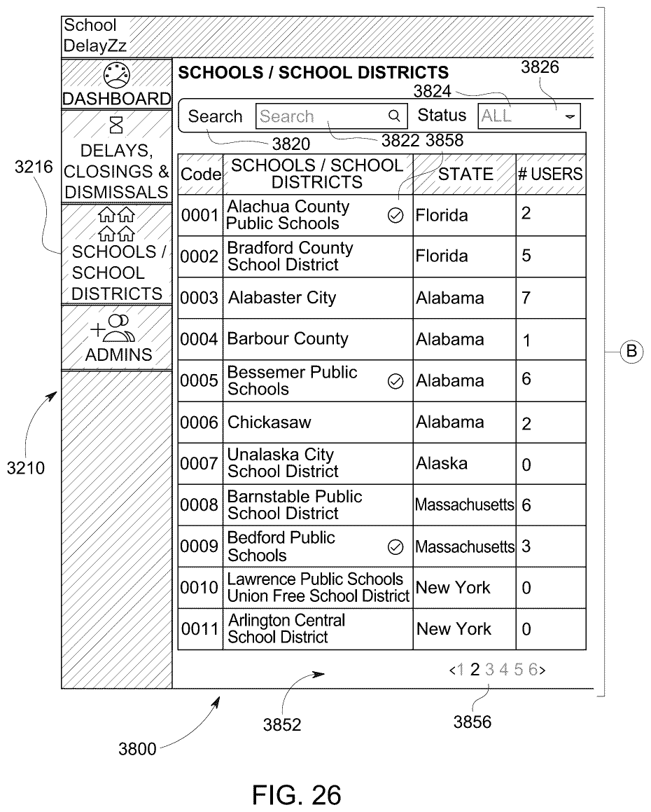

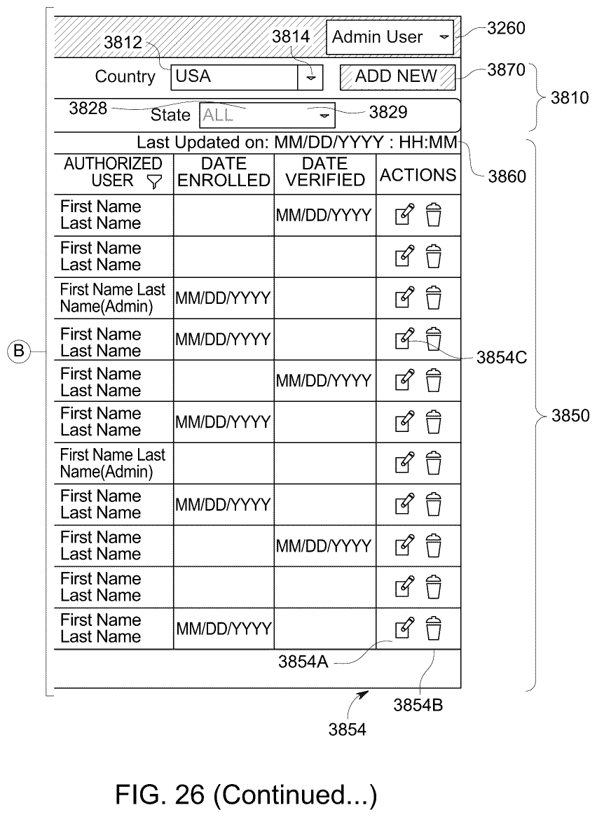

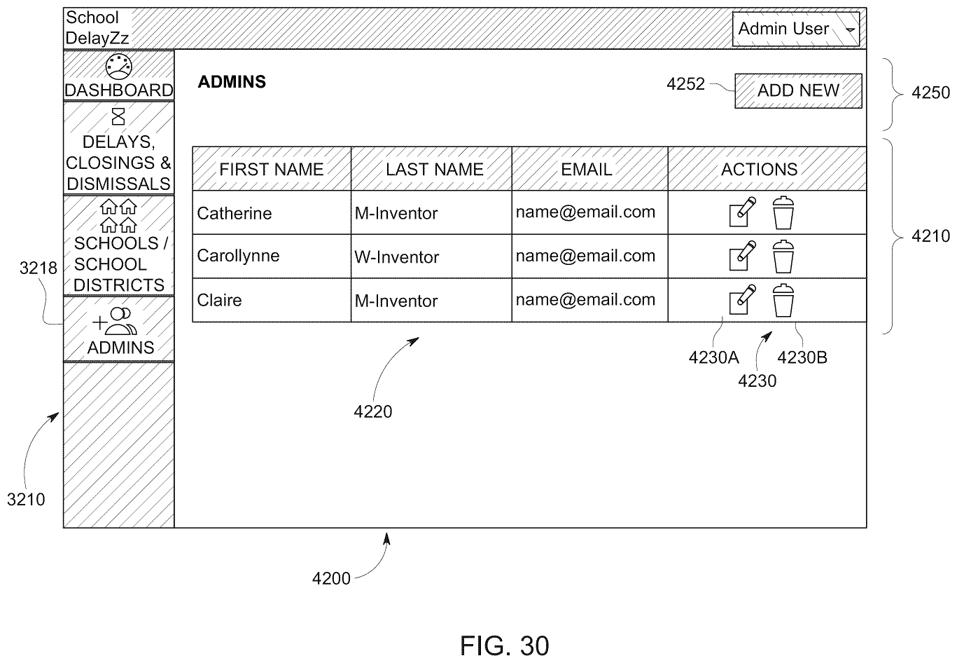

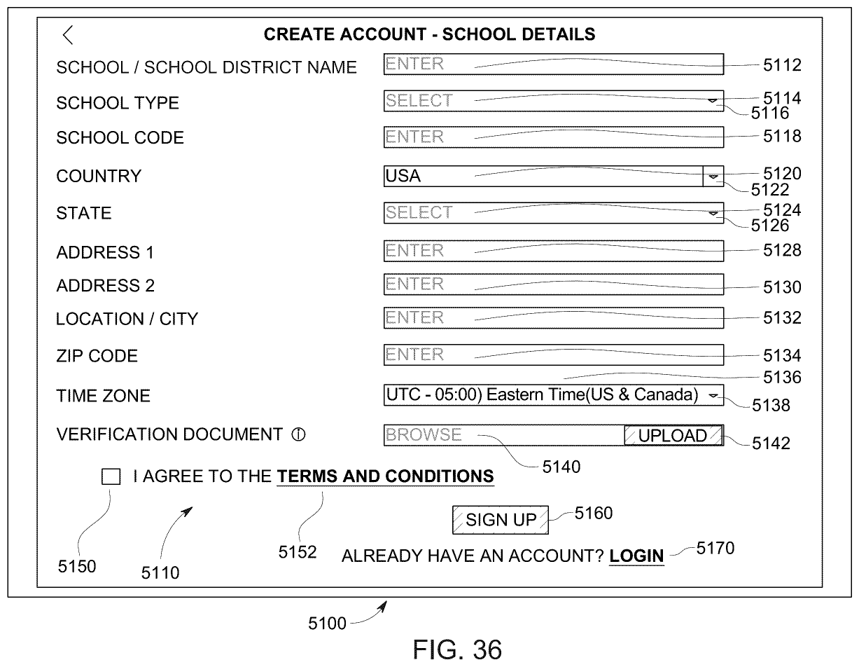

In one embodiment, each of the GUIs 3000 exhibited by the School DelayZz APP 154A to the one or more School DelayZz administrators 14, for example the Dashboard GUI 3200 of FIG. 18, may include a Main Menu navigation bar 3210, which may be selected to navigate through the GUIs 3000. For example, a “DASHBOARD” option 3212 may be selected (e.g., the administrator 14 double clicks the element with an input device such as a mouse) on the Main Menu navigation bar 3210 to navigate to the Dashboard GUI 3200 of FIG. 18, a “DELAYS, CLOSING & DISMISSALS” option 3214 may be selected to navigate to a Delays, Closings & Dismissals GUI 3300 of FIG. 20, a “SCHOOLS/SCHOOL DISTRICTS” option 3216 may be selected to navigate to a Schools/School Districts GUI 3800 of FIG. 26, and an “ADMINS” option 3218 may be selected to navigate to an Admins GUI 4200 of FIG. 30. In one embodiment, the Dashboard GUI 3200 includes one or more regions for exhibiting information and/or initiating functionality of the system 100, for example, a first region shown generally at 3220 and a second region shown generally at 3230. In one embodiment, the first region 3220 includes various statistics for the School DelayZz system 100. For example, in a Schools/School Districts display element 3222, a total number of event facilities (e.g., schools, school districts, user groups, etc.) that have been added to the system 100 is shown. In one embodiment, the total number of facilities is exhibited as including a number of active and/or enrolled facilities (e.g., seventeen (17)) within the total number twenty (20)) as shown at 3224 and a number pending and/or still awaiting verification (e.g., three (3)) as shown at 3226. As described herein, event facilities (e.g., schools, school districts, user groups, etc.) are either added by the School DelayZz administrator 14 through the a Schools/School Districts GUI 3800 of FIG. 26 or by an event facility administrator when an account is created within the system 100 on a Create Account—School Details GUI 5100 of FIG. 36. In one embodiment, the new facility (e.g., schools, school districts, user groups, etc.) added by the School DelayZz administrator 14 is enrolled/verified automatically on creation. In one embodiment, the new facility (e.g., schools, school districts, user groups, etc.) added by the event facility administrator, as described below, needs to be verified by the School DelayZz administrator 14 prior to active enrollment in the system 100.

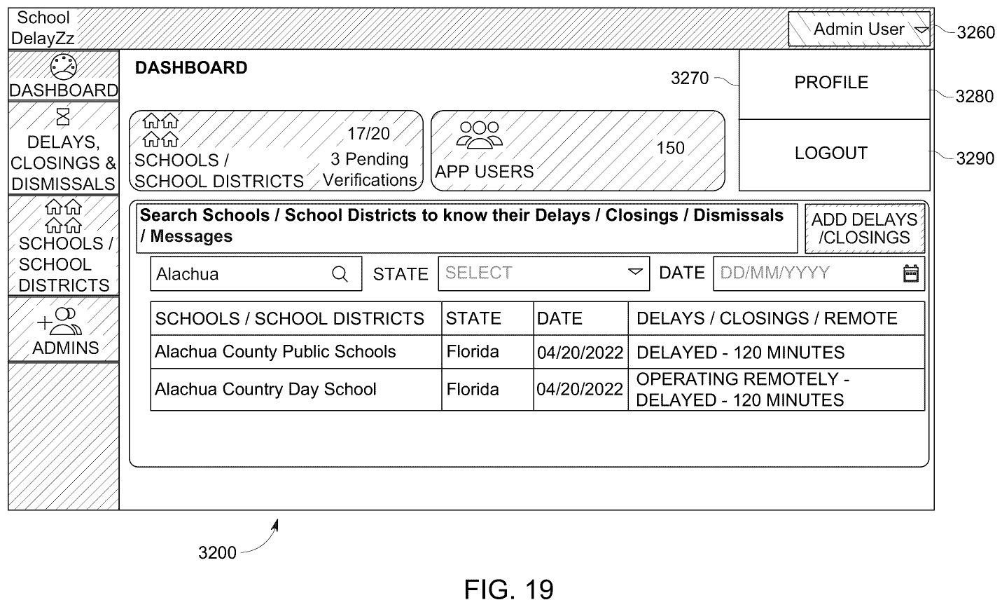

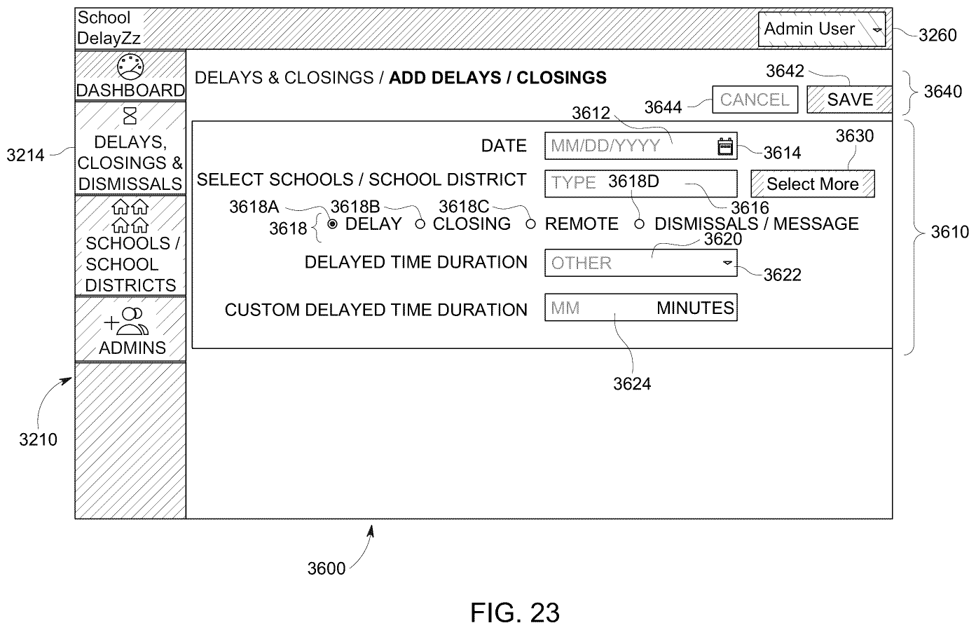

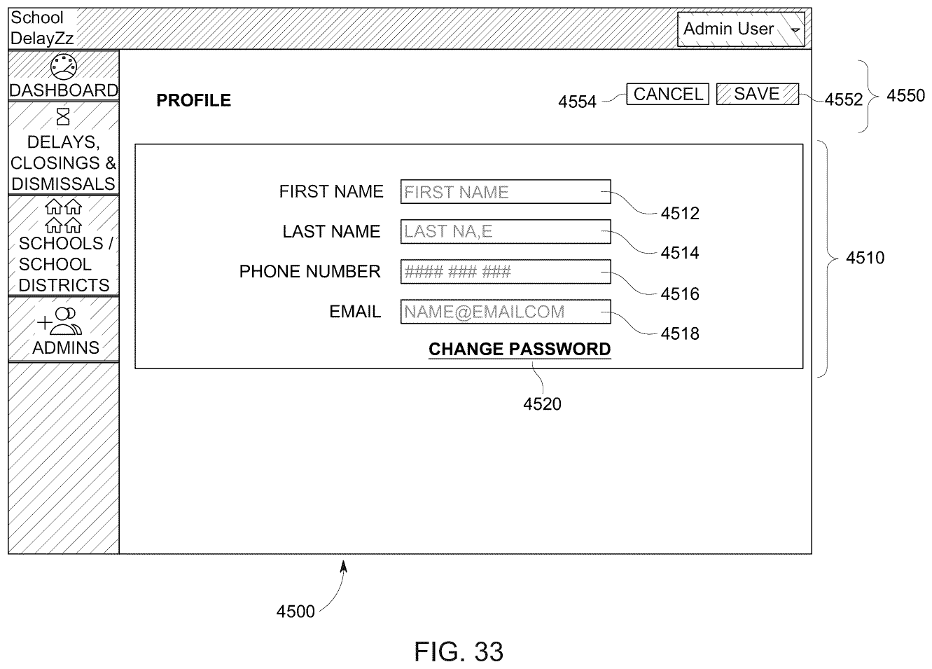

Referring again to FIG. 18, the first region 3220 of the Dashboard GUI 3200 also includes an App Users display element 3228, which provides a total number of registered users 10 (e.g., one hundred and fifty (150)) of the School DelayZz system 100 at 3229. In one embodiment, within the second region 3230 one of the School DelayZz administrators 14 may initiate a search for one of the event facilities within system 100 (e.g., schools, school districts, user groups, or the like) to determine a status of events being held at the facility. For example, to initiate the search, the administrator 14 manually inputs an event facility name in a first search field 3232 (e.g., a “keyword” field wherein a value “Alachua” is exhibited). The administrator 14 may initiate the search and/or optionally narrow or filter the search, by manually inputting or selecting a State in a second search field 3234 labeled “STATE”. As shown in FIG. 18, in one embodiment, the second search field 3234 includes a drop-down list element 3236 that, if activated, exhibits a list of States within, for example, the United States, one or all of which that may be selected by the administrator 14. In one embodiment, the administrator 14 may further initiate the search and/or optionally narrow or filter the search by manually inputting or selecting a date in a third search field 3238 labeled “DATE”. In one embodiment, the administrator 14 may manually input the date, e.g., in a day, month, and year (DD/MM/YYYY) format or may select a Calendar control element 3240 that, if activated, exhibits a current year calendar (e.g., beginning with a current day), from which a day of the year may be selected by the administrator 14. Once the administrator 14 has completed his/her desired search criteria (e.g., entered values within one or more of the search fields 3232, 3234, and 3238), the APP 154A performs a search of event facilities within the system 100. In one embodiment, the APP 154A performs the requested search and returns results matching the inputted criteria in a search results table, shown generally at 3242. In one embodiment, illustrated in FIG. 18, the search results table 3242 includes the names of event facilities (e.g., schools, school districts, user groups, etc.), state, date of a status presented (e.g., a delay, closing, or change in format to remote), and details of the status exhibited. In one embodiment, the Dashboard GUI 3200 further includes an “ADD DELAYS/CLOSING” control button 3250 that, if selected, the APP 154A closes the Dashboard GUI 3200 and invokes an Add Delays/Closings GUI 3600 of FIG. 23, where the administrator 14 may add a new occurrence of a delay or a closing of an event facility, as described below. In one embodiment, the Dashboard GUI 3200 also further includes an “Admin User” dropdown menu control 3260 that, if selected, as shown in FIG. 19, the APP 154A invokes a navigation menu 3270 and exhibits the menu over the Dashboard GUI 3200. As shown in FIG. 19, the navigation menu 3270 includes options of a PROFILE control element 3280 and a LOGOUT control element 3290. It should be appreciated that, in one embodiment, the navigation menu 3260, like the Main Menu navigation bar 3210 discussed above, is exhibited on each of the GUIs 3000 exhibited by the School DelayZz APP 154A to the one or more School DelayZz administrators 14. If the administrator 14 selects the PROFILE control element 3280 then, in response, the APP 154A closes of the Dashboard GUI 3200 and navigates to a Profile GUI 4500, illustrated in FIG. 33. If the administrator 14 selects the LOGOUT control element 3290 then, in response, the APP 154A closes of the Dashboard GUI 3200, terminates the administrator's current access to the School DelayZz system 100, and navigates to the Login GUI 3100, illustrated in FIG. 17.

Referring again to the Main Menu navigation bar 3210, if the administrator 14 selects the “DELAYS, CLOSING & DISMISSALS” option 3214, the APP 154A navigates to the Delays, Closings & Dismissals GUI 3300 of FIG. 20, where the administrator 14 may view, add, change, or delete one of the statuses exhibited (e.g., a delay, closing, dismissal, or change in format to remote) for one of the event facilities (e.g., schools, school districts, user groups, etc.) within the School DelayZz system 100. In one embodiment, Delays, Closings & Dismissals GUI 3300 includes one or more regions for exhibiting information and/or initiating functionality of the system 100, for example, a first region shown generally at 3310 and a second region shown generally at 3350. In one embodiment, the first region 3310 provides functionality for narrowing or filtering the information exhibited in the second region 3350. For example, the first region 3310 includes a Country control element 3312 labeled “Country” and that includes a drop-down list control element 3314 which exhibits a list of available countries for selection. With the Country control element 3312 the administrator 14 may select a country within the list of one or more countries having event facilities participating in the system 100. When activated, the APP 154A filters the status information exhibited on the Delays, Closings & Dismissals GUI 3300 to include information only for event facilities within the selected country. In one embodiment, as illustrated in FIG. 20, a default value of the drop-down list control element 3314 is the United States of America (e.g., USA). In one embodiment, the first region 3310 of the Delays, Closings & Dismissals GUI 3300 also includes a Display Status control element 3320 that includes tabs for each of the values of statuses for the event facilities including, for example, a DELAYS tab control element 3322, a CLOSINGS tab control element 3324, a REMOTE tab control element 3326, and a DISMISSAL tab control element 3328. As described herein, when the administrator 14 selects or activates one of the tab control elements 3322, 3324, 3326, and 3328, the APP 154A filters the status information exhibited on the Delays, Closings & Dismissals GUI 3300 to include information only for event facilities having the selected status. For example, as illustrated in FIG. 20, the DELAYS tab control element 3322 is activated by the administrator 14 and, in response, the APP 154A exhibits within a Delay Status table 3352 of the second region 3350 event facilities (e.g., schools, school districts, user groups, and the like) having events that have a delayed status, as described below. In one embodiment, the first region 3310 further includes control elements within a search block 3330 to even further narrow or filter the status information exhibited on the Delays, Closings & Dismissals GUI 3300. For example, as illustrated in FIG. 20, the administrator 14 may manually input an event facility name in a first search field 3332 labeled “Search.” When a value is entered into the first search field 3332, the APP 154A narrows or filters the status information exhibited in the Delay status table 3352 for the named event facility. The administrator 14 may also optionally narrow or filter the status information, by manually inputting or selecting a State in a second search field 3334 labeled “State.” As shown in FIG. 20, in one embodiment, the second search field 3334 includes a drop-down list element 3336 that, if activated, exhibits a list of States within the selected Country (e.g., the United States as the value of the Country field 3312 is “USA”), one or all of which that may be selected by the administrator 14. In one embodiment, the administrator 14 may further optionally narrow or filter the status information displayed in the Delays, Closings & Dismissals GUI 3300 by manually inputting or selecting a date range in a third search field 3340 labeled “Date,” which includes a beginning date field 3342 labeled “From” and an end date field 3346 labeled “To”. In one embodiment, the administrator 14 may manually input the date values for the beginning date field 3342 and the end date field 3346, e.g., in a day, month, and year (DD/MM/YYYY) format or may select Calendar control elements 3344 and 3348, respectively that, if activated, exhibits a current year calendar (e.g., beginning with a current day), from which a day of the year may be selected by the administrator 14. Once the administrator 14 has completed his/her desired criteria for exhibiting the status information (e.g., entered values within one or more of the Display Status control element 3320 and/or search fields 3330), the APP 154A exhibits the status information for event facilities within the system 100 matching the criteria within the Delay status table 3352.

As noted above, the APP 154A performs the requested search and exhibits the status information in the status table, shown generally at 3352, within the second region 3350. In one embodiment, illustrated in FIG. 20, the status table 3352 includes the names of event facilities (e.g., schools, school districts, user groups, etc.), state, date of a status presented (e.g., a delay), and details of the delay status (e.g., time period). In one embodiment, the status table 3352 further includes an Actions column, shown generally at 3354, that provides one or more icons for each listed facility for initiating functionality to be performed on one of the listed facilities. For example, in one embodiment illustrated in FIG. 20, the one or more icons include an edit icon 3354A (e.g., a pencil and paper image) and a delete icon 3354B (e.g., a garbage can image). In one embodiment, if the administrator 14 selects the edit icon 3354A for one of the listed event facilities, the APP 154A closes the Delays, Closings & Dismissals GUI 3300 and invokes an Edit Delays/Closings GUI 3700 of FIG. 25, where the administrator 14 may view and edit details of the delay for the event facility, as described below. In one embodiment, if the administrator 14 selects the delete icon 3354B for one of the listed event facilities, the APP 154A deletes the listed delay for the event facility. In one embodiment, prior to completing the delete operation, the APP 154A exhibits a confirmation pop up box (not shown) and requests that the administrator 14 confirms his/her instruction to delete the selected delay entry. In one embodiment, illustrated in FIG. 20, if the status table 3352 includes more entries for event facilities and delay statuses than can be exhibited on one page of the Delays, Closings & Dismissals GUI 3300, the APP 154A provides a page navigation element 3356 that allows the administrator 14 to move between two or more pages of the status table 3352 exhibited on the Delays, Closings & Dismissals GUI 3300. In one embodiment, the Delays, Closings & Dismissals GUI 3300 includes a Date and Time element 3360 (e.g., included in the first region 3310) that provides the date and time that one of the administrators 14 last updated the status for the event facilities exhibited within the status table 3352. In one embodiment, illustrated in FIG. 20, the Delays, Closings & Dismissals GUI 3300 also includes a ADD DELAYS/CLOSINGS control button 3370 (e.g., included in the first region 3310) that, if selected, the APP 154A closes the Delays, Closings & Dismissals GUI 3300 and invokes an Add Delays/Closings GUI 3600 of FIG. 23, where the administrator 14 may add a new occurrence of a delay or a closing of an event facility, as described below.

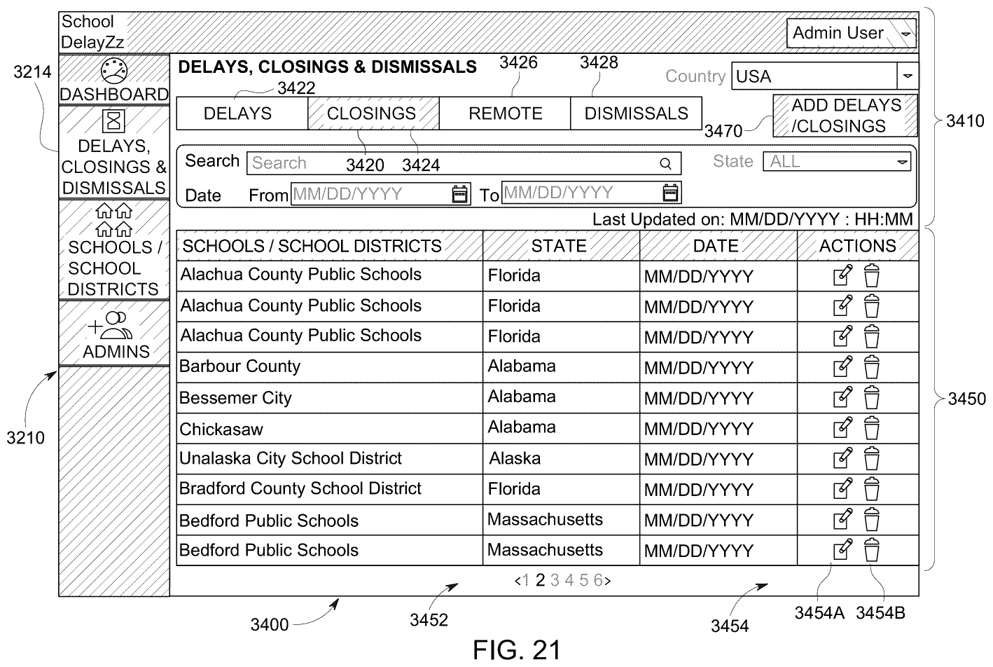

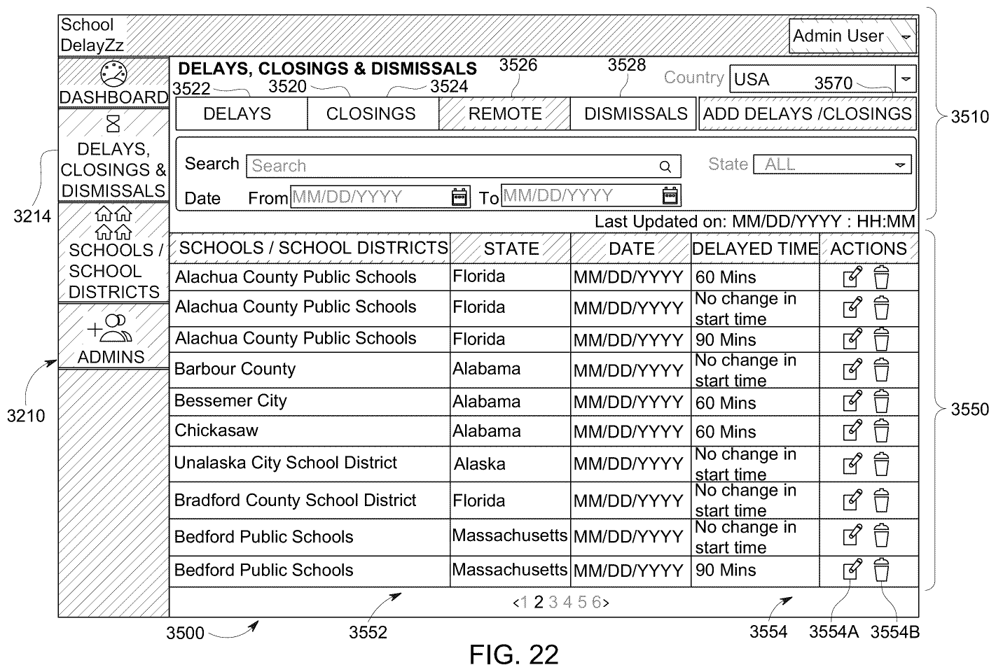

It should be appreciated that the APP 154A exhibits closing, change of format status to remote, and dismissal information in a similar manner as the APP 154A does on the Delays, Closings & Dismissals GUI 3300 of FIG. 20 for delay status information, with slight variations to the status table 3352 and columns presented therein. For example, as shown in FIG. 21, a Delays, Closings & Dismissal GUI 3400 is depicted where the administrator 14 may view, add, change, or delete closing status information for one or more of the event facilities (e.g., schools, school districts, user groups, etc.) within the School DelayZz system 100. As shown in FIG. 21, the Delays, Closings & Dismissal GUI 3400 includes a first region shown generally at 3410 and a second region shown generally at 3450, each substantially similar to the first region 3310 and the second region 3350 of the Delays, Closings & Dismissals GUI 3300. In the first region 3410 of FIG. 21, however, the Display Status control element 3420 differs from the Display Status control element 3320 (FIG. 20) as a DELAYS tab control element 3422 is not selected and a CLOSINGS tab control element 3424 is selected. A REMOTE tab control element 3426 and a DISMISSAL tab control element 3428 remain unselected. As shown in FIG. 21, the second region 3450 of the Delays, Closings & Dismissal GUI 3400 differs from the second region 3350 (FIG. 20) as a status table 3452 includes the names of event facilities (e.g., schools, school districts, user groups, etc.), state, date of a status presented (e.g., a closing), and an Actions column. There is no column exhibiting details of the closing status (e.g., time period) as there was for the status table 3352. Similarly, as shown in FIG. 22, a Delays, Closings & Dismissals GUI 3500 is depicted where the administrator 14 may view, add, change, or delete remote status information for one or more of the event facilities (e.g., schools, school districts, user groups, etc.) within the School DelayZz system 100. As shown in FIG. 22, the Delays, Closings & Dismissal GUI 3500 includes a first region shown generally at 3510 and a second region shown generally at 3550, each substantially similar to the first regions 3310, 3410 and the second regions 3350, 3450 of the Delays, Closings & Dismissals GUI 3300 and 3400. In the first region 3510 of FIG. 22, however, the Display Status control element 3520 differs from the Display Status control element 3320 (FIG. 20) and Display Status control element 3420 (FIG. 21) as a DELAYS tab control element 3522, a CLOSINGS tab control element 3524, and a DISMISSALS tab control element 3528 are not selected and a REMOTE tab control element 3526 is selected. As shown in FIG. 22, the second region 3550 of the Delays, Closings & Dismissals GUI 3500 differs from the second regions 3350 (FIG. 20) and 3450 (FIG. 21) as a status table 3552 includes the names of event facilities (e.g., schools and/or school districts), state, date of a status presented (e.g., a remote format), a delay time or notice of no delay time in a DELAYED TIME column, and an ACTIONS column. While not depicted, it should be appreciated that it is within the scope of the present disclosure for the APP 154A to exhibit a Delays, Closings & Dismissals GUI (not shown) for dismissal status information, with slight variations to the status table 3552 and columns presented therein. For example, in one embodiment, a dismissal status table includes columns presenting the names of event facilities (e.g., schools and/or school districts), state, date of a status presented (e.g., a dismissal status), a time or notice of the dismissal time (e.g., early or late, in relation to the originally scheduled dismissal time), and an ACTIONS column permitting editing or deletion of an exhibited dismissal. In one embodiment, described herein, the dismissal features and functions permit one of the event facility administrators 10 and/or the system administrator 14 to broadcast a message to users 10 associated with one or more event facilities (e.g., schools, school districts, user groups, or the like). For example, an alert or notification message of a situation at or in proximity to the event facility that may impact the originally scheduled daily events at the event facility (e.g., resulting in an early or late dismissal). If any such messaging is enabled for a particular event facility, the message is exhibited in the dismissal status table (not shown).

As shown in FIGS. 20, 21, and 22, each of the Delays, Closings & Dismissals GUIs 3300, 3400, and 3500, respectively, include an ADD DELAYS/CLOSINGS control button 3370, 3470, and 3570 (e.g., included in the first regions 3310, 3410, and 3510) that, if selected, the APP 154A closes the corresponding one of the Delays, Closings & Dismissals GUIs 3300, 3400, and 3500 and invokes an Add Delays/Closings GUI 3600 of FIG. 23. Similarly, and referring again to the Dashboard GUI 3200 (FIG. 18), when the administrator 14 selects the “ADD DELAYS/CLOSING” control button 3250, the APP 154A closes the Dashboard GUI 3200 and invokes the Add Delays/Closings GUI 3600 of FIG. 23. In the Add Delays/Closings GUI 3600 the administrator 14 may add a new occurrence of a status change to an event, for example, a delay, a closing, an early or a late dismissal (e.g., a hold over or shelter in place), or a change of format of the event. In one embodiment, the Add Delays/Closings GUI 3600 includes one or more regions for inputting information and/or initiating functionality of the system 100, for example, a first region shown generally at 3610 and a second region shown generally at 3640. In one embodiment, the first region 3610 provides fields and functionality for defining the new occurrence of a status change including a date field 3612 labeled “DATE”, an event facility field 3616 labeled “SELECT SCHOOLS/SCHOOL DISTRICT”, a series of radio control buttons, shown generally at 3618, for characterizing the type of status change, a first delay time field 3620 labeled “DELAYED TIME DURATION,” and a second delay time field 3624 labeled “CUSTOM DELAYED TIME DURATION.” With reference to the date field 3612, in one embodiment, the administrator 14 may manually input a date value for the change of status to an event, e.g., in a day, month, and year (DD/MM/YYYY) format or may select Calendar control element 3614 that, if activated, exhibits a current year calendar (e.g., beginning with a current day), from which a day of the year may be selected by the administrator 14. In the event facility field 3616, in one embodiment, the administrator 14 may manually input an event facility name value in which the new change of status is scheduled to occur. As described below, if the new change of status is to occur at two or more event facilities, the administrator 14 may invoke functionally to propagate the change of status to other event facilities by activating a Select More control button 3630, as described more fully below. With the date and the event facility for the new change of status to occur selected and input into fields 3612 and 3616, the administrator 14 further defines the character of the type of status change by selecting one of the radio control buttons 3618. In one embodiment, a first one 3618A of the radio control buttons 3618 is labeled “DELAY,” a second one 3618B is labeled “CLOSING,” a third one 3618C is labeled “REMOTE,” and a fourth one 3618D is labeled “DISMISSAL/MESSAGE.” In one embodiment illustrated in FIG. 23, the status change type field 3618 is a binary choice, e.g., only one of the types radio buttons DELAY 3618A, CLOSING 3618B, REMOTE 3618C, or DISMISSAL/MESSAGE 3618D may be selected, such that when one of the types is selected and enabled, the other three options are deactivated and not selectable so that the new occurrence of the change in status only has one type value. In one embodiment, when the type of status change is one of a delay (e.g., the DELAY radio control button 3618A is enabled), a dismissal (e.g., the DISMISSAL/MESSAGE radio control button 3618D is enabled), or a change in format (e.g., the REMOTE radio control button 3618C is enabled), the first delay time field 3620 (e.g., the field labeled DELAYED TIME DURATION) is activated for receiving input data. For example, in one embodiment, the first delay time field 3620 includes a dropdown menu control 3622, which presents two or more preset values for a delay in the scheduled start time for the new occurrence of the change in status for the event. In one embodiment, the drop-down menu control 3622 exhibits values of, for example, “60 mins”, “90 mins”, “120 mins”, or “Other”. It should be appreciated that while these four (4) values are described, the present disclosure is not limited to these values and that other preset values may be implemented using the features and functions of the present disclosure. In one embodiment, when the preset value of “Other” is selected within the dropdown men control 3622, the second delay time field 3624 (e.g. the field labeled CUSTOM DELAYED TIME DURATION) is activated for receiving input data. Once activated, the administrator 14 may utilize the second delay time field 3624 to manually input a customized value (e.g., in minutes) for the delay in the scheduled start time for the new occurrence of the change in status for the event. In one embodiment, when the type of status change is one of a dismissal or message (e.g., the DISMISSAL/MESSAGE radio control button 3618D is enabled), the APP 154A presents a Message Text dialog box (not shown) where the system administrator 14 may enter a custom or predefined message (e.g., from a drop-down menu control element, not shown) to be broadcast to users 10 associated with the event facility (specified in field 3616).

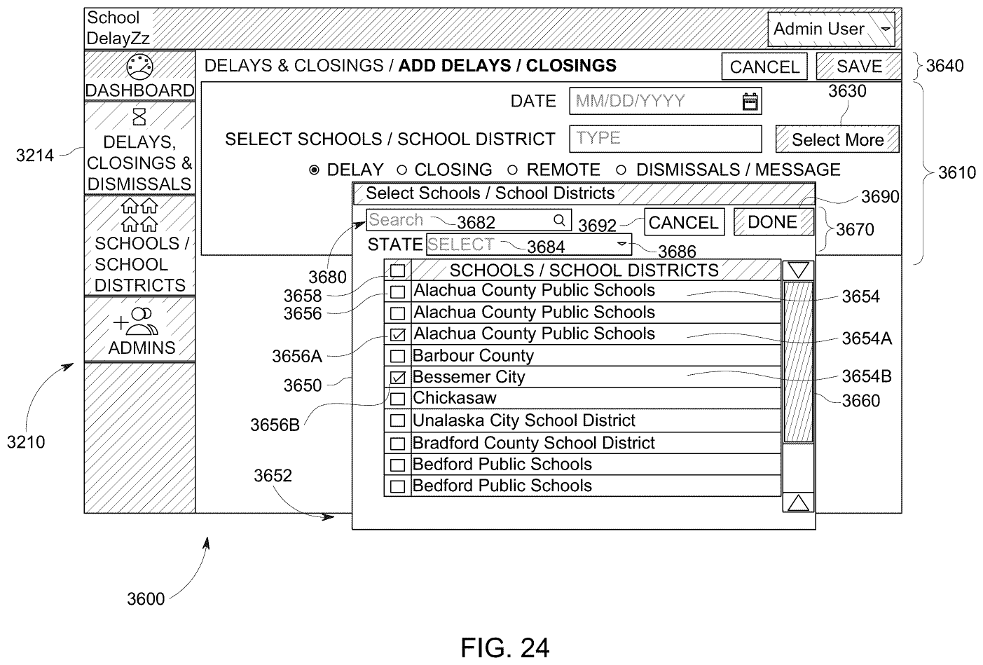

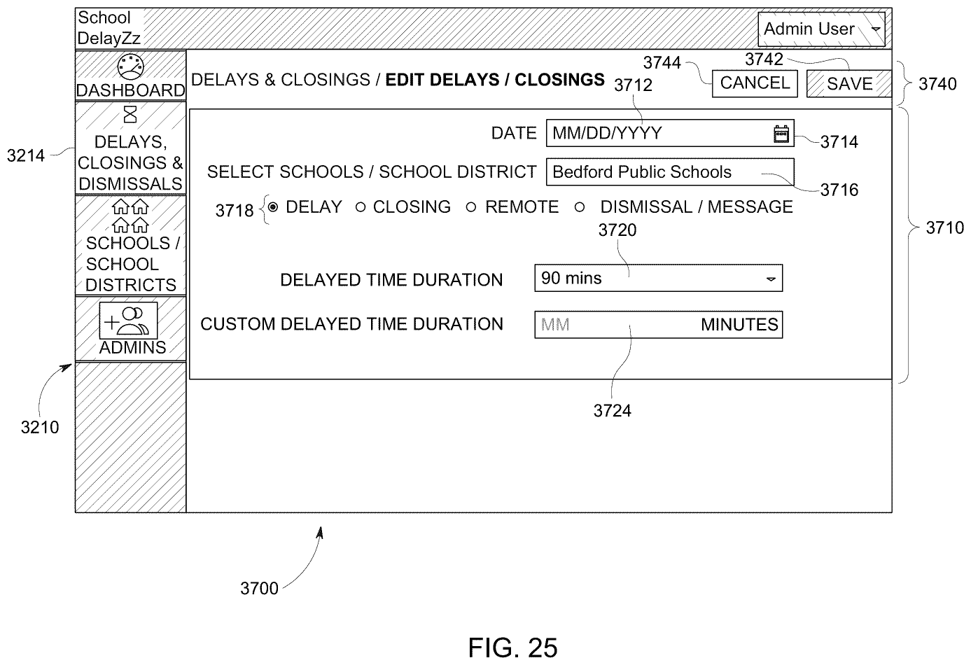

To create the new occurrence of the specified change of status for the specified event facility (e.g., schools, school districts, user groups, or the like), the administrator 14 selects a “Save” control button 3642 in the second region 3640 of the Add Delays/Closings GUI 3600 of FIG. 23. Alternatively, the administrator 14 ends the creation operation by selecting a “Cancel” control button 3644. In one embodiment, selecting the Save control button 3642 or the Cancel control button 3644 closes the Add Delays/Closings GUI 3600 and invokes or reactivates the Delays, Closings & Dismissals GUIs 3300 (FIG. 20), 3400 (FIG. 21), and 3500 (FIG. 22), or the Dashboard GUI 3200 (FIG. 18) that invoked the Add Delays/Closings GUI 3600 of FIG. 23. As noted above, in one embodiment, the administrator 14 may invoke functionally to propagate the same change of status entered on the Add Delays/Closings GUI 3600 for the specified event facility (e.g., schools, school districts, user groups, or the like) to other event facilities by activating a Select More control button 3630 of the first region 3610 to invoke a Select Schools/School Districts dialog box 3650. In one embodiment, as illustrated on FIG. 24, the School DelayZz APP 154A exhibits the Select Schools/School Districts dialog box 3650 over the Add Delays/Closings GUI 3600.

In one embodiment, the Select Schools/School Districts dialog box 3650 provides for propagating the same change of status to one or more other event facilities. For example, in one embodiment, the Select Schools/School Districts dialog box 3650 provides a table or list, shown generally at 3652, of the names of event facilities 3654 (e.g., schools, school districts, user groups, etc.) within the School DelayZz system 100 for the administrator 14 to review and select. In one embodiment, the list 3652 includes a check box control element 3656 with each one of the listed event facilities 3654, where the administrator 14 may select one or more individual ones of the event facilities 3654 listed to receive the same change of status. In one embodiment, the list 3652 also includes a check box control element 3658 where the administrator 14 may select all of the event facilities 3654 within the list 3652 to receive the same change of status. In one embodiment, one or more of the check box control elements 3656 corresponding individually to event facilities 3654 that may be selected, e.g., filled, to enable, or deselected, e.g., unfilled, to disable the propagation operation for that individual event facility. For example, as shown in FIG. 24, check boxes 3656A and 3656B are selected or enabled to propagate a change of status to two event facilities, a facility 3654A labeled “Alachua County Public Schools” and a facility 3654B labeled “Bessemer City”. As shown in FIG. 24, the Select Schools/School Districts dialog box 3650 may include a scroll bar control element 3660 which, when activated, allows the administrator 14 to visually exhibits additional values of event facilities 3654 beyond what is currently exhibited within the borders of the table or list 3652 of facilities. In one embodiment, the Select Schools/School Districts dialog box 3650 includes a region 3670 including a search block, shown generally at 3680, to narrow or filter within, or to add additional the event facilities 3654 to the list 3652. For example, as illustrated in FIG. 24, the administrator 14 may optionally manually input an event facility name in a first search field 3682. When a value is entered into the first search field 3682, the APP 154A narrows or filters the list 3652 or adds the specified event facilities 3654 to the event facilities exhibited in the list 3652 to match the named event facility. The administrator 14 may also optionally narrow or filter within, or to add additional the event facilities 3654, to the list 3652 by manually inputting or selecting a State in a second search field 3684 labeled “STATE”. As shown in FIG. 24, in one embodiment, the second search field 3684 includes a drop-down list element 3686 that, if activated, exhibits a list of States within, e.g., the United States, one or all of which that may be selected by the administrator 14. To implement or propagate the change of status to the additional one or more event facilities 3654 specified in the Select Schools/School Districts dialog box 3650, the administrator 14 selects a “DONE” control button 3690. Alternatively, the administrator 14 may end the propagation operation by selecting a “Cancel” control button 3692. In one embodiment, selecting the Save control button 3690 or the Cancel control button 3692 closes the Select Schools/School Districts dialog box 3650 and invokes or reactivates the Add Delays/Closings GUI 3600 (FIG. 23).

As shown in FIGS. 20, 21, and 22, each of the Delays, Closings & Dismissals GUIs 3300, 3400, and 3500, respectively, includes within the status tables 3352, 3452, and 3552, respectively, Actions columns 3354, 3454, and 3554. Each of the Actions columns include the edit icons 3354A, 3454A, and 3554A, respectively, that when selected invoke the Edit Delays/Closings GUI 3700 of FIG. 25, where the administrator 14 may view and edit details of the change of status for the event facility corresponding to the selected edit icon. For example, when the edit icon 3354A (FIG. 20) for the event facility “Bedford Public Schools” is selected, the School DelayZz APP 154A invokes the Edit Delays/Closings GUI 3700 of FIG. 25. In one embodiment, as shown by comparing FIG. 23 to FIG. 25, the Edit Delays/Closings GUI 3700 includes substantially the same fields and functionality of the Add Delays/Closings GUI 3600. However, when invoked, the Edit Delays/Closings GUI 3700 exhibits current values of the status change for the selected event facility, e.g., the Bedford Public Schools, selected as described above, when the edit icon 3354A (FIG. 20) is selected. As shown in FIG. 25, the Edit Delays/Closings GUI 3700 includes one or more regions for inputting information and/or initiating functionality of the system 100, for example, a first region shown generally at 3710 and a second region shown generally at 3740. In one embodiment, the first region 3710 provides fields and functionality for viewing and editing (e.g., modifying) the status change exhibited including a date field 3712 labeled “DATE”, an event facility field 3716 labeled “SELECT SCHOOLS/SCHOOL DISTRICT”, a series of radio control buttons, shown generally at 3718, for characterizing the type of status change, a first delay time field 3720 labeled “DELAYED TIME DURATION,” and a second delay time field 3724 labeled “CUSTOM DELAYED TIME DURATION.” As shown in FIG. 25, the APP 154A prefills these fields 3712, 3716, 3718, 3720, and 3724 with the values for the Bedford Public Schools change of status. Once exhibited, the administrator 14 may change values presented within these fields using similar functionality (e.g., a calendar control element 3714, within the date field 3712) as that employed within the Add Delays/Closings GUI 3600, as described above. To save any modification made to the change of status for the specified event facility (e.g., school, school district, or the like), the administrator 14 selects a “Save” control button 3742 in the second region 3780 of the Edit Delays/Closings GUI 3700 of FIG. 25. Alternatively, the administrator 14 ends the edit operation by selecting a “Cancel” control button 3744. In one embodiment, selecting the Save control button 3742 or the Cancel control button 3744 closes the Edit Delays/Closings GUI 3700 and invokes or reactivates the Delays, Closings & Dismissals GUIs 3300 (FIG. 20), 3400 (FIG. 21), and 3500 (FIG. 22) that invoked the Edit Delays/Closings GUI 3600 of FIG. 25.

Referring again to the Main Menu navigation bar 3210, if the administrator 14 selects the “SCHOOLS/SCHOOL DISTRICTS” option 3216, the APP 154A navigates to the Schools/School Districts GUI 3800 of FIG. 26 where the administrator 14 may view and manage (e.g., change or delete) detailed information for an existing event facility or invoke functionality to add a new event facility. In one embodiment, the Schools/School Districts GUI 3800 includes one or more regions for inputting information and/or initiating functionality of the system 100, for example, a first region shown generally at 3810 and a second region shown generally at 3850. In one embodiment, the first region 3810 provides fields and functionality for searching or filtering the detailed information for an existing facility or for initiating an operation to add a new event facility or edit an existing event facility. For example, the first region 3810 includes a Country control element 3812 labeled “Country” and that includes a drop-down list control element 3814 which exhibits a list of available countries for selection. With the Country control element 3812 the administrator 14 may select a country within the list of one or more countries having event facilities participating in the system 100. When activated, the APP 154A filters the event facility information exhibited on the Schools/School Districts GUI 3800 to include information only for event facilities within the selected country. In one embodiment, as illustrated in FIG. 26, a default value of the drop-down list control element 3814 is the United States of America (e.g., USA). In one embodiment, the first region 3810 also includes a search or filter input box 3820, which includes a keyword field 3822 labeled “Search”, a status field 3824 labeled “Status”, and a state field 3828 labeled “State.” In the keyword field 3822, the administrator 14 may manually input an event facility name or a unique code for a facility to locate or filter information exhibited within an event facility table, shown generally at 3852, within the second region 3850, and described in detail below. When a value is entered into the keyword field 3822, the APP 154A narrows or filters the event facility information exhibited for the named event facility or facility have the matching unique code. As shown in FIG. 26, the administrator 14 may also optionally narrow or filter the event facility information, by manually inputting or selecting (e.g., via a drop-down menu control 3826) a status in the status field 3824. In one embodiment, the status field 3824 refers to a validation status of the event facility and may include values of, for example, a “Pending” status or a “Verified” status. In one embodiment, as described herein, event facilities (e.g., schools, school districts, user groups, and the like) added by the School Administrators (described below) and verified by the School DelayZz administrator 14 are considered as a “Verified” status, while facilities added by the School Administrator and not yet verified by the School DelayZz Administrator 14 are considered as “Pending” status. In one embodiment, the APP 154A identifies the one or more event facilities each having a Verified status with a check icon 3858 within the table 3854 exhibited in the second region 3850. As shown in FIG. 26, in one embodiment, the administrator 14 may also optionally narrow or filter the event facility information, by manually inputting or selecting (e.g., via a drop-down menu control 3829) a state in the state field 3828. In one embodiment, the state drop-down menu control 3829, if activated, exhibits a list of States within the specified country (e.g., value of the country field 3812 of the USA), one or all of which that may be selected by the administrator 14. As noted above, if the administrator 14 enters a value in one of the fields 3822, 3824, 3828 of the search or filter input box 3820, the APP 154A narrows or filters the event facility information exhibited in the event facility table 3852 of the second region 3850.

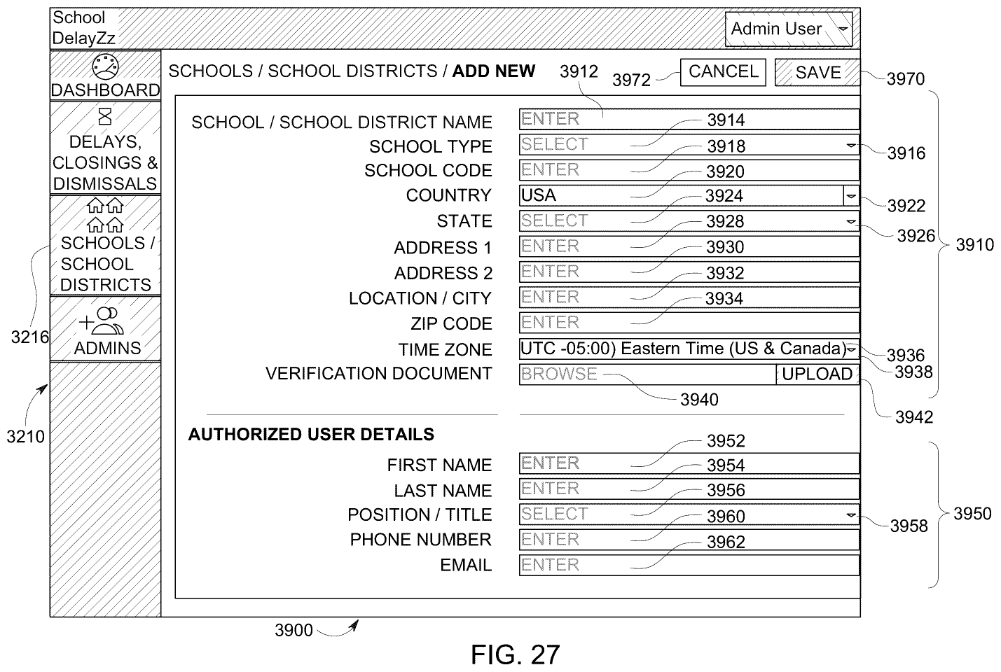

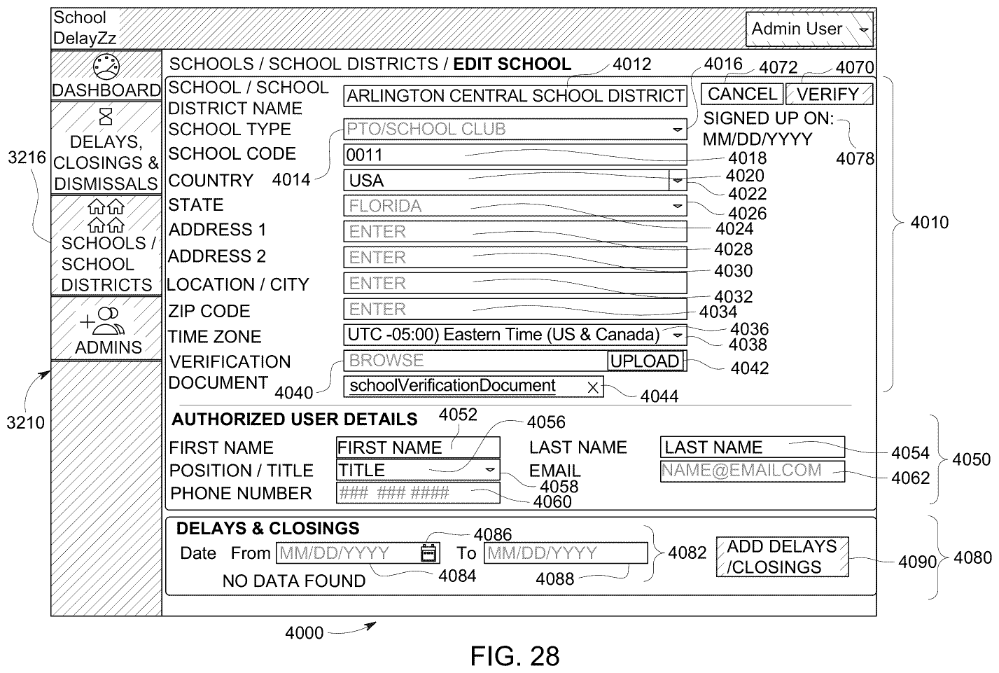

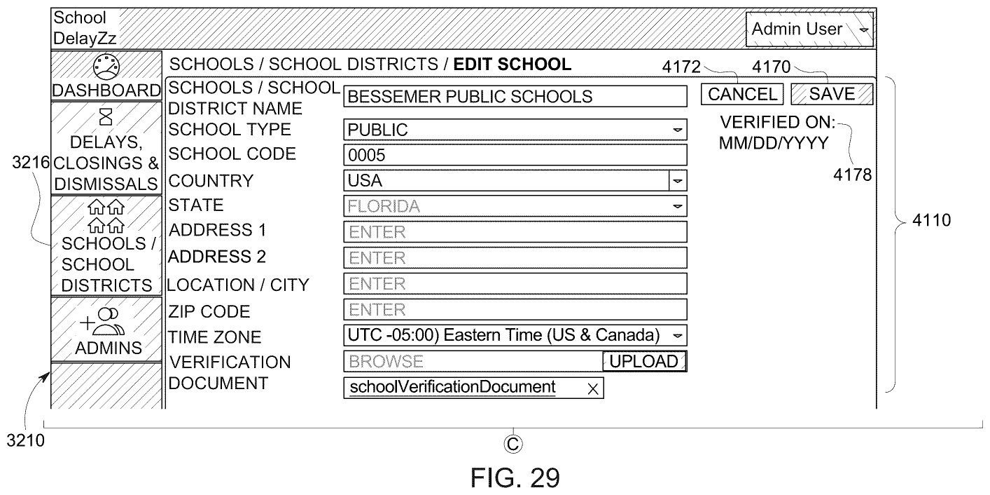

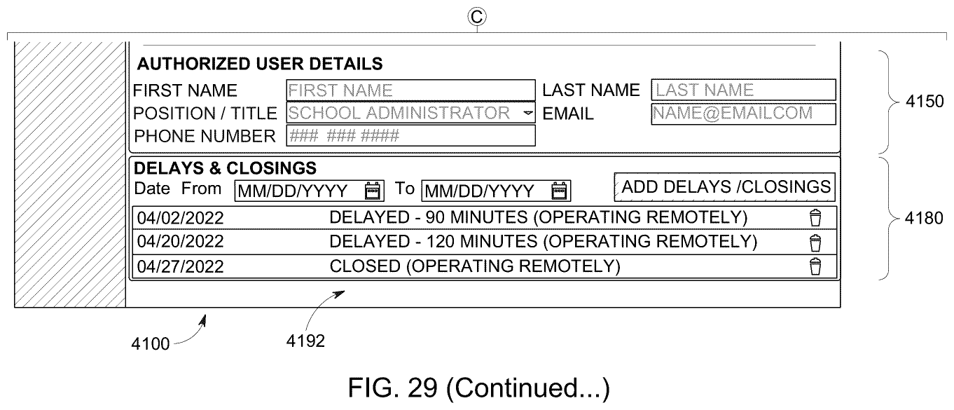

In one embodiment, the APP 154A performs the requested operation to exhibit event facility information in the event facility table 3852. In one embodiment, illustrated in FIG. 26, the table 3852 includes columns exhibiting, for example, a unique code for the event facilities listed, the names of event facilities (e.g., schools, school districts, user groups, etc.), state, number of registered users within the system 100 associated with the event facility, one or more authorized users for the event facility (e.g., persons being able to implement a change of status for the facility), a date of enrollment of the facility with the School DelayZz system 100, if applicable, a date the facility was verified, and an Actions column. In one embodiment, the Actions column, shown generally at 3854, includes one or more icons for each listed facility for initiating functionality to be performed on one of the listed facilities. For example, in one embodiment illustrated in FIG. 26, the one or more icons include an edit icon 3854A (e.g., a pencil and paper image) and a delete icon 3854B (e.g., a garbage can image). In one embodiment, if the administrator 14 selects the edit icon 3854A for one of the listed event facilities (e.g., Arlington Central School District), the APP 154A closes the Schools/School Districts GUI 3800 and invokes an Edit School GUI 4000 of FIG. 28 for a selected non-verified event facility (e.g., school, school district, or the like) or an Edit School GUI 4100 of FIG. 29 for a selected verified event facility, where the administrator 14 may view and edit details of the corresponding event facility (e.g., since 3854A is selected, the Edit School District GUI 4000 of FIG. 28 is invoked), as described below. In one embodiment, if the administrator 14 selects (e.g., double clicks with an input device such as a mouse) one of the listed event facilities by name, the APP 154A closes the Schools/School Districts GUI 3800 and invokes either the Edit School GUI 4000 of FIG. 28 for a selected non-verified event facility or the Edit School GUI 4100 of FIG. 29 for the selected verified event facility. In one embodiment, if the administrator 14 selects the delete icon 3854B for one of the listed event facilities, the APP 154A deletes the listed event facility. In one embodiment, prior to completing the delete operation, the APP 154A exhibits a confirmation pop up box (not shown) and requests that the administrator 14 confirms his/her instruction to delete the selected event facility. In one embodiment, illustrated in FIG. 26, if the event facilities table 3852 includes more entries for event facilities that can be exhibited on one page of the Schools/School Districts GUI 3800, the APP 154A provides a page navigation element 3856 that allows the administrator 14 to move between two or more pages of the facilities table 3852 exhibited on the Schools/School Districts GUI 3800. In one embodiment, the Schools/School Districts GUI 3800 includes a Date and Time element 3860 (e.g., included in the first region 3810) that provides the date and time that one of the administrators 14 last updated the list of event facilities exhibited within the event facilities table 3852. In one embodiment, illustrated in FIG. 26, the Schools/School Districts GUI 3800 also includes an ADD NEW control button 3870 (e.g., included in the first region 3810) that, if selected, the APP 154A closes the Schools/School Districts GUI 3800 and invokes an Add New GUI 3900 of FIG. 27, where the administrator 14 may add a new event facility (e.g., schools, school districts, user groups, or the like), as described below.

As shown in FIG. 27, the Add New GUI 3900 includes one or more regions for inputting information and/or initiating functionality of the system 100 to add a new event facility, for example, a first region shown generally at 3910 and a second region shown generally at 3950. In one embodiment, the first region 3910 provides fields and functionality for adding a new event facility (e.g., schools, school districts, user groups, or the like) and information describing the same. For example, the first region 3910 includes a name field 3912 labeled “SCHOOL/SCHOOL DISTRICT NAME,” an event facility type field 3914 labeled “SCHOOL TYPE” and that includes a drop-down list control element 3916, an event code field 3918 labeled “SCHOOL CODE,” and a Country control element 3920 labeled “COUNTRY” and that includes a drop-down list control element 3922 which exhibits a list of available countries for selection. As noted previously with related fields, with the Country control element 3920 the administrator 14 may select a country within the list of one or more countries having event facilities participating in the system 100. In one embodiment, as illustrated in FIG. 27, a default value of the drop-down list control element 3920 is the United States of America (e.g., USA). In one embodiment, the first region 3910 also includes a state field 3924 labeled “STATE” and that includes a drop-down list control element 3926 which exhibits a list of available states within the selected country for selection. The first region 3910 also includes street address fields 3928 and 3930 labeled “ADDRESS 1” and “ADDRESS 2”, respectively. The first region 3910 also includes a city field 3932 labeled “LOCATION/CITY” and a zip code field 3934 labeled “ZIP CODE”. The first region 3910 further includes a time zone field 3936 labeled “TIME ZONE” and that includes a drop-down list control element 3938 for selecting applicable time zones. In one embodiment, the APP 154A automatically detects and enters the applicable time zone from the values input into the Country control element 3920 and the state field 3924. In one embodiment, the automatically entered time zone may be overwritten (e.g., manually changed) by the administrator 14. In one embodiment, each of the aforementioned fields in the first region 3910 (e.g., fields 3912, 3914, 3918, 3920, 3924, 3928, 3930, 3932, 3934, and 3936) are “required” entries (e.g., entries that are required to have a non-blank or null value). In one embodiment, the first region 3910 may also include a verification document field 3940 labeled “VERIFICATION DOCUMENT.” In one embodiment, entry of a new event facility into the School DelayZz system 100 requires evidence of approval by the event facility. If so required, the verification document field 3940 is provided for submission of such a verification document. In one embodiment, entry of text within the field 3940 initiates a browser operation (as is known in the art) to locate a document corresponding to the text entered within a file directory accessible by the administrator 14. Once located, an upload control element 3942 labeled “UPLOAD” may be invoked to retrieve the document from the specified location with the file directory for submission to the School DelayZz system 100.

In one embodiment, the second region 3950 of the Add New GUI 3900 includes fields for identifying one or more authorized users (e.g., an administrator for the event facility, as described below) associated with the newly added event facility. For example, as shown in FIG. 27, the second region 3950, labeled “Authorized User Details,” includes a first name field 3952 labeled “FIRST NAME”, a second name field 3954 labeled “LAST NAME”, a position field 3956 labeled “POSITION/TITLE” and that includes a drop-down menu control element 3958, a phone number field 3960 labeled “PHONE NUMBER,” and an electronic mail field 3962 labeled “EMAIL”. In one embodiment, the drop-down menu control element 3958 includes values of, for example, “School Administrator,” “PTO/School Club,” or “Other.” In one embodiment, the adding of an authorized user for a particular event facility is an optional process. If added, in one embodiment, the APP 154A generates an electronic message to the authorized user inviting them to the School DelayZz system 100. In one embodiment, the electronic message includes a link to login to the system 100 and to set up an account by creating login credentials, as described herein. If the authorized user is not added or does not establish an account within, for example, a predefined time period, responsibility for managing details of the new event facility remains with the School DelayZz administrator 14. To create the newly specified event facility (e.g., schools, school districts, user groups, or the like), the administrator 14 selects a “Save” control button 3970 of the Add New GUI 3900 of FIG. 27. Once selected, in one embodiment, the APP 154A exhibits a confirmation pop up box (not shown) and requests that the administrator 14 confirms his/her instruction to add the new event facility and its related information to the system 100. When confirmed, the School DelayZz APP 154A adds a new entry to the list of event facilities 164 within the data storage device 160 and populates the related fields, e.g., the event facility name field 165, the status field 167, and the authorized user (e.g., Authorized Notifier) field 169. Alternatively, the administrator 14 ends the creation operation by selecting a “Cancel” control button 3972. In one embodiment, selecting the Save control button 3970 or the Cancel control button 3972 closes the Add New GUI 3900 (FIG. 27) and invokes or reactivates the Schools/School Districts GUI 3800 of FIG. 26.

Referring again to the Schools/School Districts GUI 3800 of FIG. 26, as shown, the Schools/School Districts GUI 3800 includes the list of event facilities exhibited within the event facilities table 3852 with each listed event facility having an Actions column that includes the edit icon, e.g., the edit icon 3854A. When either the name of the event facility or the edit icon is selected, the School DelayZz APP 154A invokes one of an Edit School GUI 4000 of FIG. 28 or an Edit School GUI 4100 of FIG. 29, where the administrator 14 may view and edit details of the event facility (e.g., schools, school districts, user groups, and the like) corresponding to the selected event facility name or edit icon. It should be appreciated that the Edit School GUI 4000 (FIG. 28) and the Edit School GUI 4100 (FIG. 29) are substantially similar and differ in that the Edit School Name GUI 4000 is invoked when the event facility selected (e.g., name or edit icon corresponding thereto) is a non-verified event facility such as, for example, an “Arlington Central School District” facility selected with edit icon 3854A of FIG. 26, and that the Edit School Name GUI 4100 is invoked when the event facility selected is a verified event facility such as, for example, a “Bessemer Public Schools” facility selected with the edit icon 3854C of FIG. 26.

In one embodiment, as shown by comparing FIG. 27 to FIGS. 28 and 29, the Edit School GUI 4000 (FIG. 28) and the Edit School GUI 4100 (FIG. 29) include substantially the same fields and functionality of the Add New GUI 3900 (FIG. 27). However, when invoked, the Edit School GUI 4000 (FIG. 28) and the Edit School GUI 4100 (FIG. 29) exhibit current values for the selected event facility. For example, and as shown in FIG. 28, the Edit School GUI 4000 includes one or more regions for inputting information and/or initiating functionality of the system 100 to edit a non-verified event facility, for example, a first region shown generally at 4010, a second region shown generally at 4050, and a third region shown generally at 4080. In one embodiment, the first region 4010 provides fields and functionality for editing the non-verified event facility (e.g., school, school district, user group, or the like) and information describing the same. For example, the first region 4010 includes a name field 4012 labeled “SCHOOL/SCHOOL DISTRICT NAME,” an event facility type field 4014 labeled “SCHOOL TYPE” and that includes a drop-down list control element 4016, an event code field 4018 labeled “SCHOOL CODE,” and a Country control element 4020 labeled “Country” and that includes a drop-down list control element 4022 which exhibits a list of available countries for selection. As noted previously with related fields, with the Country control element 4020 the administrator 14 may select a country within the list of one or more countries having event facilities participating in the system 100. In one embodiment, as illustrated in FIG. 28, a default value of the drop-down list control element 4020 is the United States of America (e.g., USA). In one embodiment, the first region 4010 also includes a state field 4024 labeled “State” and that includes a drop-down list control element 4026 which exhibits a list of available states within the selected country for selection. The first region 4010 also includes street address fields 4028 and 4030 labeled “ADDRESS 1” and “ADDRESS 2”, respectively. The first region 4010 also includes a city field 4032 labeled “LOCATION/CITY” and a zip code field 4034 labeled “ZIP CODE”. The first region 4010 further includes a time zone field 4036 labeled “TIME ZONE” and that includes a drop-down list control element 4038 for selecting applicable time zones. In one embodiment, the APP 154A automatically detects and enters the applicable time zone from the values input into the Country control element 4020 and the state field 4024. In one embodiment, the automatically entered time zone may be overwritten (e.g., changed) by the administrator 14. In one embodiment, each of the aforementioned fields in the first region 4010 (e.g., fields 4012, 4014, 4020, 4024, 4028, 4030, 4032, 4034, and 4036) are required entries and the event code field 4018 is an optional entry.

In one embodiment, the first region 4010 may also include a verification document field 4040 labeled “VERIFICATION DOCUMENT.” In one embodiment, as noted above when adding a new event facility into the School DelayZz system 100, the system 100 requires evidence of approval by the event facility. If it is required or desired to remove and to add a new verification document, the verification document field 4040 is provided for submission of such a new verification document. In one embodiment, entry of text within the field 4040 initiates a browser operation (as is known in the art) to locate a document corresponding to the text entered within a file directory accessible by the administrator 14. Once located, an upload control element 4042 labeled “UPLOAD” may be invoked to retrieve the document from the specified location with the file directory for submission to the School DelayZz system 100. An icon 4044 is exhibited once the uploaded document is loaded to permit review of the verification document, as needed or desired.

In one embodiment, the second region 4050 of the Edit School Name GUI 4000 includes fields for exhibiting current ones of persons identified as the one or more authorized users (e.g., an administrator for the event facility, as described below) associated with the event facility. For example, as shown in FIG. 28, the second region 4050 includes a first name field 4052 labeled “FIRST NAME”, a second or last name field 4054 labeled “LAST NAME”, a position field 4056 labeled “POSITION/TITLE” and that includes a drop-down menu control element 4058, a phone number field 4060 labeled “PHONE NUMBER,” and an electronic mail field 4062 labeled “EMAIL”. In one embodiment, the drop-down menu control element 4058 includes values of, for example, “School Administrator,” “PTO/School Club,” or “Other.” In one embodiment, the adding of an authorized user for a particular event facility is an optional process. Accordingly, the fields within the second region 4050 may not have current values for every event facility within the School DelayZz system 100. As also noted above, if the authorized user is not added or does not establish an account, responsibility for managing details of the new event facility remains with the School DelayZz administrator 14.

To save the edits made to the specified event facility (e.g., school, school district, or the like), the administrator 14 selects a “VERIFY” control button 4070 of the Edit School Name GUI 4000 of FIG. 28. Once selected, in one embodiment, the APP 154A exhibits a confirmation pop up box (not shown) and requests that the administrator 14 confirms his/her instruction to edit the event facility and its related information to the system 100. When confirmed, the School DelayZz APP 154A revises the entry for the selected facility in the list of event facilities 164 within the data storage device 160 (e.g., the event facility name field 165, the status field 167, and authorized user (e.g., Authorized Notifier) field 169, as appropriate). Additionally, by selecting the Verify Control button 4070, the administrator 14 initiates a verification process whereby the specified event facility may be verified for full access to the School DelayZz system 100. Alternatively, the administrator 14 ends the edit operation by selecting a “CANCEL” control button 4072. In one embodiment, selecting the Verify control button 4070 or the Cancel control button 4072 closes the Edit School Name GUI 4000 (FIG. 28) and invokes or reactivates the Schools/School Districts GUI 3800 of FIG. 26. In one embodiment, illustrated in FIG. 28, the Edit School Name GUI 4000 includes a Date element 4078 (e.g., included in the first region 4010) that provides the date that the selected event facility signed up to participate in the School DelayZz system 100.

In one embodiment, the third region 4080 of the Edit School Name GUI 4000 includes current status changes (e.g., a delay, closing, or change of format) for the exhibited event facility, and search or filter field 4082 for the same. However, as each of the event facilities exhibited in the Edit School Name GUI 4000 are not verified, it is anticipated that no status change information is exhibited. As exceptions may exist, the Edit School Name GUI 4000 is configured to support any such data. Accordingly, in one embodiment, the administrator 14 may optionally narrow or filter the change of status information displayed for the non-verified event facility by manually inputting or selecting a date range in the search field 4082 labeled “DATE”, which includes a beginning date field 4084 labeled “From” and an end date field 4088 labeled “To”. In one embodiment, the administrator 14 may manually input the date values for the beginning date field 4084 and the end date field 4088, e.g., in a day, month, and year (DD/MM/YYYY) format or may select Calendar control element 4086 that, if activated, exhibits a current year calendar (e.g., beginning with a current day), from which a day of the year may be selected by the administrator 14. Once the administrator 14 has completed his/her desired criteria for exhibiting the status information (e.g., entered values within date search field 4082), the APP 154A exhibits the status information for non-verified event facility being edited matching the criteria, if applicable. In one embodiment, illustrated in FIG. 28, the Edit School Name GUI 4000 includes an ADD DELAYS/CLOSINGS control button 4090 in the third region 4080 that, if selected, the APP 154A closes the Edit School Name GUI 4000 and invokes the Add Delays/Closings GUI 3600 of FIG. 23.

As noted above, the Edit School Name GUI 4100 of FIG. 29 includes substantially the same fields within its regions 4110, 4150, and 4180, as the Edit School Name GUI 4000 of FIG. 28 does within its regions 4010, 4050, and 4080, except that in the third region 4180 of the Edit School Name GUI 4100 the School DelayZz APP 154A exhibits a status information table 4192 including current status changes (e.g., a delay, closing, or change of format) for the exhibited, verified event facility. Additionally, in the first region 4110, as the exhibited event facility is already verified, the VERIFY control button 4070 of the Edit School Name GUI 4000 (FIG. 28) is replaced by a “SAVE” control button 4170 on the Edit School Name GUI 4100 (FIG. 29). When the SAVE control button 4170 is selected, the APP 154A exhibits a confirmation pop up box (not shown) and requests that the administrator 14 confirms his/her instruction to edit the verified event facility and its related information to the system 100. When confirmed, the School DelayZz APP 154A revises the entry for the selected facility in the list of event facilities 164 within the data storage device 160 (e.g., the event facility name field 165, the status field 167, and the authorized user (e.g., Authorized Notifier) field 169, as appropriate). Also, in the first region 4110 of FIG. 29, the Edit School Name GUI 4100 includes a Date element 4178 that provides the date that the selected event facility was verified to participate in the School DelayZz system 100.

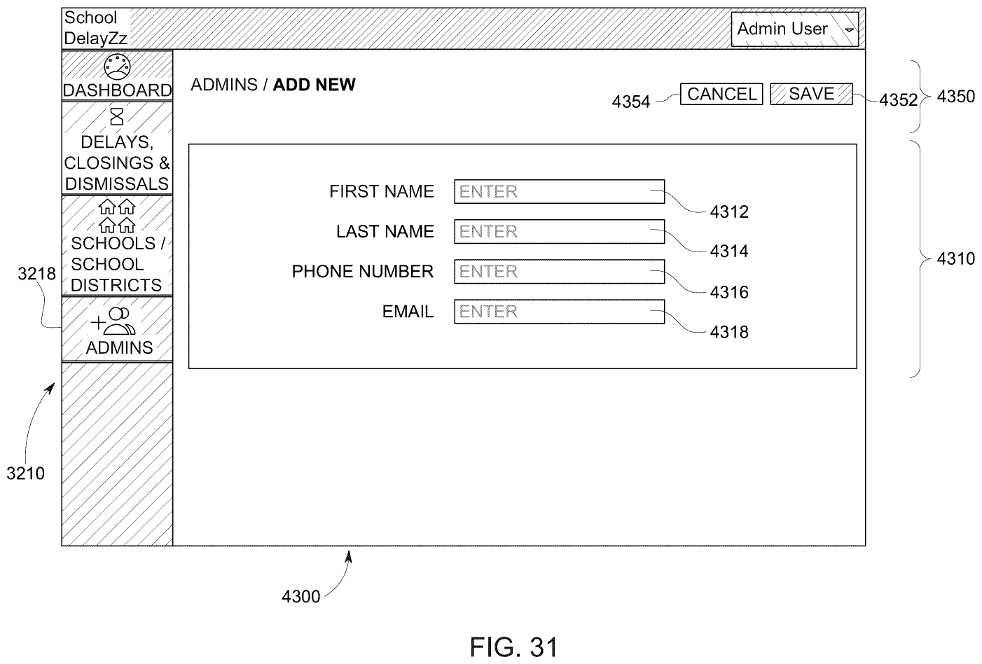

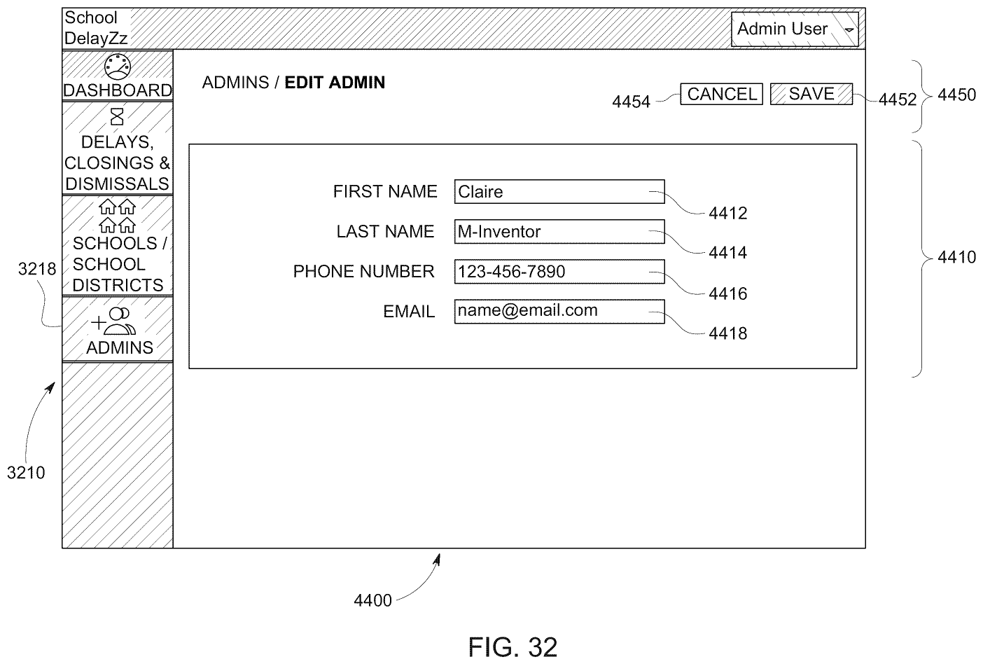

Referring again to the Main Menu navigation bar 3210, if the administrator 14 selects the “ADMINS” option 3218, the APP 154A navigates to the Admins GUI 4200 of FIG. 30 where the School DelayZz administrator 14 may view and manage (add, modify, or delete) co-administrators, in one embodiment, having a same level of access authority or less authority. In one embodiment, the Admins GUI 4200 includes one or more regions for inputting information and/or initiating functionality of the system 100, for example, a first region shown generally at 4210 and a second region shown generally at 4250. In one embodiment, when the ADMINS option 3218 is invoked, the APP 154A exhibits a list of administrators of the School DelayZz system 100 within the first region 4210 in an administrators table shown generally at 4220. In one embodiment, illustrated in FIG. 30, the administrator table 4220 includes columns exhibiting, for example, each administrator's first name, last name, electronic mail (email) address, and an Actions column. In one embodiment, the Actions column, shown generally at 4230, includes one or more icons for each listed facility for initiating functionality to be performed on one of the listed administrators. For example, in one embodiment illustrated in FIG. 30, the one or more icons include an edit icon 4230A (e.g., a pencil and paper image) and a delete icon 4230B (e.g., a garbage can image). In one embodiment, if the administrator 14 selects the edit icon 4230A for one of the listed administrators (e.g., Claire M-Inventor), the APP 154A closes the Admins GUI 4200 and invokes an Edit Admin GUI 4400 of FIG. 32 for the selected administrator 14 (e.g., Claire M-Inventor, as the edit icon 4230A is selected), where the administrator 14 may view and edit details of the corresponding administrator, as described below.

In one embodiment, if the administrator 14 selects (e.g., double clicks with an input device such as a mouse) one of the listed administrators 14 by name, the APP 154A also closes the Admins GUI 4200 and invokes the Edit Admin GUI 4400 of FIG. 32 for a selected administrator. In one embodiment, if the administrator 14 selects the delete icon 4230B for one of the listed administrators, the APP 154A deletes the listed administrator 14 from the system 100. In one embodiment, prior to completing the delete operation, the APP 154A exhibits a confirmation pop up box (not shown) and requests that the administrator 14 confirms his/her instruction to delete the selected administrator. In one embodiment, illustrated in FIG. 30, the Admins GUI 4200 also includes an ADD NEW control button 4252 (e.g., included in the second region 4250) that, if selected, the APP 154A closes the Admins GUI 4200 and invokes an Add New GUI 4300 of FIG. 31, where the administrator 14 may add a new administrator, as described below.

In one embodiment, as illustrated in FIG. 31, the Add New GUI 4300 includes one or more regions for inputting information and/or initiating functionality of the system 100 to add a new one of the administrators 14, for example, a first region shown generally at 4310 and a second region shown generally at 4350. In one embodiment, the first region 4310 provides fields and functionality for adding a new administrator and information identifying the same. For example, the first region 4310 includes a first name field 4312 labeled “FIRST NAME,” a last name field 4314 labeled “LAST NAME,” a telephone number field 4316 labeled “PHONE NUMBER,” and an electronic mail field 4318 labeled “EMAIL.” In one embodiment, the fields 4312, 4314, and 4318 of the first region 4310 are required entries and field 4316 is an optional entry. To create the newly specified administrator, the administrator 14 selects a “Save” control button 4352 of the Add New GUI 4300 of FIG. 31. Once selected, in one embodiment, the APP 154A exhibits a confirmation pop up box (not shown) and requests that the administrator 14 confirms his/her instruction to add the new one of the administrators 14 and his/her related identifying information to the system 100. When confirmed, the School DelayZz APP 154A adds a new entry for the administrator in a list of School DelayZz administrators (not shown) within the data storage device 160. Alternatively, the administrator 14 ends the creation operation for the proposed new administrator by selecting a “Cancel” control button 4354. In one embodiment, selecting the Save control button 4352 or the Cancel control button 4354 closes the Add New GUI 4300 (FIG. 31) and invokes or reactivates the Admins GUI 4200 of FIG. 30.

In one embodiment, as shown by comparing FIG. 32 to FIG. 31, the Edit Admin GUI 4400 (FIG. 32) includes substantially the same fields and functionality as the Add New GUI 4300 (FIG. 31). However, when invoked, the Edit Admin GUI 4400 (FIG. 32) exhibits current values for the selected one of the existing administrators 14. For example, and as shown in FIG. 32, the Edit Admin GUI 4400 includes one or more regions for inputting information and/or initiating functionality of the system 100 to edit one of the existing administrators 14, for example, a first region shown generally at 4410 and a second region shown generally at 4450. In one embodiment, the first region 4410 provides fields and functionality for editing the existing administrator and information identifying the same. For example, the first region 4410 includes a first name field 4412 labeled “FIRST NAME,” a last name field 4414 labeled “LAST NAME,” a telephone number field 4416 labeled “PHONE NUMBER,” and an electronic mail field 4418 labeled “EMAIL.” In one embodiment, the fields 4412, 4414, and 4418 of the first region 4410 are required entries and the field 4416 in an optional entry. When invoked, the current values of these fields are exhibited on the Edit Admin GUI 4400, for example, FIG. 32 exhibits values for administrator “Claire M-Inventor” as if edit icon 4230A (FIG. 30) was selected to invoke the Edit Admin GUI 4400. With these values exhibited, the administrator 14 may selectively review and edit these fields. To save the newly edited information for the selected administrator, the administrator 14 selects a “Save” control button 4452 of the Edit Admin GUI 4400 of FIG. 32. Once selected, in one embodiment, the APP 154A exhibits a confirmation pop up box (not shown) and requests that the administrator 14 confirms his/her instruction to revise and save the changes to one of the administrators 14 and his/her related identifying information to the system 100. When confirmed, the School DelayZz APP 154A revises the entry for the administrator in the list of School DelayZz administrators (not shown) within the data storage device 160. Alternatively, the administrator 14 ends the editing operation for the administrator by selecting a “Cancel” control button 4454. In one embodiment, selecting the Save control button 4452 or the Cancel control button 4454 closes the Edit Admin GUI 4400 (FIG. 32) and invokes or reactivates the Admins GUI 4200 of FIG. 30.

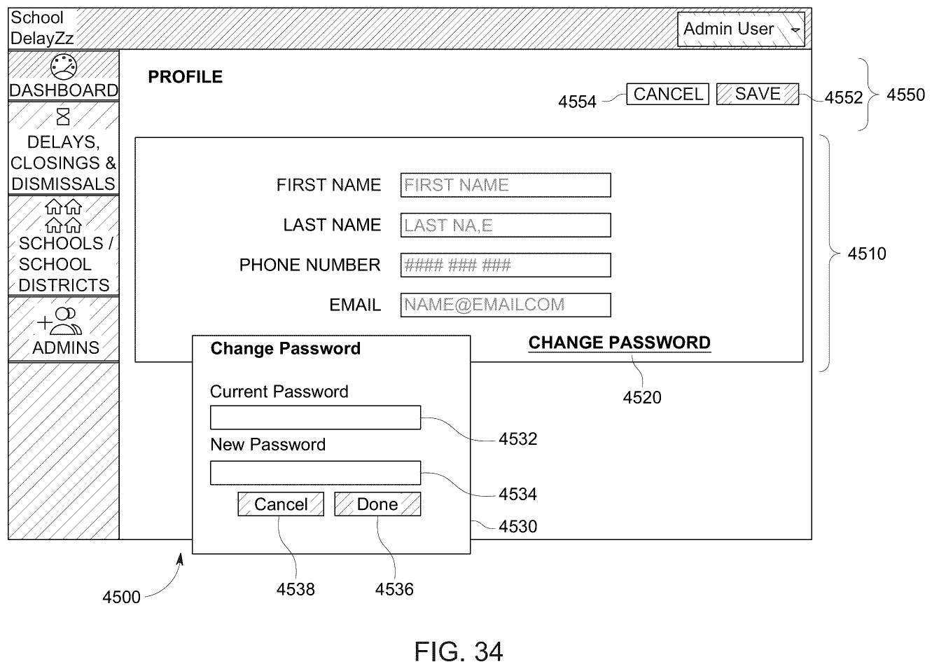

Referring again to the Dashboard GUI 3200 of FIG. 19, if the administrator 14 selects the PROFILE control element 3280 then, in response, the APP 154A closes of the Dashboard GUI 3200 and navigates to the Profile GUI 4500, illustrated in FIG. 33. In the Profile GUI 4500 one of the School DelayZz administrators 14 may view and modify current values within his/her own personal identifying information. For example, as shown in FIG. 33, the Profile GUI 4500 includes one or more regions for inputting information and/or initiating functionality of the system 100 to view and edit existing values within his/her own profile on the system 100, for example, within a first region shown generally at 4510 and a second region shown generally at 4550. In one embodiment, the first region 4510 provides fields and functionality for editing the administrator's own identifying information. For example, the first region 4510 includes a first name field 4512 labeled “FIRST NAME,” a last name field 4514 labeled “LAST NAME,” a telephone number field 4516 labeled “PHONE NUMBER,” and an electronic mail field 4518 labeled “EMAIL.” In one embodiment, each of the aforementioned fields in the first region 4510 (e.g., fields 4512, 4514, 4516, and 4518) are required entries. With the current values of these fields exhibited on the Profile GUI 4500, the administrator 14 may selectively review and edit these fields. In one embodiment, the first region 4510 also includes a change password textual navigation control element 4520 for the administrator 14 to change his/her password. When the change password textual navigation control element 4520 is selected, the School DelayZz APP 154A invokes a Change Password Dialog Box 4530 on the Profile GUI 4500, as illustrated in FIG. 34, in which the administrator 14 enters his/her current password in a current password field 4532 labeled “Current Password” and a new password in a new password field 4534 labeled “New Password.” Once the administrator 14 enters a new password in an approved format (e.g., see password requirements included in the Sign Up GUI 1200 of FIG. 5), the administrator 14 selects a “Done” control button 4536 of the Change Password Dialog Box 4530 of FIG. 34. Once the Done Control button 4536 is selected, the School DelayZz APP 154A saves the new password within the administrator's profile in the list of School DelayZz administrators (not shown) within the data storage device 160. Alternatively, the administrator 14 ends the change password operation by selecting a “Cancel” control button 4538 on the Change Password Dialog Box 4530. In one embodiment, selecting the Save control button 4536 or the Cancel control button 4538 closes the Change Password Dialog Box 4530 (FIG. 34) and invokes or reactivates the Profile GUI 4500 of FIG. 33.

To save the newly edited information within the administrator's own profile, the administrator 14 selects a “Save” control button 4552 of the Profile GUI 4500 of FIG. 33. Once selected, in one embodiment, the APP 154A exhibits a confirmation pop up box (not shown) and requests that the administrator 14 confirms his/her instruction to revise and save the changes to his/her own profile to the system 100. When confirmed, the School DelayZz APP 154A revises the entry for the administrator 14 within the list of School DelayZz administrators (not shown) within the data storage device 160. Alternatively, the administrator 14 ends the editing operation for his/her own profile by selecting a “Cancel” control button 4554. In one embodiment, selecting the Save control button 4552 or the Cancel control button 4554 closes the Profile GUI 4500 (FIG. 33) and invokes or reactivates the GUI that initiated the action or, alternatively, invokes or reactivates the Admins GUI 4200 of FIG. 30.

### School Administrator as Client/User—Application Overview

As noted above, the users 10 (e.g., operators of the client/user devices 120) of the system 100 may include attendees or participants of the event being conducted at one of the event facilities but also others including, for example, persons picking up or dropping off the attendees of the event, as well as administrators of one or more of the event facilities 165 (e.g., school, school district, or the like). Similar to the one or more of the administrators 14 (e.g., operators of the server 150) of the School DelayZz event notification and messaging system 100 that may access the GUIs 3000 to execute features and functionality of the system 100, as described herein, administrators of one or more of the event facilities 165 may access the School DelayZz system 100 by navigating one of the client/user devices 120 to a URL for website access to the system 100. In one embodiment, in this website access to the system 100, the APP 124A may cooperate with features and functions of the system 100 hosted on the server 150 (e.g., modules of APP 154A) and/or stored within the data storage device 160 (e.g., modules of APP 160A).

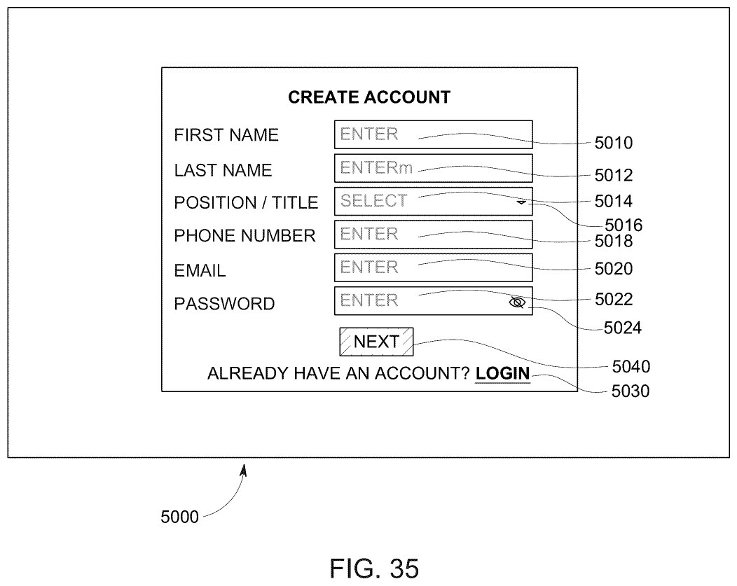

As shown in FIG. 35, one of the School DelayZz event facility administrators 10 navigates to the URL for the School DelayZz event notification and messaging system 100 and is presented by the School DelayZz APP 124A with a Create Account GUI 5000. In the Create Account GUI 5000, the event facility administrator 10 enters his/her personal identification details as well as the details for the event facility for which they are responsible. For example, as illustrated in FIG. 35 the event facility administrator 10 enters his/her first name in a first name field 5010 labeled “FIRST NAME,” his/her last name in a last name field 5012 labeled “LAST NAME,” his/her position or title in a position field 5014 labeled “POSITION/TITLE” and that includes a drop-down menu control element 5016, his/her telephone number at the event facility in a telephone number field 5018 labeled “PHONE NUMBER,” his/her electronic mail address in an electronic mail field 5020 labeled “EMAIL,” and a password in a password field 5022 labeled “PASSWORD” and that includes a selectable icon to, for example, a reveal, unblock, or unconceal a value within the password field 5022 including an “Eye” icon (not shown) and, alternatively, obfuscate, block, or conceal the value within the password field depicted with an “Eye with Slash” icon 5024. As is known in the art, the Create Account GUI 5000 allows the event facility administrator 10 to toggle between viewing the value in the password field 5022 (e.g., when the Eye icon is exhibited) and to conceal the value in the password field 5022 (e.g., when the Eye with Slash icon 5024 is exhibited). In one embodiment, the default for the password field 5022 is to have its value obfuscated or concealed. In one embodiment, the drop-down menu control element 5016 of the position field 5014 includes values of, for example, “School Administrator,” “PTO/School Club,” or “Other.” In one embodiment, each of the aforementioned fields (e.g., fields 5010, 5012, 5014, 5018, 5020, and 5022) are required entries. In one embodiment, the values of the electronic mail field 5020 and the password field 5022 are the event facility administrator's login credentials for the School DelayZz system 100. In one embodiment, the Create Account GUI 5000 also includes a navigational control element 5030 labeled “ALREADY HAVE AN ACCOUNT? LOGIN.” If selected, the Create Account GUI 5000 is ended, and the event facility administrator 10 is provided a Login GUI (not shown) substantially similar to the Login GUI 3100 of FIG. 17 for the School DelayZz administrator 14.

In one embodiment, the Create Account GUI 5000 (FIG. 35) also includes a navigational control element 5040 labeled “NEXT” to continuing entering values to create an account with the system 100. When selected, the APP 124A invokes a second step in the create account process where a Create Account—School Details GUI 5100 of FIG. 36 is exhibited to the event facility administrator 10. As shown in FIG. 36, the Create Account—School Details GUI 5100 includes one or more regions for inputting information and/or initiating functionality of the system 100 to add a new event facility, for example, a first region shown generally at 5110. In one embodiment, the first region 5110 provides fields and functionality for adding a new event facility (e.g., school, school district, or the like) and information describing the same. For example, the first region 5110 includes a name field 5112 labeled “SCHOOL/SCHOOL DISTRICT NAME,” an event facility type field 5114 labeled “SCHOOL TYPE” and that includes a drop-down list control element 5116, an event code field 5118 labeled “SCHOOL CODE,” and a Country control element 5120 labeled “COUNTRY” and that includes a drop-down list control element 5122 which exhibits a list of available countries for selection. As noted previously with related fields, with the Country drop-down control element 5122 the event facility administrator 10 may select a country within the list of one or more countries having event facilities participating in the system 100. In one embodiment, as illustrated in FIG. 36, a default value of the drop-down list control element 5122 is the United States of America (e.g., USA). In one embodiment, the first region 5110 also includes a state field 5124 labeled “STATE” and that includes a drop-down list control element 5126 which exhibits a list of available states within the selected country for selection. The first region 5110 also includes street address fields 5128 and 5130 labeled “ADDRESS 1” and “ADDRESS 2”, respectively. The first region 5110 also includes a city field 5132 labeled “LOCATION/CITY” and a zip code field 5134 labeled “ZIP CODE”. The first region 5110 further includes a time zone field 5136 labeled “TIME ZONE” and that includes a drop-down list control element 5138 for selecting applicable time zones. In one embodiment, the APP 124A automatically detects and enters the applicable time zone derived from the values input into the Country field 5120 and the state field 5124. In one embodiment, the automatically entered time zone may be overwritten (e.g., manually changed) by the event facility administrator 10. In one embodiment, each of the aforementioned fields in the first region 5010 (e.g., fields 5112, 5114, 5118, 5120, 5124, 5128, 5130, 5132, 5134, and 5136) are required entries. In one embodiment, the first region 5110 may also include a verification document field 5140 labeled “VERIFICATION DOCUMENT.” In one embodiment, entry of a new event facility into the School DelayZz system 100 requires evidence of approval by the event facility. If so required, the verification document field 5140 is provided for submission of such a verification document. In one embodiment, entry of text within the field 5140 initiates a browser operation (as is known in the art) to locate a document corresponding to the text entered within a file directory accessible by the event facility administrator 10. Once located, an upload control element 5142 labeled “UPLOAD” may be invoked to retrieve the document from the specified location with the file directory for submission to the School DelayZz system 100.

In one embodiment, the first region 5110 of the Create Account—School Details GUI 5100 further includes a check box control element 5150 labeled “I AGREE TO THE TERMS AND CONDITIONS”, wherein the event facility administrator 10 indicates the facility's approve of terms and conditions for use and participation in the School DelayZz system 100. In one embodiment, the “TERM AND CONDITIONS” portion of the label is a textual navigation control element 5152 that, when selected, the School DelayZz APP 124A invokes documentation or a webpage exhibiting the terms and conditions for use and participation in the School DelayZz system 100 to the facility administrator for his/her review and, if desired, printing. In one embodiment, activation of the check box control element 5150 is required prior to the event facility to become active within the School DelayZz system 100. To create the newly specified event facility (e.g., school, school district, or the like), the event facility administrator 10 selects a “SIGN UP” control button 5160 of the Create Account—School Details GUI 5100 of FIG. 36. Once selected, in one embodiment, the APP 124A exhibits a confirmation pop up box (not shown) and requests that the event facility administrator 10 confirms his/her instruction to add the new event facility and its related information to the system 100. When confirmed, the event facility administrator 10 receives a “successfully added” message (not shown) informing the administrator 10 that the event facility has been added to the system 100 and awaits review and verification prior to full admission in an “Active Status.” In one embodiment, the confirmation of the addition also triggers the School DelayZz APP 124A to add a new entry to the list of event facilities 164 within the data storage device 160, to populate the related fields, and to trigger a message to one of the School DelayZz administrators 14 notifying the administrator 14 that a new event facility has been added, for example, in a “Pending Status.” The APP 124A also requests that one of the administrators 14 reviews of the event facility details and provide verification for activation with the School DelayZz system 100. Once verified, the new event facility is activated, and the event facility administrator 10 is notified that he/she may login to the School DelayZz system 100. In one embodiment, each of the above-described notification messages is provided via an electronic mail message. In one embodiment, the Create Account—School Details GUI 5100 also includes a navigational control element 5170 labeled “ALREADY HAVE AN ACCOUNT? LOGIN.” If selected, the Create Account GUI 5100 is ended, and the event facility administrator 10 is provided a Login GUI (not shown) substantially similar to the Login GUI 3100 of FIG. 17 for the School DelayZz administrator 14. In one embodiment, selecting the SIGN UP control button 5160 closes the Create Account—School Details GUI 5100 (FIG. 36) and invokes or reactivates the Login GUI.

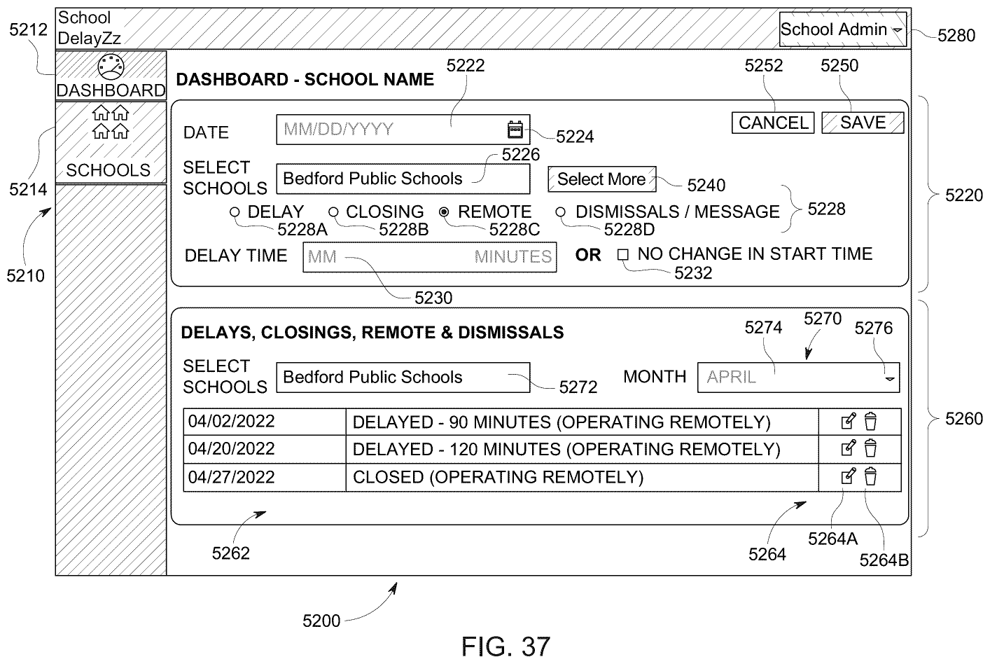

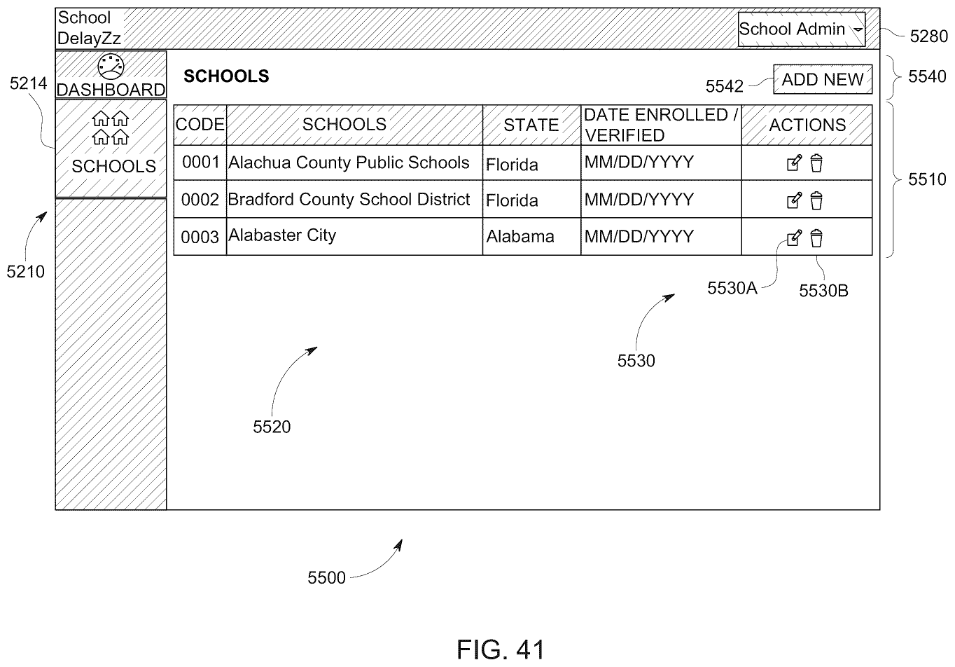

Once the School DelayZz administrator 14 has verified the new event facility, the event facility administrator 10 may enter his/her login credentials (e.g., email address and password). In one embodiment, once the event facility administrator 10 has entered their login credentials and the APP 124A has validated the administrator's login credentials to ensure that the administrator 10 is authorized to access the School DelayZz system 100, the APP 124A exhibits a Dashboard—School Name GUI 5200 of FIG. 37 to the event facility administrator 10. In one embodiment, each of the GUIs 5200 to 5800 described below and exhibited by the School DelayZz APP 124A to the one or more event facility administrators 10, for example the Dashboard—School Name GUI 5200 of FIG. 37, may include a Main Menu navigation bar 5210, which may be selected to navigate through the GUIs 5200 to 5800. For example, a “DASHBOARD” option 5212 may be selected (e.g., the administrator 10 double clicks the element with an input device such as a mouse) on the Main Menu navigation bar 5210 to navigate to the Dashboard—School Name GUI 5200 of FIG. 37 or a “SCHOOLS” option 5214 may be selected to navigate to a Schools GUI 5500 of FIG. 41. It should be appreciated that, while not shown, it is within the scope of the present disclosure for the Main Menu navigation bar 5210 for the event facility administrator 10 to include other options such as, for example, a “DELAYS, CLOSING & DISMISSALS” option similar to the Main Menu navigation bar 3210 for the system administrator 14, as described above. In one embodiment, the DELAYS, CLOSING & DISMISSALS option for the Main Menu navigation bar 5210 may invokes a Delays, Closings & Dismissals GUI (not shown), substantially similar to the Delays, Closings & Dismissals GUI 3300 of FIG. 20, where the event facility administrator 10 may utilize the APP 124A to view, add, change, or delete one of the statuses exhibited (e.g., a delay, closing, dismissal, or change in format to remote) for the event facilities (e.g., schools, school districts, user groups, etc.) that he/she manages within the School DelayZz system 100. In one embodiment, the Delays, Closings & Dismissals GUI (not shown) for the event facility administrator 10 includes an ADD DELAYS/CLOSINGS control button (e.g., similar to the ADD DELAYS/CLOSINGS control button 3370 of FIG. 20) that, if selected, the APP 124A closes the Delays, Closings & Dismissals GUI (not shown) and invokes an Add Delays/Closings GUI (not shown) (e.g., similar to the Add Delays/Closings GUI 3600 of FIG. 23), where the event facility administrator 10 may add a new occurrence of a delay, a closing, or a dismissal of an event facility, as described with reference to features and functionality described above and provided to the system administrator 14 by the system 100.

In one embodiment, the Dashboard—School Name GUI 5200 includes one or more regions for exhibiting information and/or initiating functionality of the system 100, for example, a first region shown generally at 5220 and a second region shown generally at 5260, where the event facility administrator 10 may view and manage (add, change, or delete) a change of status (e.g., delay, closing, or change of format) for their assigned event facility. In one embodiment, the first region 5220 includes fields and functionality for the event facility administrator 10 to add a new occurrence of a status change to an event, for example, a delay, a closing, an early dismissal, a late dismissal (e.g., due to a hold over or shelter in place order), or a change of format of the event at his/her assigned event facility. In one embodiment, the first region 5220 includes a date field 5222 labeled “DATE” and that has a Calendar control element 5224, an event facility field 5226 labeled “SELECT SCHOOLS,” a series of radio control buttons, shown generally at 5228, for characterizing the type of status change, a delay time field 5230 labeled “DELAY TIME,” and a no delay time check box control 5232 labeled “NO CHANGE IN START TIME.” With reference to the date field 5222, in one embodiment, the event facility administrator 10 may manually input a date value for the change of status to an event, e.g., in a day, month, and year (DD/MM/YYYY) format or may select the Calendar control element 5224 that, if activated, exhibits a current year calendar (e.g., beginning with a current day), from which a day of the year may be selected by the administrator 10. In the event facility field 5226, in one embodiment, the administrator 10 may manually input an event facility name value in which the new change of status is scheduled to occur. As described below, if the new change of status is to occur at two or more event facilities, the administrator 10 may invoke functionally to propagate the change of status to other event facilities by activating a Select More control button 5240, as described more fully below.

With the date and the event facility for the new change of status to occur selected and input into fields 5222 and 5226, the event facility administrator 10 further defines the character of the type of status change by selecting one of the radio control buttons 5228. In one embodiment, a first one 5228A of the radio control buttons 5228 is labeled “DELAY,” a second one 5228B is labeled “CLOSING,” a third one 5228C is labeled “REMOTE, and a fourth one 5228D is labeled “DISMISSAL/MESSAGE.” In one embodiment illustrated in FIG. 37, the status change type field 5228 is a binary choice, e.g., only one of the types radio buttons DELAY 5228A, CLOSING 5228B, REMOTE 5228C, or DISMISSAL/MESSAGE 5228D may be selected, such that when one of the types is selected and enabled, the other three options are deactivated and not selectable so that the new occurrence of the change in status only has one type value. In one embodiment, when the type of status change is one of a delay (e.g., the DELAY radio control button 5228A is enabled), a dismissal (e.g., the DISMISSAL/MESSAGE radio control button 5228D is enabled), or of a change in format (e.g., the REMOTE radio control button 5228C is enabled), the delay time field 5230 is activated for receiving input data. Once activated, the administrator 10 may utilize the delay time field 5230 to input a value (e.g., in minutes) for the delay in the scheduled start time for the new occurrence of the change in status for the event. In one embodiment, the delay time field 5230 may include a dropdown menu control (not shown) that exhibits predefined values of, for example, “60 mins”, “90 mins”, “120 mins”, or “Other”. It should be appreciated that while these four (4) values are described, the present disclosure is not limited to these values and that other preset values may be implemented using the features and functions of the present disclosure. Alternatively, in one embodiment, the administrator 10 may activate the delay time check box control 5232 labeled “NO DELAY IN START TIME” to indicate that there is no planned delay in the start time, for example, when the status change is a change of format to remote.

In one embodiment, when the DISMISSAL/MESSAGE radio control button 5228D is enabled, the APP 124A invokes features and functions to permit one of the event facility administrators 10 to broadcast a message to users 10 associated with one or more event facilities (e.g., schools, school districts, user groups, or the like). For example, the APP 124A invokes an alert or notification message dialog box (not shown) where the administrator 12 may enter a custom or predefined message of a situation at or in proximity to the event facility that may impact the originally scheduled daily events at the event facility (e.g., resulting in an early or late dismissal). To create the new occurrence of the specified change of status for the specified event facility (e.g., school, school district, or the like) within the system 100, the administrator 10 selects a “Save” control button 5250 in the first region 5210 of the Dashboard—School Name GUI 5200 of FIG. 37. Once saved, the specified change of status is stored in the list of event facilities 164 including its corresponding fields such as the status 167 of the facility 165, within the data storage device 160. Alternatively, the administrator 10 ends the creation operation by selecting a “Cancel” control button 5252. In one embodiment, selecting the Save control button 5250 or the Cancel control button 5252 clears all input information within the Dashboard—School Name GUI 5200.

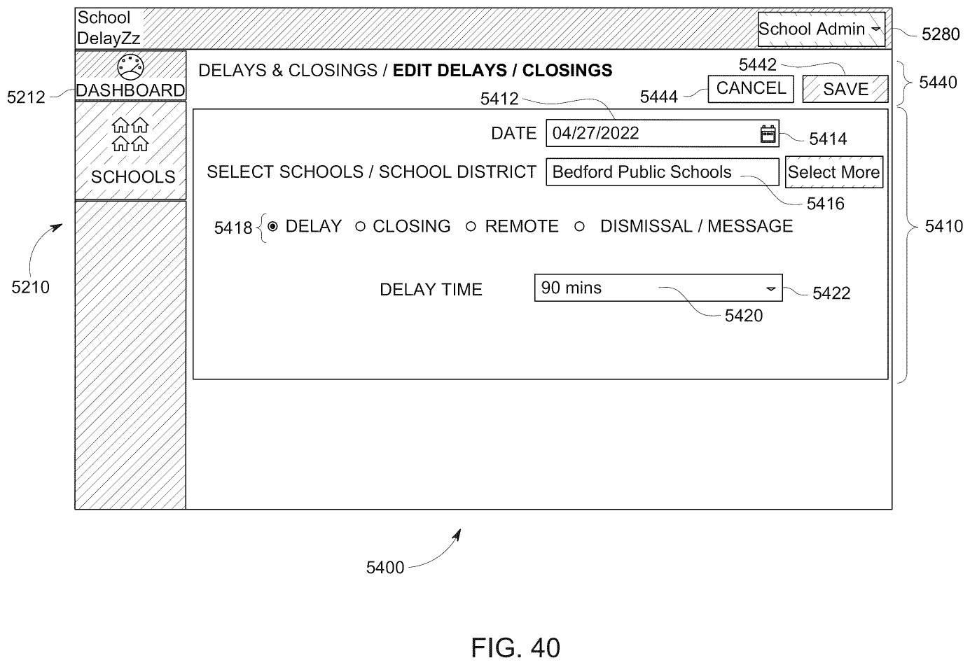

In one embodiment, the second region 5260 of the Dashboard—School Name GUI 5200 includes a Delay & Closings table, shown generally at 5262, that is populated by the School DelayZz APP 124A to exhibit the status changes for event facilities (e.g., schools, school districts, or the like) for which the event facility administrator 10 is responsible. In one embodiment, the Delays & Closing table 5262 exhibits the particular change of status indicated in the first region 5220, for example, the delay (e.g., if the DELAY radio control button 5228A is enabled), the closing (e.g., if the CLOSING radio control button 5228B is enabled), the change in format (e.g., if the REMOTE radio control button 5228C is enabled), or the dismissal/messaging (e.g., if the DISMISSAL/MESSAGE radio control button 5228BD is enabled) for the event facility specified in the event facility field 5226 (e.g., Bedford Public Schools). In one embodiment, the Delay & Closings table 5262 exhibits a date and a type of change of status. In one embodiment, the Delay & Closing table 5262 also includes an Actions column, shown generally at 5264. In one embodiment, the Actions column 5264 includes one or more icons for each listed status change for initiating functionality to be performed by the APP 124A. For example, in one embodiment illustrated in FIG. 37, the one or more icons include an edit icon 5264A (e.g., a pencil and paper image) and a delete icon 5264B (e.g., a garbage can image). In one embodiment, if the administrator 10 selects the edit icon 5264A for one of the listed status changes, the APP 124A closes the Dashboard—School Name GUI 5200 and invokes an Edit Delays/Closing GUI 5400 of FIG. 40, where the administrator 10 may view and edit details of the status change for the event facility, as described below. In one embodiment, if the administrator 10 selects the delete icon 5264B for one of the listed status changes, the APP 124A deletes the listed status change for the specified event facility. In one embodiment, prior to completing the delete operation, the APP 124A exhibits a confirmation pop up box (not shown) and requests that the administrator 10 confirms his/her instruction to delete the selected status change entry. Additionally, the second region 5260 includes search or filter fields, shown generally at 5270, that may be used by one of the event facility administrators 10 to initiate a search for one of the event facilities within system 100 (e.g., a school, school district, or the like). For example, to initiate the search or to filter or narrow the results with the Delays & Closing table 5262, the administrator 10 manually inputs an event facility name in a first search field 5272 labeled “SELECT SCHOOLS”, wherein the APP 124A initiates a “keyword” search or filter operation for the value entered in the first search field 5272. Additionally or alternatively, the administrator 10 may initiate the search and/or narrow or filter operation by manually inputting or selecting a month in a second search field 5274 labeled “MONTH”. As shown in FIG. 37, in one embodiment, the second search field 5274 includes a drop-down list element 5276 that, if activated, exhibits a list of months of the year, one of which that may be selected by the administrator 10. Once the administrator 10 has completed his/her desired search criteria (e.g., entered values within one or more of the search fields 5272 and/or 5274), the APP 124A performs a search of event facilities within the system 100. In one embodiment, the APP 124A performs the requested search and returns results matching the inputted criteria in the Delays & Closings table 5262.

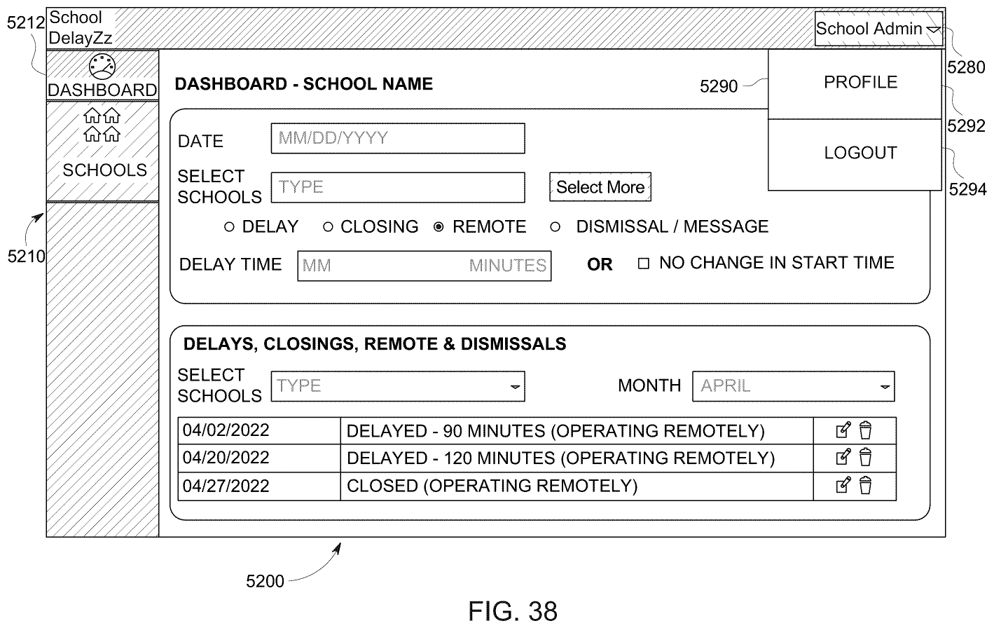

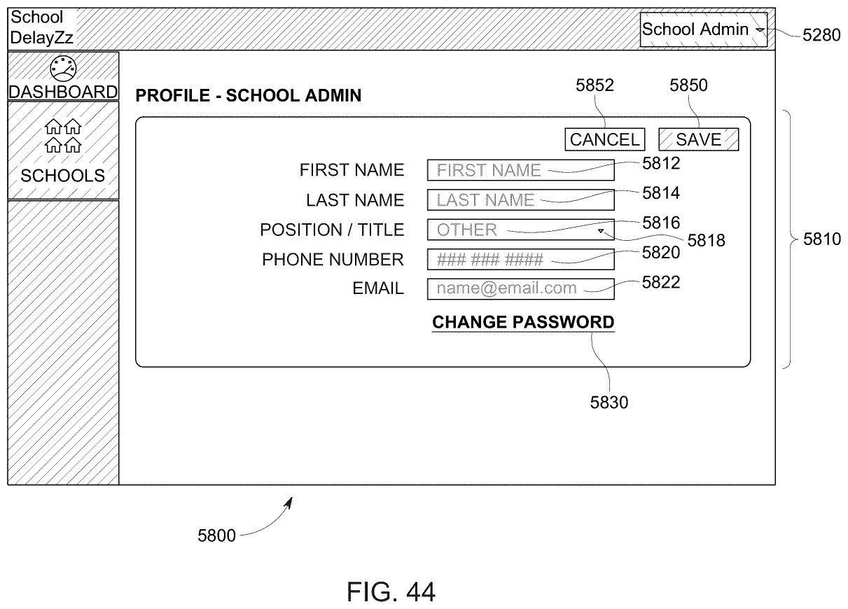

In one embodiment, the Dashboard—School Name GUI 5200 also further includes an “School Admin” dropdown menu control 5280 that, if selected, as shown in FIG. 38, the APP 124A exhibits a navigation menu 5290 including options of a PROFILE control element 5292 and a LOGOUT control element 5294. It should be appreciated that, in one embodiment, the “School Admin” dropdown menu control 5280 providing access to the navigation menu 5290, like the Main Menu navigation bar 5210 discussed above, is exhibited on each of the GUIs 5000 to 5800 exhibited by the School DelayZz APP 124A to the one or more School DelayZz event facility administrators 10. If the administrator 10 selects the PROFILE control element 5292 then, in response, the APP 124A closes of the Dashboard—School Name GUI 5200 and navigates to a Profile—School Admin GUI 5800, illustrated in FIG. 44. If the administrator 10 selects the LOGOUT control element 5294 then, in response, the APP 124A closes of the Dashboard—School Name GUI 5200, terminates the school administrator's current access to the School DelayZz system 100, and navigates to the Login GUI, described above.

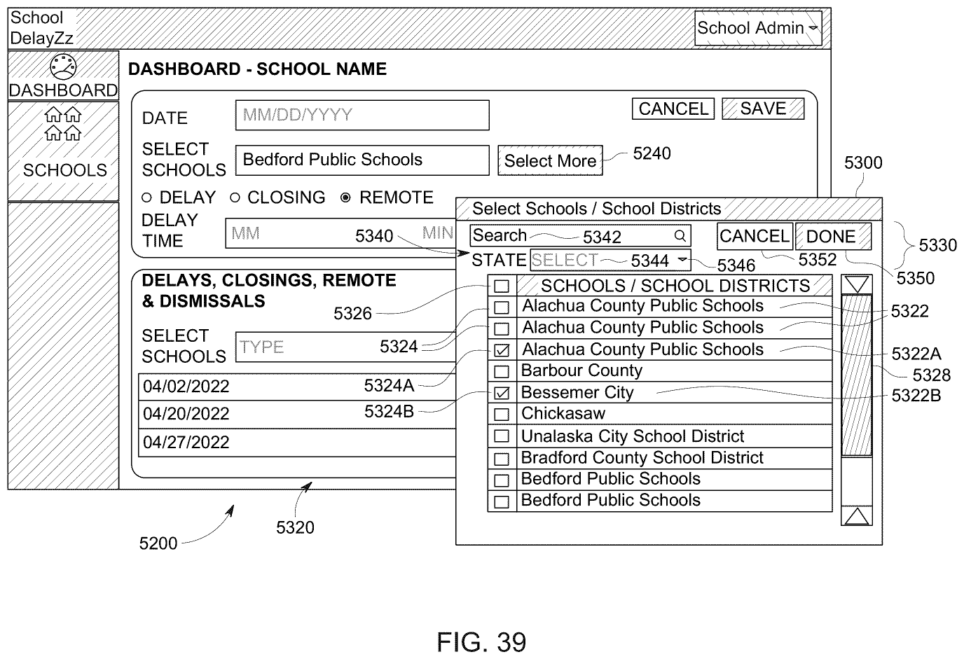

As noted above, in one embodiment, the event facility administrator 10 may invoke functionally to propagate the same change of status entered on the Dashboard—School Name GUI 5200 for the specified event facility (e.g., school, school district, or the like) to other event facilities by activating the Select More control button 5240 of the first region 5220 to invoke a Select Schools/School Districts dialog box 5300. In one embodiment, as illustrated on FIG. 39, the School DelayZz APP 124A exhibits the Select Schools/School Districts dialog box 5300 on the Dashboard—School Name GUI 5200. In one embodiment, the Select Schools/School Districts dialog box 5300 enables propagation of a same change of status made in the first region 5220 of the Dashboard—School Name GUI 5200 to one or more other event facilities. For example, in one embodiment, the Select Schools/School Districts dialog box 5300 provides a table or list, shown generally at 5320, of the names of event facilities 5322 (e.g., schools and/or school districts) within the School DelayZz system 100 for the administrator 10 to review and select. In one embodiment, the list 5320 includes a check box control element 5324 associated with each one of the listed event facilities 5322, where the administrator 10 may select one or more individual ones of the event facilities 5322 listed to receive the same change of status. In one embodiment, the list 5320 also includes a check box control element 5326 where the administrator 10 may select all of the event facilities 5322 within the list 5320 to receive the same change of status. In one embodiment, one or more of the check box control elements 5324 corresponding individually to event facilities 5322 may be selected, e.g., filled, to enable, or deselected, e.g., unfilled, to disable the propagation operation. For example, as shown in FIG. 39, check boxes 5324A and 5324B are selected to propagate a change of status to two event facilities, a facility 5322A labeled “Alachua County Public Schools” and a facility 5322B labeled “Bessemer City”. As shown in FIG. 39, the Select Schools/School Districts dialog box 5300 may include a scroll bar control element 5328 which, when activated, allows the administrator 10 to visually exhibits additional values of event facilities 5322 beyond what is currently exhibited within the borders of the table or list 5320 of facilities. In one embodiment, the Select Schools/School Districts dialog box 5300 includes a region 5330 including a search block, shown generally at 5340, to narrow or filter within, or to add additional the event facilities 5322 to the list 5320. For example, as illustrated in FIG. 39, the administrator 10 may optionally manually input an event facility name in a first search field 5342. When a value is entered into the first search field 5342, the APP 124A narrows or filters the list 5320 or adds the specified event facilities 5342 to the event facilities exhibited in the list 5320 to match the named event facility. The administrator 10 may also optionally narrow or filter within, or to add additional the event facilities 5322, to the list 5320 by manually inputting or selecting a State in a second search field 5344 labeled “STATE”. As shown in FIG. 39, in one embodiment, the second search field 5344 includes a drop-down list element 5346 that, if activated, exhibits a list of States within the United States, one or all of which that may be selected by the administrator 10. To implement or propagate the change of status to the additional one or more event facilities 5322 specified in the Select Schools/School Districts dialog box 5300, the administrator 10 selects a “DONE” control button 5350. Alternatively, the administrator 10 may end the propagation operation by selecting a “Cancel” control button 5352. In one embodiment, selecting the Save control button 5350 or the Cancel control button 5352 closes the Select Schools/School Districts dialog box 5300 and invokes or reactivates the Dashboard—School Name GUI 5200 (FIG. 37).

As described above and as shown in FIG. 37, the Dashboard—School Name GUI 5200 includes within the status table 5262 exhibited thereon, the Actions column 5264 that includes the edit icon 5264A that, when selected, invokes the Edit Delays/Closings GUI 5400 of FIG. 40, where the event facility administrator 10 may view and edit details of the change of status for the event facility corresponding to the selected edit icon. For example, when the edit icon 5264A (FIG. 37) for the event facility “Bedford Public Schools” is selected, the School DelayZz APP 124A invokes the Edit Delays/Closings GUI 5400 of FIG. 40. In one embodiment, when invoked, the Edit Delays/Closings GUI 5400 exhibits current values of the status change for the selected event facility, e.g., the Bedford Public Schools, selected as described above. As shown in FIG. 40, the Edit Delays/Closings GUI 5400 includes one or more regions for inputting information and/or initiating functionality of the system 100, for example, a first region shown generally at 5410 and a second region shown generally at 5440. In one embodiment, the first region 5410 provides fields and functionality for viewing and editing (e.g., modifying) the status change exhibited including a date field 5412 labeled “DATE” and that includes a calendar control element 5414, an event facility field 5416 labeled “SELECT SCHOOLS/SCHOOL DISTRICT”, a series of radio control buttons, shown generally at 5418, for characterizing the type of status change, and a delay time field 5420 labeled “DELAY TIME” and that includes a drop-down menu control 5422. In one embodiment, the drop-down menu control 5422 exhibits values of, for example, “60 mins”, “90 mins”, and “120 mins.” It should be appreciated that while these three (3) values are described, the present disclosure is not limited to these values and that other preset values may be implemented using the features and functions of the present disclosure. If the drop-down menu control 5422 is not selected, the administrator 10 may enter their own value within the delay time field 5420. As shown in FIG. 40, the APP 124A prefills these fields 5412, 5416, 5418, and 5420 with the values for the Bedford Public Schools change of status. Once exhibited, the administrator 10 may change values presented within these fields using, for example, functionality including the calendar control element 5414 within the date field 5412 and/or the radio control buttons 5418 to revise the type of status change. For example, as shown in FIG. 40, the previous type of status change for the Bedford Public Schools event facility, e.g., previously operating remotely on a date of “04/27/2022,” is revised to a Delay status, operating with a “90 mins.” delay in the regular starting time. To save any modification made to the change of status for the specified event facility (e.g., school, school district, or the like), the administrator 10 selects a “Save” control button 5442 in the second region 5440 of the Edit Delays/Closings GUI 5400 of FIG. 40. Alternatively, the administrator 10 ends the edit operation by selecting a “Cancel” control button 5444. In one embodiment, selecting the Save control button 5442 or the Cancel control button 5444 closes the Edit Delays/Closings GUI 5400 and invokes or reactivates the Dashboard—School Name GUI 5200 (FIG. 37).

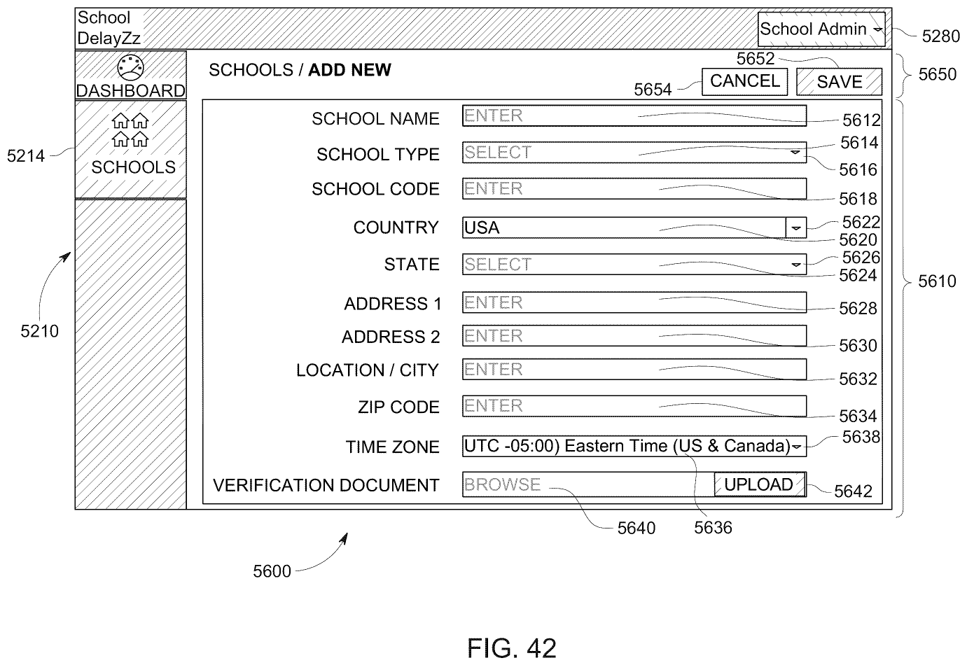

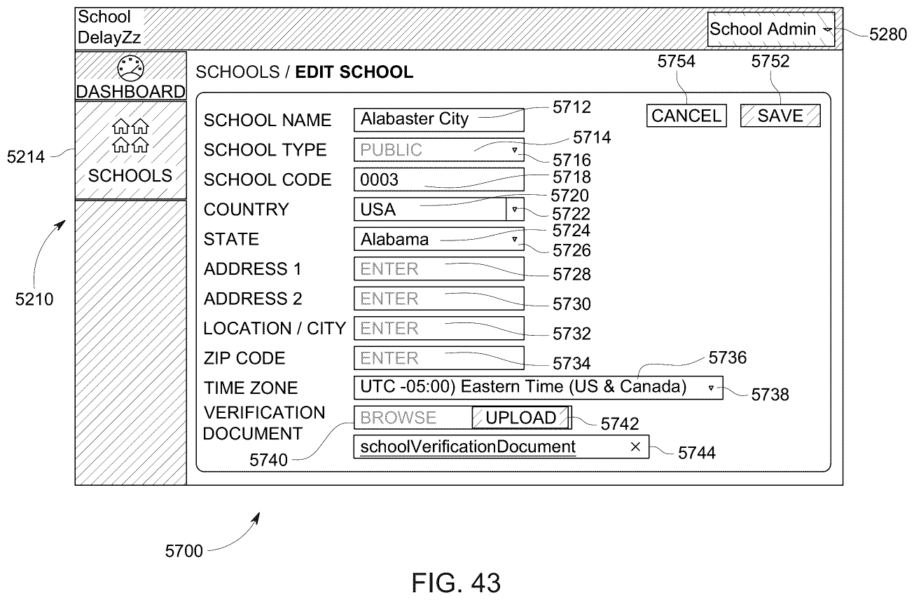

Referring again to the Main Menu navigation bar 5210, if the administrator 10 selects the “SCHOOLS” option 5214, the APP 124A navigates to the Schools GUI 5500 of FIG. 41 where the administrator 10 may view and manage (e.g., change or delete) detailed information for an existing event facility or invoke functionality to add a new event facility. In one embodiment, the Schools GUI 5500 includes one or more regions for inputting information and/or initiating functionality of the system 100, for example, a first region shown generally at 5510 and a second region shown generally at 5540. In one embodiment, the first region 5510 provides fields and functionality for searching or filtering the detailed information for an existing facility or for initiating an operation to add a new event facility or edit an existing event facility. For example, the first region 5510 includes an event facility table, shown generally at 5520, populated by the APP 124A that includes the event facilities that the event facility administrator 10 is responsible for maintaining. In one embodiment, illustrated in FIG. 41, the event facility table 5520 includes columns exhibiting, for example, a unique code for the event facilities listed, the names of event facilities (e.g., schools, school districts, user groups, and the like), state, a date of enrollment and/or verification of the facility with the School DelayZz system 100, and an Actions column. In one embodiment, the Actions column, shown generally at 5530, includes one or more icons for each listed facility for initiating functionality to be performed on one of the listed facilities. For example, in one embodiment illustrated in FIG. 41, the one or more icons include an edit icon 5530A (e.g., a pencil and paper image) and a delete icon 5530B (e.g., a garbage can image). In one embodiment, if the administrator 10 selects the edit icon 5530A for one of the listed event facilities (e.g., “Alabaster City” facility), the APP 124A closes the Schools GUI 5500 and invokes an Edit School GUI 5700 of FIG. 43 for the selected event facility (e.g., school, school district, user group, or the like), where the administrator 10 may view and edit details of the corresponding event facility (e.g., since 5530A is selected, the Edit School GUI 5700 of FIG. 43 is invoked and populated with the details for the “Alabaster City” facility), as described below. In one embodiment, if the administrator 10 selects (e.g., double clicks with an input device such as a mouse) one of the listed event facilities by name, the APP 124A closes the Schools GUI 5500 and invokes the Edit School GUI 5700 of FIG. 43 for the selected event facility. In one embodiment, if the administrator 10 selects the delete icon 5530B for one of the listed event facilities, the APP 124A deletes the listed event facility. In one embodiment, prior to completing the delete operation, the APP 124A exhibits a confirmation pop up box (not shown) and requests that the administrator 10 confirms his/her instruction to delete the selected event facility. In one embodiment, illustrated in FIG. 41, the Schools GUI 5500 also includes an ADD NEW control button 5542 (e.g., included in the second region 5540) that, if selected, the APP 124A closes the Schools GUI 5500 (FIG. 41) and invokes an Add New GUI 5600 of FIG. 42, where the administrator 10 may add a new event facility (e.g., school, school district, or the like), as described below.

As shown in FIG. 42, the Add New GUI 5600 includes one or more regions for inputting information and/or initiating functionality of the system 100 to add a new event facility, for example, a first region shown generally at 5610 and a second region shown generally at 5650. In one embodiment, the first region 5610 provides fields and functionality for adding a new event facility (e.g., school, school district, user groups, or the like) and information describing the same. For example, the first region 5610 includes a name field 5612 labeled “SCHOOL NAME,” an event facility type field 5614 labeled “SCHOOL TYPE” and that includes a drop-down list control element 5616, an event code field 5618 labeled “SCHOOL CODE,” and a Country field 5620 labeled “COUNTRY” and that includes a drop-down list control element 5622 which exhibits a list of available countries for selection. In one embodiment, the drop-down list control element 5616 for the event facility type field 5614 includes values of “Private” or “Public,” although the present disclosure is not limited to these values. As noted previously with related fields, with the Country drop-down control element 5622 the event facility administrator 10 may select a country within the list of one or more countries having event facilities participating in the system 100. In one embodiment, as illustrated in FIG. 42, a default value of the Country drop-down list control element 5622 is the United States of America (e.g., USA). In one embodiment, the first region 5610 also includes a state field 5624 labeled “STATE” and that includes a drop-down list control element 5626 which exhibits a list of available states within the selected country for selection. The first region 5610 also includes street address fields 5628 and 5630 labeled “ADDRESS 1” and “ADDRESS 2”, respectively. The first region 5610 also includes a city field 5632 labeled “LOCATION/CITY” and a zip code field 5634 labeled “ZIP CODE”. The first region 5610 further includes a time zone field 5636 labeled “TIME ZONE” and that includes a drop-down list control element 5638 for selecting applicable time zones. In one embodiment, the APP 124A automatically detects and enters the applicable time zone from the values input into the Country field 5620 and the state field 5624. In one embodiment, the automatically entered time zone may be overwritten (e.g., manually changed) by the administrator 10. In one embodiment, each of the aforementioned fields in the first region 5610 (e.g., fields 5612, 5614, 5618, 5620, 5624, 5628, 5630, 5632, 5634, and 5636) are required entries. In one embodiment, the first region 5610 may also include a verification document field 5640 labeled “VERFIED DOCUMENT.” In one embodiment, entry of a new event facility into the School DelayZz system 100 requires evidence of approval by the event facility. If so required, the verification document field 5640 is provided for submission of such a verification document. In one embodiment, entry of text within the field 5640 initiates a browser operation (as is known in the art) to locate a document corresponding to the text entered within a file directory accessible by the administrator 10. Once located, an upload control element 5642 labeled “UPLOAD” may be invoked to retrieve the document from the specified location with the file directory for submission to the School DelayZz system 100.

To create the newly specified event facility (e.g., school, school district, user group, or the like), the administrator 10 selects a “Save” control button 5652 in the second region 5650 of the Add New GUI 5600 of FIG. 42. Once selected, in one embodiment, the APP 124A exhibits a confirmation pop up box (not shown) and requests that the administrator 10 confirms his/her instruction to add the new event facility and its related information to the system 100. When confirmed, the School DelayZz APP 124A adds a new entry to the list of event facilities 164 within the data storage device 160 and populates the related fields, e.g., the event facility name field 165 and the event facility administrator's name as an authorized user (e.g., Authorized Notifier) field 169. Alternatively, the administrator 10 ends the creation operation by selecting a “Cancel” control button 5654. In one embodiment, selecting the Save control button 5652 or the Cancel control button 56544 closes the Add New GUI 5600 (FIG. 42) and invokes or reactivates the Schools GUI 5500 of FIG. 41.

Referring again to the Schools GUI 5500 of FIG. 41, as shown, the Schools GUI 5500 includes the list of event facilities exhibited within the event facilities table 5520 with each listed event facility having an Actions column that includes the edit icon, e.g., the edit icon 5530A. When either the name of the event facility or the edit icon is selected, the School DelayZz APP 124A invokes the Edit School GUI 5700 of FIG. 43, where the administrator 10 may view and edit details of the event facility (e.g., school, school district, user group, and the like) corresponding to the selected event facility name or edit icon. In one embodiment, as shown by comparing FIG. 43 to FIG. 42, the Edit School GUI 5700 (FIG. 43) includes substantially the same fields and functionality as that of the Add New GUI 5600 (FIG. 42). However, when invoked, the Edit School GUI 5700 exhibits current values for the selected event facility. For example, and as shown in FIG. 41, when the administrator 10 selects the edit icon 5530A on the Schools GUI 5500, the School DelayZz APP 124A closes the Schools GUI 5500 and invokes the Edit School GUI 5700 (FIG. 43) and populates fields thereof with details for the corresponding event facility (e.g., the “Alabaster City” event facility corresponding to edit icon 5530A). In one embodiment, the Edit School GUI 5700 (FIG. 43) includes one or more regions for inputting information and/or initiating functionality of the system 100 to edit a specified event facility, for example, the “Alabaster City” event facility. In one embodiment, the Edit School GUI 5700 includes a name field 5712 labeled “SCHOOL NAME,” an event facility type field 5714 labeled “SCHOOL TYPE” and that includes a drop-down list control element 5716, an event code field 5718 labeled “SCHOOL CODE,” and a Country field 5720 labeled “COUNTRY” and that includes a Country drop-down list control element 5722 which exhibits a list of available countries for selection. As noted previously with related fields, with the Country drop-down control element 5722 the event facility administrator 10 may select a country within the list of one or more countries having event facilities participating in the system 100. In one embodiment, as illustrated in FIG. 43, a default value of the Country drop-down list control element 5722 is the United States of America (e.g., USA). In one embodiment, the Edit School GUI 5700 also includes a state field 5724 labeled “STATE” and that includes a State drop-down list control element 5726 which exhibits a list of available states within the selected country for selection. The Edit School GUI 5700 also includes street address fields 5728 and 5730 labeled “ADDRESS 1” and “ADDRESS 2”, respectively. The Edit School GUI 5700 also includes a city field 5732 labeled “LOCATION/CITY” and a zip code field 5734 labeled “ZIP CODE”. The Edit School GUI 5700 further includes a time zone field 5736 labeled “TIME ZONE” and that includes a drop-down list control element 5738 for selecting applicable time zones. In one embodiment, the APP 124A automatically detects and enters the applicable time zone from the values input into the Country field 5720 and the state field 5724. In one embodiment, the automatically entered time zone may be overwritten (e.g., manually changed) by the event facility administrator 10. In one embodiment, each of the aforementioned fields of the Edit School GUI 5700 (e.g., fields 5712, 5714, 5720, 5724, 5728, 5730, 5732, 5734, and 5736) are required entries and the event code field 5718 is an optional entry. In one embodiment, the Edit School GUI 5700 may also include a verification document field 5740 labeled “VERIFICATION DOCUMENT.” In one embodiment, as noted above when adding a new event facility into the School DelayZz system 100, the system 100 requires evidence of approval by the event facility. If it is required or desired to remove and to add a new verification document, the verification document field 5740 is provided for submission of such a new verification document. In one embodiment, entry of text within the field 5740 initiates a browser operation (as is known in the art) to locate a document corresponding to the text entered within a file directory accessible by the administrator 10. Once located, an upload control element 5742 labeled “UPLOAD” may be invoked to retrieve the document from the specified location with the file directory for submission to the School DelayZz system 100. An icon 5744 is exhibited once the uploaded document is loaded to permit review of the verification document, as needed or desired. To save the edits made to the specified event facility (e.g., school, school district, or the like), the event facility administrator 10 selects a “SAVE” control button 5752 of the Edit School GUI 5700 of FIG. 43. Once selected, in one embodiment, the APP 124A exhibits a confirmation pop up box (not shown) and requests that the administrator 10 confirms his/her instruction to edit the event facility and its related information to the system 100. When confirmed, the School DelayZz APP 124A revises the entry for the selected facility in the list of event facilities 164 within the data storage device 160 (e.g., the event facility name field 165, as appropriate). Alternatively, the administrator 10 ends the edit operation by selecting a “CANCEL” control button 5754. In one embodiment, selecting the SAVE control button 5752 or the CANCEL control button 5754 closes the Edit School GUI 5700 (FIG. 43) and invokes or reactivates the Schools GUI 5500 of FIG. 41.

Referring again to the Dashboard GUI 5200 of FIG. 38, if the event facility administrator 10 selects the PROFILE control element 5292 from the navigation menu 5290 then, in response, the APP 124A closes of the Dashboard GUI 5200 and navigates to the Profile—School Admin GUI 5800, illustrated in FIG. 44. In the Profile—School Admin GUI 5800 one of the School DelayZz event facility administrators 10 may view and modify current values within his/her own personal identifying information within the system 100. For example, as shown in FIG. 44, the Profile—School Admin GUI 5800 includes one or more regions for inputting information and/or initiating functionality of the system 100 to view and edit existing values within his/her own profile on the system 100, for example, within a first region shown generally at 5810. In one embodiment, the first region 5810 provides fields and functionality for editing the event facility administrator's own identifying information. For example, the first region 5810 includes a first name field 5812 labeled “FIRST NAME,” a last name field 5814 labeled “LAST NAME,” a position field 5816 labeled “POSITION/TITLE” and that includes a drop-down menu control element 5818, a phone number field 5820 labeled “PHONE NUMBER,” and an electronic mail field 5822 labeled “EMAIL”. In one embodiment, the drop-down menu control element 5818 includes values of, for example, “School Administrator,” “PTO/School Club,” or “Other.” In one embodiment, each of the aforementioned fields in the first region 5810 (e.g., fields 5812, 5814, 5816, 5820, and 5822) are required entries.

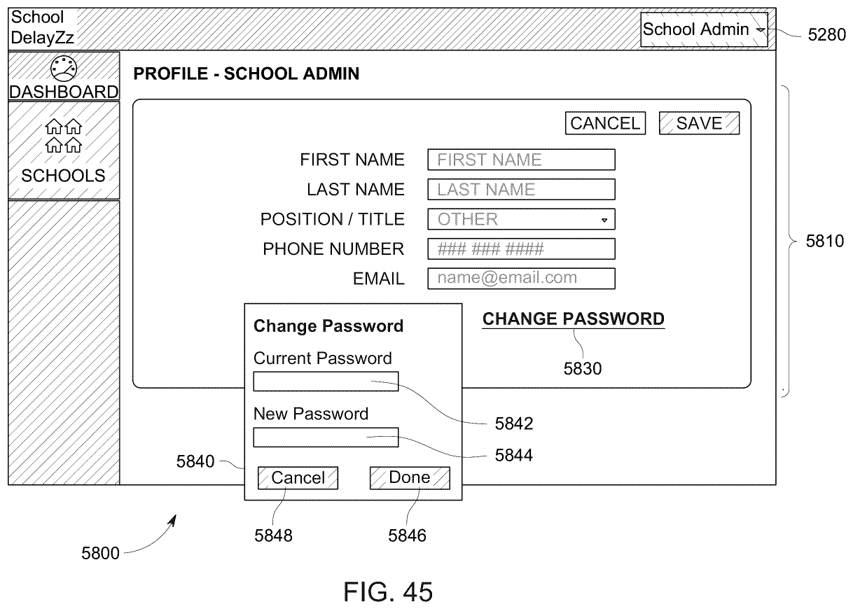

With the current values of these fields exhibited on the Profile—School Admin GUI 5800, the event facility administrator 10 may selectively review and edit these fields. In one embodiment, the first region 5810 also includes a change password textual navigation control element 5830 for the administrator 10 to change his/her password. When the change password textual navigation control element 5830 is selected, the School DelayZz APP 124A invokes a Change Password Dialog Box 5840 on the Profile—School Admin GUI 5800, as illustrated in FIG. 45, in which the administrator 10 enters his/her current password in a current password field 5842 labeled “Current Password” and a new password in a new password field 5844 labeled “New Password.” Once the administrator 10 enters a new password in an approved format (e.g., see password requirements included in the Sign Up GUI 1200 of FIG. 5), the administrator 10 selects a “Done” control button 5846 of the Change Password Dialog Box 5840 of FIG. 44. Once the Done Control button 5846 is selected, the School DelayZz APP 124A saves the new password within the event facility administrator's profile in the list of School DelayZz event facility administrators (e.g., the authorized user list 162) within the data storage device 160. Alternatively, the administrator 10 ends the change password operation by selecting a “Cancel” control button 5848 on the Change Password Dialog Box 5840. In one embodiment, selecting the Done control button 5846 or the Cancel control button 5848 closes the Change Password Dialog Box 5840 (FIG. 45) and invokes or reactivates the Profile—School Admin GUI 5800 of FIG. 44. To save the newly edited information within the administrator's own profile, the administrator 10 selects a “Save” control button 5850 of the Profile—School Admin GUI 5800 of FIG. 44. Once selected, in one embodiment, the APP 124A exhibits a confirmation pop up box (not shown) and requests that the administrator 10 confirms his/her instruction to revise and save the changes to his/her own profile to the system 100. When confirmed, the School DelayZz APP 124A revises the entry for the administrator 10 within the list of authorized users 162 within the data storage device 160. Alternatively, the administrator 10 ends the editing operation for his/her own profile by selecting a “Cancel” control button 5852. In one embodiment, selecting the Save control button 5850 or the Cancel control button 5852 closes the Profile—School Admin GUI 5800 (FIG. 44) and invokes or reactivates the GUI that initiated the action or, alternatively, invokes or reactivates the Dashboard—School Name GUI 5200 of FIG. 37.

### Overview of Event Status and Notification Message Processing

Having described how users and administrators define their profiles and profiles for the one or more event facilities (e.g., schools, school districts, user groups, and the like) in which they are associated, the following overview describes how event status messages, including a change in status of an event (e.g., delay, closing, or change of format, early dismissal, late dismissal, and the like) at an event facility, are received and how the system 100 generates notification messages in response thereto to allow enable one or more attendees and/or others planning to attend or participate in the event, or pick up a participant after an end of the event to, automatically and selectively, adjust, revise, and/or adapt their schedules upon receipt of the notification messages.

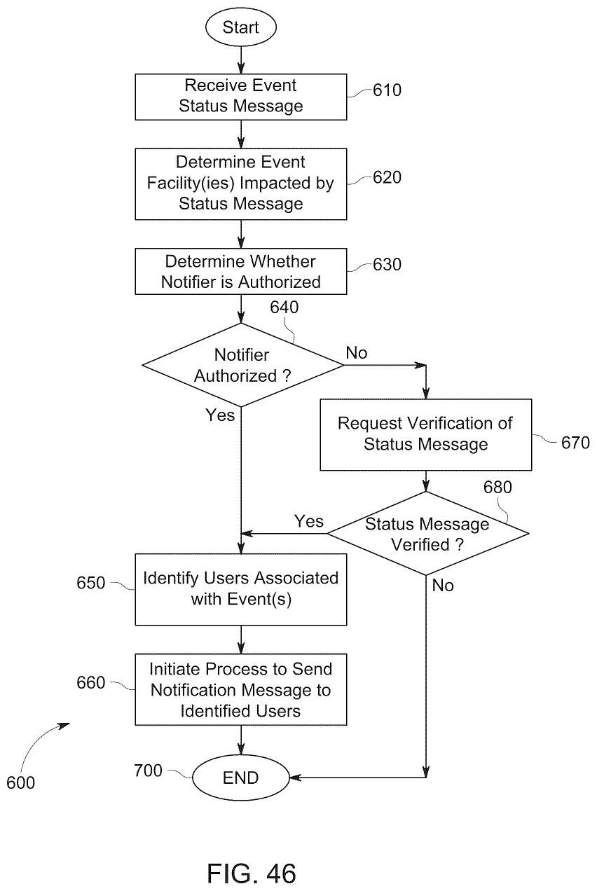

In one embodiment, illustrated in FIGS. 1 and 46, the server 150 executes APP 154A to process the event status messages 200 received from one of the notifiers, for example, a message 200A sent by the unaffiliated, third-party notify 12 using one of the processing devices 192 or a message 200B generated by the APP 124A as one of the event facility administrator 10 enters a status change of an event held at the event facility 165 he/she is responsible for administrating. As shown in FIG. 46, a method 600 for processing the event status messages 200 includes, at Step 610, receiving by the server 150 one of the event status messages 200 from one of the notifiers. In response, at Step 620, the server 150 determines one or more of the event facilities 165 impacted by the received status message 200. For example, in one embodiment, a message 200 may detail a change of status (e.g., closure, delay, change of format, or early or late dismissal) for an individual event facility (e.g., a school or other educational facility) or for a collection of facilities (e.g., a school district that includes two or more educational facilities or schools within the same school district). In one embodiment, the server 150 extracts the event facility information from the received event status message 200 and accesses the list 164 of event facilities 165 stored in the data storage device 160 to determine the one or more of the event facilities 165 impacted by the received event status message 200. At Step 630, before taking further action to generate and disseminate notification messages 170 in response to the received event status message 200, the server 150 determines whether the notifier is authorized to change the current status of operations at the one or more subject event facilities 165. As described herein, during a registration process for an event facility (e.g., a school, user group, or the like) or group of related event facilities (e.g., a school district, user groups, or the like), one or more authorized users (e.g., the Authorized Notifiers 169) are identified as being approved sources for providing event status messages 200 to the system 100. In one embodiment, the authorized or approved sources may include one or more notifiers approved to provide status messages 200 (e.g., messages 200A and 200B as shown in FIG. 1), which in one embodiment, include approved sources providing electronic messaging (e.g., email messages, API calls, and the like) or data feeds (e.g., XML feed, CSV feed, or like data feed) from one of the processing devices 192 to the server 150 as the event status messages 200 (e.g., messages 200B). At Step 630, the server 150 initiates a lookup process or query of, for example, the data storage device 160, and registration information stored therein to confirm that the received event status messages 200 are from an authorized or approved source, e.g., one of the Authorized Notifiers 169.

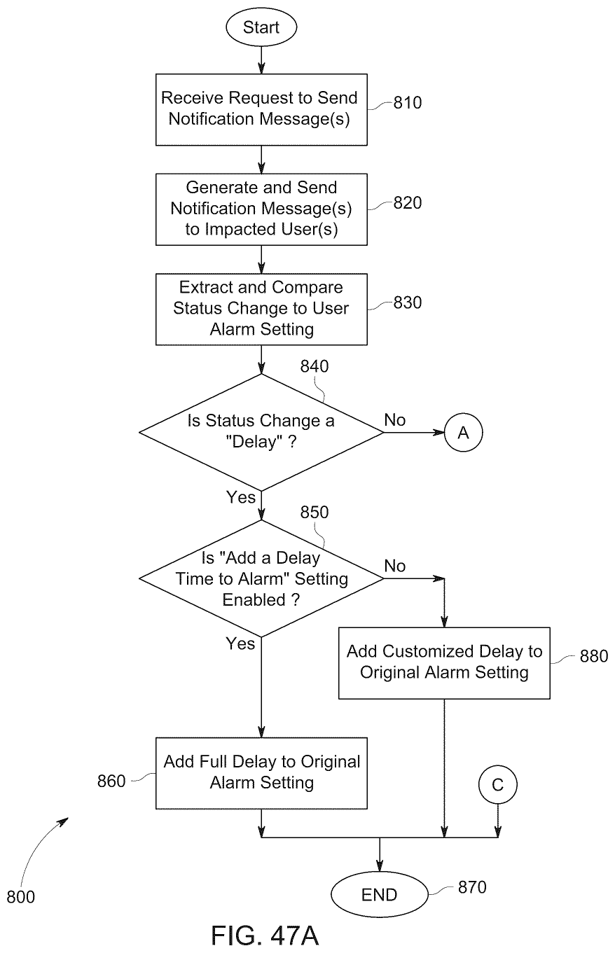

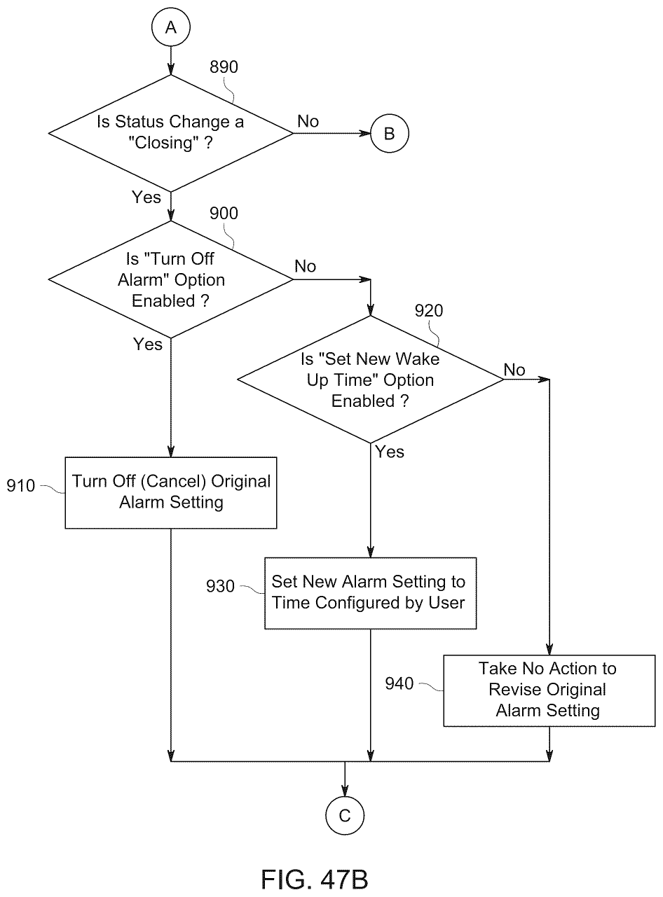

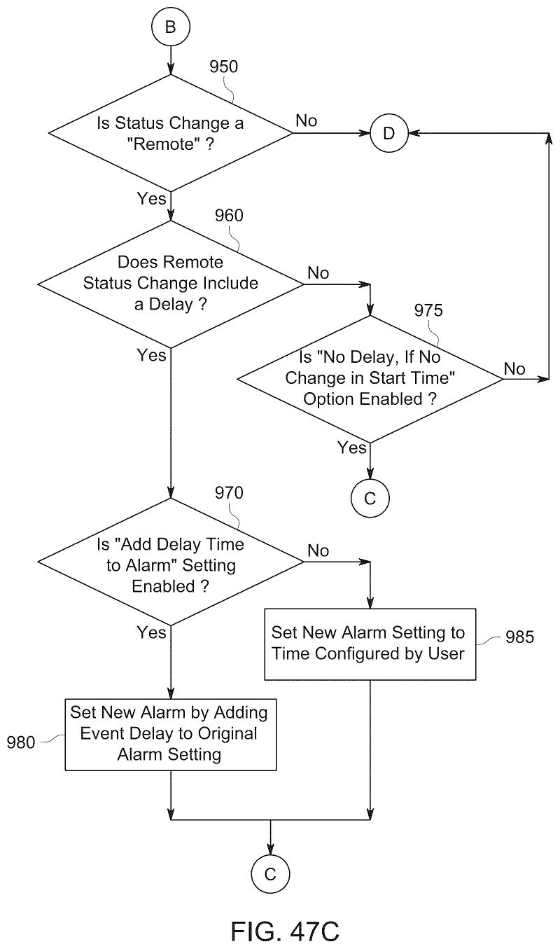

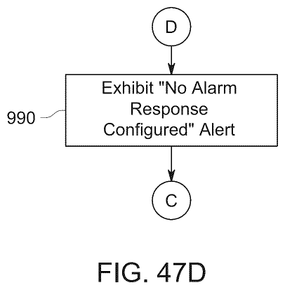

Execution of the method 600 by the APP 154A proceeds from Step 630 to Step 640, where the APP 154A determines from the lookup process whether the source of the received message 200 is an authorized notifier for the impacted event facilities 165. If the APP 154A determines that the received notification message 200 is from a current one of the Authorized Notifiers 169 for the impacted one or more event facilities 165, then execution by the APP 154A continues and proceeds from Step 640 to Step 650 along a “Yes” path. At Step 650, the APP 154A evaluates the list of users 10 associated with the impacted one or more event facilities 165. For example, as noted above, the data storage device 160 maintains the list of authorized users 162 within the data storage device 160. As noted above, the list of authorized users 162 includes the users 161 and one or more event facilities 163 associated with the user 161 as defined in the user's registration process (e.g., see FIGS. 4A to 4C and the related description provided herein). Execution of the method 600 by the APP 154A continues and proceeds from Step 650 to Step 660. At Step 660, the APP 154A initiates a process (e.g., a method 800 of FIG. 47) to request that the notification message(s) 170 be sent to the one or more users 161 associated with the event facility(ies) 163, 165 that are subject to the received event status message 200 so that the system 100 may trigger the automatic response (if enabled by the users 161) to the notification message(s) 170 and the change of status therein. In one embodiment, the initiation step includes providing the list of users 161 associated with the one or more event facilities 163, 165 impacted by the received and authorized and/or verified event status messages 200 as well as the type of the change of status (e.g., delay, cancellation, change in format, earlier or late dismissal, and the like). Once the send process is initiated, the APP 154A proceeds from Step 660 to Step 700, where the method 600 ends.

Referring again to Step 640, if the received notification message 200 is not from a current one of the Authorized Notifiers 169 for the impacted one or more event facilities 165, then execution by the APP 154A continues and proceeds from Step 640 to Step 670 along a “No” path. In one embodiment, at Step 670, the APP 154A attempts to verify that the received notification message 200 is valid by, for example, generating and sending a request message to one or more of the Authorized Notifiers 169 for the impacted one or more event facilities 165. At Step 680, the APP 154A determines whether the notification message 200 and the change of status included therein has been verified by one or more of the Authorized Notifiers 169. If the received notification message 200 is not from a current one of the Authorized Notifiers 169 and/or has not been verified by one of the Authorized Notifiers 169 for the impacted one or more event facilities 165, then execution by the APP 154A continues and proceeds from Step 680 to Step 700 along a “No” path, where the method 600 ends. If at Step 680, the APP 154A determines that the notification message 200 and the change of status included therein has been verified by one or more of the Authorized Notifiers 169, then execution by the APP 154A proceeds from Step 680 to Step 650 along a “Yes” path where, as described above, Steps 650 and 660 are executed to initiate the process to send the notification message(s) 170 to the one or more users 161 associated with the event facility(ies) 163, 165 subject to the received event status message 200.

As shown in FIGS. 47A, 47B, 47C, and 47D, a method 800 for processing a response to the received event status messages 200 (executed by one or more of the APPS 112A, 124A, 154A, and/or 160A) includes, at Step 810 (FIG. 47A), receiving by the APP 154A the request that one or more notification messages 170 be sent to the users 161 associated with one or more event facilities 163, 165 impacted by the received event status message 200. As noted above, in one embodiment, the request includes the users 161 associated with the event facility(ies) 163, 165 that are subject to the change of status included in the received event status message 200. At Step 820, for each of the users 161, the server 150 generates and sends one of the notification messages 170 to one or both of the client/user device 120 operated by the user 161 (e.g., message 170A) and/or the IoT Device 110 used by the user 161 (e.g., message 170B), for example, via the push notification gateway 157. Execution of the method 800 then concludes for the server 150. At Step 830, the APP 112A and/or 124A extract the change of status (e.g., delay, cancellation, change in format, earlier or late dismissal, and the like) from the request, e.g., provided within the notification message(s) 170 from the server 150 and APP 154A, and the APP 112A and/or 124A compares the extracted change of status to the alarm setting for each of the users 161 to trigger the appropriate response to the notification message(s) 170. At Step 840, the APP 112A and/or 124A determines whether the change of status is a “Delay” or other status change. If the change of status is a delay, execution proceeds from Step 840 to Step 850 along a “Yes” path. At Step 850, the APP 112A and/or 124A determines the automated response, if any, assigned by the user 161 (e.g., operator 10 of the user device 120) for a change of status type of delay, for example, as set in the Configure Alarms GUI 1800 of FIG. 11. For example, the APP 112A and/or 124A determines whether the user enabled the toggle control element 1834 instructing the APP 112A and/or 124A to add a delay time set by the event facility (e.g., as included in the event status message 200 and the notification message 170) to their original alarm setting (e.g., value of field 1814 (FIG. 11) indicative of the alarm for a regular wake up time). If the toggle control element 1834 is enabled, execution proceeds from Step 850 to Step 860 along a “Yes” path. At Step 860, the APP 112A and/or 124A modifies the user's original alarm setting to add the delay period defined by the event facility 163. For example, if the event status message 200 and the notification message 170 indicate that the event facility 163 is operating with a one hundred twenty (120) minute delay to its regular start time, the APP 112A and/or 124A adds the one hundred twenty-minute delay period to the user's original alarm setting. Referring to FIG. 11, the APP 112A and/or 124A adds one hundred twenty (120) minutes to the value of original alarm setting (e.g., the “6:30 am” value of field 1814) such that a new alarm setting is established at a value of eight-thirty am (e.g., “8:30 am”). Once the new alarm setting is established, execution by the APP 112A and/or 110A continues and proceeds from Step 860 to Step 870, where execution ends.

Referring again to Step 850, if the toggle control element 1834 is not enabled, execution proceeds from Step 850 to Step 880 along a “No” path. At Step 880, the APP 112A and/or 124A determines the automated response, if any, assigned by the user 161 (e.g., operator 10 of the user device 120) for the change of status type of delay (e.g., as set in the Configure Alarms GUI 1800 of FIG. 11) when the toggle control element 1834 is disabled. At Step 880, the APP 112A and/or 124A modifies the user's original alarm setting to add the customized delay period defined by the user 10 when activating the slider control element 1838 (FIG. 11) to add a variable delay time from between, for example, a numeric value of five (5) minutes to one hundred twenty (120) minutes, to their original alarm setting (e.g., the value within the field 1814). For example, if the user 10 specified that a ninety-minute (90 min) delay should be added to his/her original alarm setting in response to the event status message 200 and the notification message 170 indicate that the event facility 163 is operating with a delay to its regular start time, the APP 112A and/or 124A adds the ninety-minute (90 min) delay period to the user's original alarm setting. Referring again to FIG. 11, the APP 112A and/or 124A adds ninety (90) minutes to the value of original alarm setting (e.g., the “6:30 am” value of field 1814) such that a new alarm setting is established at a value of eight am (e.g., “8:00 am”). Once the new alarm setting is established, execution by the APP 112A and/or 110A continues and proceeds from Step 880 to Step 870, where execution ends.

Referring again to Step 840 (FIG. 47A), if the APP 112A and/or 124A determines that the change of status is not a “Delay” status change, execution proceeds from Step 840 to Step 890 along a “No” path and by following a connector labeled “A” from FIG. 47A to FIG. 47B. At Step 890 (FIG. 47B), the APP 112A and/or 124A determines whether the change of status is a “Closing” status change. If the change of status is a closing, execution proceeds from Step 890 to Step 900 along a “Yes” path. At Step 900, the APP 112A and/or 124A determines the automated response, if any, assigned by the user 161 (e.g., operator 10 of the user device 120) for a change of status type of closing, for example, as set in the Configure Alarms GUI 1800A of FIG. 12. For example, the APP 112A and/or 124A determines whether the user enabled the toggle control element 1834A instructing the APP 112A and/or 124A to turn off the alarm previously set by the user 161. If the toggle control element 1834A is enabled, execution proceeds from Step 900 to Step 910 along a “Yes” path. At Step 910, the APP 112A and/or 124A turns off or cancels the user's original alarm setting such that no alarm is set to wake up the user 161 upon receipt of the closing event status message 200 and the notification message 170. Once the scheduled alarm setting is cancelled, execution by the APP 112A and/or 110A continues and proceeds from Step 910 to Step 870 by following a connector labeled “C” from FIG. 47B to FIG. 47A, where execution ends.

Referring again to Step 900, if the toggle control element 1834A is not enabled, execution proceeds from Step 900 to Step 920 along a “No” path. At Step 920, the APP 112A and/or 124A determines whether to set a new or alternative wake up time for the user 161 or to take no action in response to the event status message 200 and the notification message 170 indicating that the event facility 163 is closed. For example, at Step 920, the APP 112A and/or 124A determine whether the toggle control element 1838A (FIG. 12) is enabled indicating that the user 161 does wish to set a new or alternative wake up time in response to the notification of a closing. If the toggle control element 1838A is enable, execution by the APP 112A and/or 124A continues and proceeds from Step 920 to Step 930 along a “Yes” path. At Step 930 the APP 112A and/or 124A establishes a new alarm setting (e.g., wake up time) for the user 161 equal to the value set by the user 161 in, for example, the Configure Alarms GUI 1800A of FIG. 12 (e.g., value entered in field 1836A and shown as “8:30 am”). Once the new or alternative alarm setting is established, execution by the APP 112A and/or 110A continues and proceeds from Step 930 to Step 870 by following the connector labeled “C” from FIG. 47B to FIG. 47A, where execution ends. Referring again to Step 920, if the toggle control element 1838A is not enabled, execution proceeds from Step 920 to Step 940 along a “No” path. At Step 940, the APP 112A and/or 124A determines the user 161 has not defined any automated action in response to the receipt of the event status message 200 and the notification message 170 indicating that the event facility 163 is closed. In one embodiment, the APP 124A may generate a message (not shown) to the user 161 indicating that no action was taken in response to the closing message. Execution by the APP 112A and/or 124A continues and proceeds from Step 940 to Step 870 by following the connector labeled “C” from FIG. 47B to FIG. 47A, where execution ends.

Referring again to Step 890 (FIG. 47B), if the APP 112A and/or 124A determines that the change of status is not a “Closing” status change, execution proceeds from Step 890 to Step 950 along a “No” path by following the connector labeled “B” from FIG. 47B to FIG. 47C. At Step 950 (FIG. 47C), the APP 112A and/or 124A determines whether the change of status is a “Remote” status change. If the change of status is a remote status, execution proceeds from Step 950 to Step 960 along a “Yes” path. At Step 960, the APP 112A and/or 124A determines whether the remote status change also includes a delay in the original start time for the event facility 163. For example, whether the event facility 163 has given a period of time for its staff, attendees, and others to prepare for the change in format from an in-person event (attendance at the event facility) to a remote format where attendance at the event is virtual. At Step 960, the APP 112A and/or 124A determines the automated response, if any, assigned by the user 161 (e.g., operator 10 of the user device 120) for a change of status type of remote with or without a delay, for example, as set in the Configure Alarms GUI 1800B of FIG. 13. If the notification message 170 indicates that the remote status change also includes a delay, execution by the APP 112A and/or 124A continues and proceeds from Step 960 to Step 970 along a “Yes” path. At Step 970, the APP 112A and/or 124A determines whether the user enabled the toggle control element 1834B instructing the APP 112A and/or 124A to add a delay time set by the event facility (e.g., as included in the event status message 200 and the notification message 170) to their original alarm setting (e.g., value of field 1814 (FIG. 13) indicative of the alarm for a regular wake up time). If the toggle control element 1834B is enabled, execution proceeds from Step 970 to Step 980 along a “Yes” path. At Step 980, the APP 112A and/or 124A modifies the user's original alarm setting to add the delay period defined by the event facility 163. For example, if the event status message 200 and the notification message 170 indicate that the event facility 163 is operating with a thirty (30) minute delay to its regular start time, the APP 112A and/or 124A adds the thirty-minute delay period to the user's original alarm setting. Referring to FIG. 13, the APP 112A and/or 124A adds thirty (30) minutes to the value of original alarm setting at 1814 (e.g., “6:30 am”) such that a new alarm setting is established at a value of seven am (e.g., “7:00 am”). Once the new alarm setting is established, execution by the APP 112A and/or 110A continues and proceeds from Step 980 to Step 870 by following the connector labeled “C” from FIG. 47B to FIG. 47A, where execution ends.

Referring again to Step 970 (FIG. 47C), if the APP 112A and/or 124A determines that the user did not enabled the toggle control element 1834B instructing the APP 112A and/or 124A to add a delay time set by the event facility to their original alarm setting, execution proceeds from Step 970 to Step 985 along a “No” path. At Step 985, the APP 112A and/or 124A establish a new or alternative wake up time for the user 161 in response to the event status message 200 and the notification message 170 indicating that the event facility 163 is changed to a remote format. For example, at Step 985, the APP 112A and/or 124A determine whether the slider control element 1838B (FIG. 13) is enabled indicating that the user 161 does wish to set a new or alternative wake up time in response to the notification of a change of format to remote. If the slider control element 1838B is enable, execution by the APP 112A and/or 124A establishes a new alarm setting (e.g., wake up time) for the user 161 equal to the value set by the user 161 in, for example, the Configure Alarms GUI 1800B of FIG. 13 (e.g., value entered at 1836B and shown as “90 minutes”) such that the new or alternative alarm is set at a value of “8:00 am.” Once the new or alternative alarm setting is established, execution by the APP 112A and/or 110A continues and proceeds from Step 985 to Step 870 by following the connector labeled “C” from FIG. 47C to FIG. 47A, where execution ends.

Referring again to Step 960 (FIG. 47C), if the APP 112A and/or 124A determines that the remote status change does not include a delay in the original start time for the event facility 163, execution continues and proceeds along a “No” path to Step 975. At Step 975, the APP 112A and/or 124A determines whether the check box control element 1850B of the Configure Alarms GUI 1800B (FIG. 13) is enabled. If the check box control element 1850B is enabled the user 161 has indicated that no delay time period should be applied to the original alarm setting if the event facility 163 has not delayed the original start time at the event facility due to the change of format to remote. Accordingly, the original alarm setting (e.g., a value in field 1814 of “6:30 am”) is maintained and execution by the APP 112A and/or 124A continues and proceeds from Step 975 to Step 870 by following the connector labeled “C” from FIG. 47C to FIG. 47A, where execution ends. Referring again to Step 975 (FIG. 47C), if the APP 112A and/or 124A determines that the check box control element 1850B is not enabled, execution continues and proceeds from Step 975 to Step 990 along a “No” path by following the connector labeled “D” from FIG. 47C to FIG. 47D. At Step 990, the APP 112A and/or 124A exhibits a “No Alarm Response Configured” message (not shown) to the user 161. Execution then continues and proceeds from Step 990 to Step 870 by following the connector labeled “C” from FIG. 47D to FIG. 47A, where execution ends. Referring again to Step 950 (FIG. 47C), if the APP 112A and/or 124A determines that the change of status is not a “Remote” status change, execution continues and proceeds from Step 950 to Step 990 along a “No” path by following the connector labeled “D” from FIG. 47C to FIG. 47D. As noted above, at Step 990 the APP 112A and/or 124A exhibits a “No Alarm Response Configured” message (not shown) to the user 161. Once exhibited, execution by the APP 112A and/or 124A continues and proceeds from Step 990 to Step 870 by following the connector labeled “C” from FIG. 47D to FIG. 47A, where execution ends.

As should be appreciated from the description of exemplary embodiments provided herein, the School DelayZz™ event notification and messaging system 100 includes novel and non-obvious systems and methods that receive and process automated responses to event status messages, each including a change in status of an event such as, for example, a school day, a meeting, a conference, an audition, a rehearsal, a show or performance, a schedule for travel, or the like (collectively, the event). In one embodiment, the event status messages include a change such as, for example, a delay, closure, or cancellation of the event, early or late dismissal from the event, or an alternative format for conducting the event. When received, the systems and methods as described herein, generate notification messages that enable attendees and/or others planning to attend or participate in the event, or pick up a participant after an end of the event to, automatically and selectively, adjust, revise, and/or adapt their schedules upon receipt of the notification messages. In one embodiment, where the event is planned to begin at an early time of the day, the automatic response may include, for example, adjusting, resetting, or cancelling an alarm set to wake the participant of the event or others, for example, providing transportation to the event.

It should be appreciated that the phraseology and the terminology used in the description of the various embodiments described herein should be given their broadest interpretation and meaning as the purpose is for describing particular embodiments only and is not intended to be limiting. As used in the description of the various described embodiments and the appended claims, the singular forms “a”, “an” and “the” are intended to include the plural forms as well, unless the context clearly indicates otherwise. It should also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, and equivalents thereof, and do not preclude the presence or addition of one or more other features, integers, steps, operations, elements, components, groups and/or equivalents thereof.

While the invention has been described with reference to various exemplary embodiments, including, for example, an implementation as a school delay, closure, or change in format to remote learning notification system, it should be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claim.

What is claimed is:

1. A system for receiving and responding to a change of status message for an event over a communication network, the system comprising:
a server including a server processor and a server memory operatively coupled to the server processor, the server memory storing server instructions executable by the server processor; and
one or more user devices, operable by one or more users of the system, each of the one or more user devices including a user device processor and a user device memory operatively coupled to the user device processor, the one or more user devices communicating with the server over a communication network, each of the user device memory storing user device instructions executable by the user device processor;
wherein when an event status message including a change in a status of an event is received by the server, the server processor executes the server instructions such that the server is configured to:
extract from the received event status message one or more event facilities conducting at least one event impacted by the event status message;
determine whether the received event status message is generated by one or more sources authorized to change the status of events conducted at a corresponding one of the one or more event facilities;
wherein when the received event status message is generated from an authorized source, identifying the one or more users associated with at least one event facility impacted by the received event status message; and
generate, by the server, one or more notification messages including the change in the status of the event and send, by the server, the generated one or more notification messages to the one or more user devices of the identified one or more users;
wherein when a notification message is received by a user device of the identified one or more users, the user device processor executes the user device instructions such that the user device is configured to:
extract from the received notification message the change in the status of the event;
determine a type of the change in the status of the event from a plurality of types of changes in the status of events;
compare the determined type of the change in the status to one or more automated responses enabled on the user device for the plurality of types of changes in the status of events; and
wherein when an automated response is enable for the determined type of the change in the status, activate the automated response by the user device to the received notification message.

2. The system of claim 1, wherein the one or more automated responses activated on the user device include at least one of:
cancelling an alarm signal set for activation on the user device at a first predetermined time;
updating the first predetermined time set for activating the alarm signal by a first delay period set by an event facility associated with the user of the user device;
updating the first predetermined time set for activating the alarm signal by a second delay period set by the user of the user device; and
cancelling the alarm signal previously set for activation on the user device at the first predetermined time and setting the alarm signal for activation on the user device at a second predetermined time.

3. The system of claim 1, wherein when no automated response is enabled on the user device, exhibiting on the user device, in response to the received notification message, an alert message that no automated response is enabled.

4. The system of claim 1, further including:
one or more Internet of Things (IoT) devices operatively coupled to at least one of the server and one of the one or more user devices, each of the one or more IoT devices including an IoT device processor and an IoT device memory operatively coupled to the IoT device processor, the IoT device memory storing IoT device instructions executable by the IoT processor; and
wherein the notification message further includes control signals provided to the one or more IoT devices by the at least one of the server and one of the one or more user devices, the control signals instructing the one or more IoT devices to activate one or more automated responses on the one or more IoT devices for the plurality of types of changes in the status of events.

5. The system of claim 4, wherein the one or more automated responses activated on the one or more IoT devices include at least one of:
cancelling an alarm signal set for activation on the one or more IoT devices at a first predetermined time;
updating the first predetermined time set for activating the alarm signal by a first delay period set by an event facility associated with the user of the user device coupled to the one or more IoT devices;
updating the first predetermined time set for activating the alarm signal by a second delay period set by the user of the user device coupled to the one or more IoT devices; and
cancelling the alarm signal previously set for activation on the one or more IoT devices at the first predetermined time and setting the alarm signal for activation on the one or more IoT devices at a second predetermined time.

6. The system of claim 1, wherein the server processor at least one of receives the event status messages from and retrieves the event status messages from a third party source.

7. The system of claim 6, wherein the third party source includes at least one of event organizers, local government officials, administrators of schools or universities, managers for television, film, or stage productions, administrators or staff of travel or transportation service providers.

8. The system of claim 1, wherein the users of the system include one or more attendees and others planning to attend or participate in the event, persons picking up the attendees and others after an end of the event, administrators of event facilities, and system administrators.

9. The system of claim 8, wherein the users further include two or more subsets of the attendees and others planning to attend or participate in the event, the persons picking up the attendees and others, and the administrators of event facilities registered with the system as one or more user groups associated with one or more of the event facilities.

10. The system of claim 1, wherein the event includes at least one of a school day, a meeting, a conference, an audition, a rehearsal, a show or performance, and a schedule for travel.

11. The system of claim 1, wherein the event facilities of the system include at least one of a school, a school district, an educational institute, a user group, and a venue for an event.

12. The system of claim 1, wherein the change of status within the notification message includes at least one of a delay, a closure, a cancellation, an early dismissal, a late dismissal, and an alternative format for conducting the event.

13. A method for responding to a change of status message for an event received over a communication network, the method comprising:
receiving, at a first processing device, an event status message including a change in a status of an event; and
in response to the received event status message, the first processing device further operating to:
extract from the received event status message one or more event facilities conducting at least one event impacted by the event status message;
determine whether the received event status message is generated by one or more sources authorized to change the status of events conducted at a corresponding one of the one or more event facilities;
wherein when the received event status message is generated from an authorized source, identify the one or more users associated with at least one event facility impacted by the received event status message; and
generate one or more notification messages including the change in the status of the event and send the generated one or more notification messages to the one or more second processing devices of the identified one or more users;
receiving, by the one or more second processing devices, one of the one or more notification messages; and
in response to the received notification message, the second processing device further operating to:
extract from the received notification message the change in the status of the event;
determine a type of the change in the status of the event from a plurality of types of changes in the status of events;
compare the determined type of the change in the status to one or more automated responses enabled on the user device for the plurality of types of changes in the status of events; and
wherein when an automated response is enable for the determined type of the change in the status, activate the automated response by the second processing device to the received notification message.

14. The method of claim 13, wherein the one or more automated responses activated on the second processing device include at least one of:
cancelling an alarm signal set for activation on the second processing device at a first predetermined time;
updating the first predetermined time set for activating the alarm signal by a first delay period set by an event facility associated with the user of the second processing device;
updating the first predetermined time set for activating the alarm signal by a second delay period set by the user of the second processing device; and
cancelling the alarm signal previously set for activation on the second processing device at the first predetermined time and setting the alarm signal for activation on the second processing device at a second predetermined time.

15. The method of claim 13, wherein when no automated response is enabled on the second processing device, exhibiting on the second processing device, in response to the received notification message, an alert message that no automated response is enabled.

16. The method of claim 13, further including:
providing one or more Internet of Things (IoT) devices operatively coupled to at least one of the first processing device and one of the second processing devices; and
wherein the notification message further includes control signals provided to the one or more IoT devices by the at least one of the first processing device and one of the second processing devices, the control signals instructing the one or more IoT devices to activate one or more automated responses on the one or more IoT devices for the plurality of types of changes in the status of events.

17. The method of claim 16, wherein the one or more automated responses activated on the one or more IoT devices include at least one of:
cancelling an alarm signal set for activation on the one or more IoT devices at a first predetermined time;
updating the first predetermined time set for activating the alarm signal by a first delay period set by an event facility associated with the user of the user device coupled to the one or more IoT devices;
updating the first predetermined time set for activating the alarm signal by a second delay period set by the user of the user device coupled to the one or more IoT devices; and
cancelling the alarm signal previously set for activation on the one or more IoT devices at the first predetermined time and setting the alarm signal for activation on the one or more IoT devices at a second predetermined time.
